(19) United States
(12) Patent Application Publication
(10) Pub. No.: US 2025/0091356 A1
(43) Pub. Date: Mar. 20, 2025

(54) LIQUID STORAGE SECTION, LIQUID FLOW MECHANISM, AND LIQUID EJECTION DEVICE

(71) Applicant: SEIKO EPSON CORPORATION, Tokyo (JP)

(72) Inventors: Tomohiro KAWASAKI, SHIOJIRI-SHI (JP); Nanami HAGA, SHIOJIRI-SHI (JP); Yuki HIRABAYASHI, SHIOJIRI-SHI (JP); Masaru KOBASHI, MATSUMOTO-SHI (JP)

(21) Appl. No.: 18/884,999

(22) Filed: Sep. 13, 2024

(30) Foreign Application Priority Data
Sep. 15, 2023 (JP) 2023-149858
Sep. 15, 2023 (JP) 2023-149859

(51) Int. Cl. B41J 2/175

(52) U.S. Cl. CPC B41J 2/17563; B41J 2/17556

(57) ABSTRACT

A liquid storage section includes a storage body that stores ejection liquid and moisturizing liquid and a moisture permeable membrane attached to the storage body, wherein the moisture permeable membrane partitions an inside of the storage body into an ejection liquid chamber and a moisturizing liquid chamber, the ejection liquid chamber is a space in which ejection liquid is stored, the moisturizing liquid chamber is a space in which moisturizing liquid is stored, and the storage body stores ejection liquid and moisturizing liquid such that a liquid surface of ejection liquid stored in the ejection liquid chamber and a liquid surface of moisturizing liquid stored in the moisturizing liquid chamber are positioned below an upper end of the moisture permeable membrane.

The present application is based on, and claims priority from JP Application Serial Number 2023-149858, filed Sep. 15, 2023, and from JP Application Serial Number 2023-149859, filed Sep. 15, 2023, the disclosures of which are hereby incorporated by reference herein in their entirety.

### BACKGROUND

### 1. Technical Field

The present disclosure relates to a liquid storage section, a liquid flow mechanism, and a liquid ejection device.

### 2. Related Art

JP-A-2019-123180 describes a liquid ejection device that stores ejection liquid and moisturizing liquid in a state of being separated by a moisture permeable membrane. In this liquid ejection device, moisture contained in moisturizing liquid is supplied to ejection liquid through the moisture permeable membrane, thereby moisturizing ejection liquid.

In such a liquid ejection device, when pressure is applied to a space where moisturizing liquid is stored or a space where ejection liquid is stored, a pressure difference occurs between the space where moisturizing liquid is stored or the space where ejection liquid is stored and a space in the moisture permeable membrane. When a pressure difference occurs, there is a possibility that moisturizing liquid seeps out to the moisture permeable membrane or ejection liquid seeps out to the moisture permeable membrane.

### SUMMARY

A liquid storage section to overcome the above-described problem includes a storage body that stores ejection liquid and moisturizing liquid and a moisture permeable membrane attached to the storage body, wherein the moisture permeable membrane partitions an inside of the storage body into an ejection liquid chamber and a moisturizing liquid chamber, the ejection liquid chamber is a space in which ejection liquid is stored, the moisturizing liquid chamber is a space in which moisturizing liquid is stored, and the storage body stores ejection liquid and moisturizing liquid such that a liquid surface of ejection liquid stored in the ejection liquid chamber and a liquid surface of moisturizing liquid stored in the moisturizing liquid chamber are positioned below an upper end of the moisture permeable membrane.

A liquid flow mechanism to overcome the above-described problem includes the above-described liquid storage section; a pressure change mechanism connected to the storage body and configured to change pressure in the storage body; and an ejection liquid flow path connected to the storage body and communicating with the ejection liquid chamber.

A liquid ejection device to overcome the above-described problem includes the above-described liquid flow mechanism and an ejection section connected to the storage body and configured to eject ejection liquid stored in the ejection liquid chamber.

### BRIEF DESCRIPTION OF THE DRAWINGS

FIG. 1 is a schematic diagram showing a first embodiment of a liquid ejection device.

FIG. 2 is a schematic diagram showing a liquid storage section.

FIG. 3 is a schematic diagram showing a second embodiment of the liquid ejection device.

FIG. 4 is a schematic diagram showing a third embodiment of the liquid ejection device.

FIG. 5 is a schematic diagram showing a fourth embodiment of the liquid ejection device.

FIG. 6 is a schematic diagram showing a fifth embodiment of the liquid ejection device.

FIG. 7 is a schematic diagram showing a sixth embodiment of the liquid ejection device.

FIG. 8 is a schematic diagram showing a seventh embodiment of the liquid ejection device.

FIG. 9 is a schematic diagram showing an eighth embodiment of the liquid ejection device.

FIG. 10 is a schematic diagram showing a ninth embodiment of the liquid ejection device.

FIG. 11 is a schematic diagram showing a tenth embodiment of the liquid ejection device.

FIG. 12 is a schematic diagram showing an eleventh embodiment of the liquid ejection device.

FIG. 13 is a schematic diagram showing a twelfth embodiment of the liquid ejection device.

FIG. 14 is a schematic diagram showing a thirteenth embodiment of the liquid ejection device.

FIG. 15 is a schematic diagram showing a fourteenth embodiment of the liquid ejection device.

FIG. 16 is a schematic diagram showing a fifteenth embodiment of the liquid ejection device.

FIG. 17 is a schematic diagram showing a sixteenth embodiment of the liquid ejection device.

FIG. 18 is a schematic diagram showing a seventeenth embodiment of the liquid ejection device.

FIG. 19 is a schematic diagram showing an eighteenth embodiment of the liquid ejection device.

FIG. 20 is a schematic diagram showing a nineteenth embodiment of the liquid ejection device.

FIG. 21 is a schematic diagram showing a twentieth embodiment of the liquid ejection device.

FIG. 22 is a schematic diagram showing a twenty first embodiment of the liquid ejection device.

FIG. 23 is a schematic diagram showing a twenty second embodiment of the liquid ejection device.

FIG. 24 is a schematic diagram showing a twenty third embodiment of the liquid ejection device.

FIG. 25 is a schematic diagram showing a twenty fourth embodiment of the liquid ejection device.

FIG. 26 is a schematic diagram showing a twenty fifth embodiment of the liquid ejection device.

FIG. 27 is a schematic diagram showing a twenty sixth embodiment of the liquid ejection device.

FIG. 28 is a schematic diagram showing a twenty seventh embodiment of the liquid ejection device.

FIG. 29 is a schematic diagram showing a twenty eighth embodiment of the liquid ejection device.

FIG. 30 is a schematic diagram showing a twenty ninth embodiment of the liquid ejection device.

FIG. 31 is a schematic diagram showing a thirtieth embodiment of the liquid ejection device.

FIG. 32 is a schematic diagram showing a thirty first embodiment of the liquid ejection device.

FIG. 33 is a schematic diagram showing a thirty second embodiment of the liquid ejection device.

FIG. 34 is a schematic diagram showing a thirty third embodiment of the liquid ejection device.

FIG. 35 is a schematic diagram showing a thirty fourth embodiment of the liquid ejection device.

FIG. 36 is a schematic diagram showing the thirty fifth embodiment of the liquid ejection device.

### DESCRIPTION OF EMBODIMENTS

Hereinafter, an embodiment of a liquid ejection device will be described with reference to the drawings. The liquid ejection device is, for example, an inkjet printer that records an image such as a character or a photograph by ejecting ink, which is an example of ejection liquid, onto a medium such as a paper sheet or fabric.

### First Embodiment

First, a first embodiment of the liquid ejection device will be described.

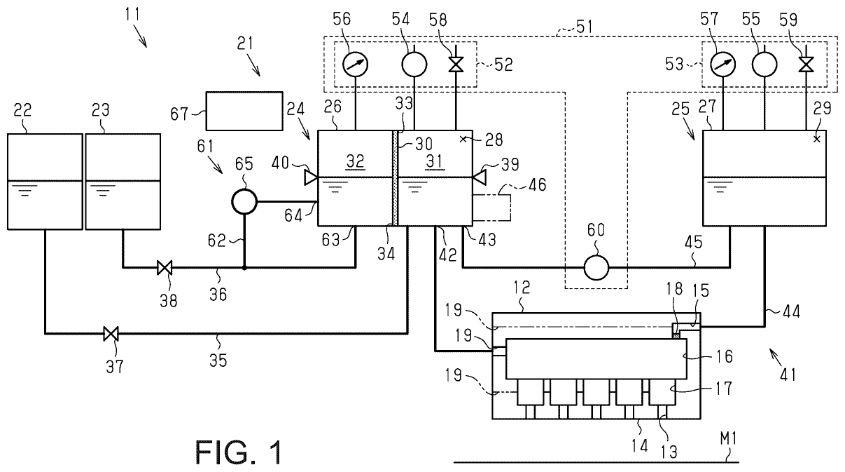

As shown in FIG. 1, a liquid ejection device 11 includes an ejection section 12. The ejection section 12 is configured to eject ejection liquid onto a medium M1. The ejection section 12 is a so-called head. The ejection section 12 includes a nozzle surface 14 in which one or more nozzles 13 open. The ejection section 12 ejects ejection liquid from the nozzle 13.

In the ejection section 12, an inlet path 15, a common liquid chamber 16, and one or more individual liquid chambers 17 are formed. The inlet path 15, the common liquid chamber 16, and one or more individual liquid chambers 17 are spaces in the ejection section 12. Ejection liquid flows through the inlet path 15, the common liquid chamber 16, and one or more individual liquid chambers 17.

The inlet path 15 is a space for introducing ejection liquid into the ejection section 12. The common liquid chamber 16 communicates with the inlet path 15. Ejection liquid is introduced into the common liquid chamber 16 through the inlet path 15. One or more individual liquid chambers 17 communicate with the common liquid chamber 16. Ejection liquid is introduced into one or more individual liquid chambers 17 through the common liquid chamber 16. When a plurality of individual liquid chambers 17 is formed in the ejection section 12, the plurality of individual liquid chambers 17 communicates with the common liquid chamber 16. One individual liquid chamber 17 communicates with one nozzle 13. Therefore, the ejection section 12 includes individual liquid chambers 17 formed in the same number as the nozzles 13. The ejection section 12 ejects ejection liquid from the nozzle 13 by applying pressure to ejection liquid positioned in the individual liquid chamber 17.

The ejection section 12 may include a filter 18. In one example, the filter 18 is positioned in the inlet path 15.

Specifically, the filter 18 is positioned at an end section of the inlet path 15 that is connected to the common liquid chamber 16. The filter 18 collects air bubbles, foreign matters, and the like contained in ejection liquid. By this, the ejection liquid from which air bubbles, foreign matters, and the like have been removed is introduced into the common liquid chamber 16 and the individual liquid chamber 17.

An outlet path 19 may be formed in the ejection section 12. The outlet path 19 is a space in the ejection section 12 through which ejection liquid flows. The outlet path 19 is a space for leading out ejection liquid from the ejection section 12. Therefore, ejection liquid can flow in the ejection section 12 from the inlet path 15 to the outlet path 19. When ejection liquid stays for a long time, the ejection liquid may thicken or settle. Since the ejection liquid flows in the ejection section 12, a possibility that ejection liquid is thickened or settled in the ejection section 12 is reduced.

The outlet path 19 extends from the inlet path 15, the common liquid chamber 16, or the individual liquid chamber 17. For example, the outlet path 19 extends from the common liquid chamber 16. Therefore, ejection liquid flows through the inlet path 15, the common liquid chamber 16, and the outlet path 19 in this order to pass through the ejection section 12. The outlet path 19 may extend from the inlet path 15 or may extend from the individual liquid chamber 17. The outlet path 19 may extend from the inlet path 15 so that ejection liquid passes through the ejection section 12 without passing through the filter 18.

The inside of the ejection section 12 is usually maintained at a negative pressure. This is for forming a meniscus in the nozzle 13. By this, the ejection section 12 can appropriately eject ejection liquid. Even when the ejection liquid flows from the inlet path 15 to the outlet path 19, it is preferable that the inside of the ejection section 12 is maintained at a negative pressure. When a negative pressure of the ejection section 12 is released, a meniscus may be broken. When a meniscus is broken, the meniscus needs to be formed again in the nozzle 13.

The liquid ejection device 11 includes a liquid flow mechanism 21. The liquid flow mechanism 21 is a mechanism that causes liquid to flow. The liquid flow mechanism 21 causes ejection liquid to flow. The liquid flow mechanism 21 supplies ejection liquid to the ejection section 12 by flowing the ejection liquid. The liquid flow mechanism 21 may cause moisturizing liquid to flow in addition causing ejection liquid to flow. Moisturizing liquid is liquid for moisturizing ejection liquid. Moisturizing liquid is, for example, a glycerin aqueous solution.

The liquid flow mechanism 21 is connected to a liquid supply source. The liquid supply source accommodates liquid. The liquid supply source includes an ejection liquid supply source 22 and a moisture supply source 23. The ejection liquid supply source 22 accommodates ejection liquid. The moisture supply source 23 accommodates moisture, that is, water. The ejection liquid supply source 22 and the moisture supply source 23 may be a cartridge, a pack, or the like that can be attached to the liquid ejection device 11, or may be a tank that can be refilled with liquid.

The liquid flow mechanism 21 includes one or more liquid storage sections. In one example, the liquid flow mechanism 21 includes a first liquid storage section 24 and a second liquid storage section 25. The liquid flow mechanism 21 may include three or more liquid storage sections. A liquid storage section stores liquid. Specifically, a liquid storage section stores ejection liquid or ejection liquid and moisturizing liquid. In one example, the first liquid storage section 24 stores ejection liquid and moisturizing liquid. The second liquid storage section 25 stores ejection liquid.

A liquid storage section is connected to a liquid supply source. Therefore, ejection liquid is supplied from the ejection liquid supply source 22 to a liquid storage section. Moisture is supplied to the liquid storage section from the moisture supply source 23. In one example, the first liquid storage section 24 is connected to the ejection liquid supply source 22 and the moisture supply source 23. The second liquid storage section 25 is connected to the first liquid storage section 24. That is, the second liquid storage section 25 is connected to the liquid supply source through the first liquid storage section 24. Liquid is supplied to the second liquid storage section 25 from the first liquid storage section 24. In one example, ejection liquid is supplied to the second liquid storage section 25 from the first liquid storage section 24. The first liquid storage section 24 is not limited to being supplied with liquid from the liquid supply source, and may be configured to be supplied with liquid from the second liquid storage section 25. The second liquid storage section 25 is not limited to being supplied with liquid from the first liquid storage section 24, and may be configured to be supplied with liquid directly from the liquid supply source.

The liquid storage section includes a storage body. The storage body is configured to store ejection liquid or ejection liquid and moisturizing liquid. The first liquid storage section 24 includes a first storage body 26. The second liquid storage section 25 includes a second storage body 27. In one example, the first storage body 26 stores ejection liquid and moisturizing liquid. The second storage body 27 stores ejection liquid.

The storage body defines a storage chamber. The storage chamber is a space in which liquid is stored. The first storage body 26 defines a first storage chamber 28. The second storage body 27 defines a second storage chamber 29. In one example, ejection liquid and moisturizing liquid are stored in the first storage chamber 28. Ejection liquid is stored in the second storage chamber 29.

The liquid storage section includes a moisture permeable membrane. Specifically, at least one of the plurality of liquid storage sections includes a moisture permeable membrane. For example, at least one of the first liquid storage section 24 and the second liquid storage section 25 includes a moisture permeable membrane. That is, only the first liquid storage section 24 may have a moisture permeable membrane, only the second liquid storage section 25 may have a moisture permeable membrane, or both the first liquid storage section 24 and the second liquid storage section 25 may have a moisture permeable membrane. In one example, the first liquid storage section 24 includes a moisture permeable membrane, and the second liquid storage section 25 does not have a moisture permeable membrane. The first liquid storage section 24 includes a first moisture permeable membrane 30.

A moisture permeable membrane is attached to a storage body. The moisture permeable membrane partitions the inside of the storage body into an ejection liquid chamber and a moisturizing liquid chamber. That is, the moisture permeable membrane partitions the ejection liquid chamber and the moisturizing liquid chamber. In one example, the first moisture permeable membrane 30 is attached to the first storage body 26. The first moisture permeable membrane 30 partitions the inside of the first storage body 26 into a first ejection liquid chamber 31 and a first moisturizing liquid chamber 32.

The ejection liquid chamber is a space in which ejection liquid is stored. Ejection liquid is supplied to the ejection liquid chamber. In one example, ejection liquid is supplied to the first ejection liquid chamber 31 from the ejection liquid supply source 22. The moisturizing liquid chamber is a space in which moisturizing liquid is stored. Water is supplied to the moisturizing liquid chamber. That is, moisture is supplied to moisturizing liquid stored in the moisturizing liquid chamber. In one example, moisture is supplied to the first moisturizing liquid chamber 32 from the moisture supply source 23.

A moisture permeable membrane is a membrane that allows gas to permeate through it but does not allow liquid to permeate through it. Therefore, the moisture permeable membrane separates ejection liquid from moisturizing liquid so that ejection liquid stored in the ejection liquid chamber and moisturizing liquid stored in the moisturizing liquid chamber do not mix. A moisture permeable membrane is a porous membrane in which a plurality of thin holes is formed. The moisture permeable membrane defines a gap in communication with the plurality of thin holes. The gap is a space in the moisture permeable membrane. In this thin hole, a meniscus is generated by surface tension of liquid. The meniscus is a gas-liquid interface between liquid stored in a liquid chamber and gas positioned in a gap. By this, a moisture permeable membrane allows gas to permeate therethrough but does not allow liquid to permeate therethrough.

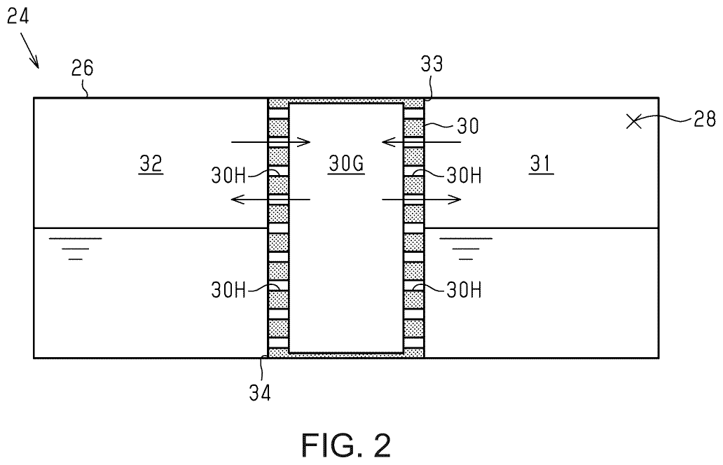

As shown in FIG. 2, a plurality of first thin holes 30H is formed in the first moisture permeable membrane 30. In the first moisture permeable membrane 30, a first gap 30G through which a plurality of first thin holes 30H communicates is formed. The first gap 30G is positioned between the first ejection liquid chamber 31 and the first moisturizing liquid chamber 32 in the first storage chamber 28. The first gap 30G communicates with the first ejection liquid chamber 31 and the first moisturizing liquid chamber 32 through the first thin hole 30H. A meniscus of ejection liquid is formed or a meniscus of moisturizing liquid is formed in the first thin hole 30H.

The moisture permeable membrane includes an upper end and a lower end. The lower end of the moisture permeable membrane is attached to the storage body. The upper end of the moisture permeable membrane is positioned at an upper end than an ejection liquid surface and a moisturizing liquid surface. That is, the storage body stores ejection liquid and moisturizing liquid such that the upper end of the moisture permeable membrane e is positioned above the ejection liquid surface and the moisturizing liquid surface. The first moisture permeable membrane 30 includes a first upper end 33 and a first lower end 34. The first upper end 33 is positioned above an ejection liquid surface of the first ejection liquid chamber 31 and a moisturizing liquid surface of the first moisturizing liquid chamber 32. That is, the first storage body 26 stores ejection liquid and moisturizing liquid such that the first upper end 33 is positioned above the ejection liquid surface of the first ejection liquid chamber 31 and the moisturizing liquid surface of the first moisturizing liquid chamber 32.

The moisture permeable membrane may completely partition the inside of the storage body. In one example, the first moisture permeable membrane 30 completely partitions the inside of the first storage body 26. That is, the first upper end 33 and the first lower end 34 are attached to the first storage body 26. By this, even if ejection liquid splashes or moisturizing liquid splashes, there is no possibility that the ejection liquid and the moisturizing liquid are mixed.

In ejection liquid, moisture may evaporate with the passage of time. When moisture evaporates from ejection liquid, the concentration of ejection liquid increases. When the concentration of ejection liquid is increases, there is a possibility that thickening of the ejection liquid occurs. If thickening of ejection liquid occurs, the ejection section 12 may not be able to appropriately eject ejection liquid.

Moisturizing liquid moisturizes ejection liquid through a moisture permeable membrane. Specifically, moisturizing liquid moisturizes ejection liquid by supplying moisture to ejection liquid through the moisture permeable membrane. Moisture contained in moisturizing liquid permeates through the moisture permeable membrane as water vapor. By this, moisture is supplied to ejection liquid. In one example, moisture of moisturizing liquid stored in the first moisturizing liquid chamber 32 is supplied to ejection liquid stored in the first ejection liquid chamber 31 by permeating the first moisture permeable membrane 30. The movement speed of moisture supplied from moisturizing liquid to ejection liquid is determined by the contact area between the ejection liquid and the moisturizing liquid through a moisture permeable membrane The larger the contact area between ejection liquid and moisturizing liquid through a moisture permeable membrane, the larger the movement speed of moisture. The movement speed of moisture is desirably larger than the evaporation speed of ejection liquid. The movement speed of moisture supplied from moisturizing liquid to ejection liquid is also determined by the thickness of a moisture permeable membrane. The thinner a moisture permeable membrane, the larger the movement speed of moisture.

For moisturizing liquid, an appropriate concentration for moisturizing ejection liquid is set. Specifically, the concentration of moisturizing liquid is set SO that the moisturizing force of fresh ejection liquid and the moisturizing force of moisturizing liquid are balanced. Moisturizing force is the ease with which moisture is released. That is, the larger the moisturizing force, the easier it is to supply moisture. If the moisturizing force of moisturizing liquid stored in a moisturizing liquid chamber is smaller than the moisturizing force of fresh ejection liquid, moisture moves from the ejection liquid to the moisturizing liquid. In this case, there is a possibility that an increase in the concentration of ejection liquid is promoted. On the other hand, if the moisturizing force of moisturizing liquid stored in a moisturizing liquid chamber is larger than the moisturizing force of fresh ejection liquid, there is a possibility that the concentration of the ejection liquid is excessively lowered. Therefore, in order to maintain ejection liquid at an appropriate concentration, a liquid storage section stores moisturizing liquid of an appropriate concentration when moisturizing the ejection liquid. By this, when moisture of ejection liquid evaporates, causing the moisturizing force of the ejection liquid to decrease, moisture moves from moisturizing liquid to ejection liquid.

When moisture moves from moisturizing liquid to ejection liquid, the moisture amount of the moisturizing liquid decreases. In moisturizing liquid, similarly to ejection liquid, moisture evaporate with the passage of time. Therefore, the may concentration of moisturizing liquid may increase. When the concentration of moisturizing liquid becomes high, there is a possibility that ejection liquid cannot be moisturized. In this regard, since moisture is supplied from the moisture supply source 23 to a moisturizing liquid chamber, a possibility that the concentration of moisturizing liquid increases is reduced.

A storage body stores liquid and air in a storage chamber. Specifically, the storage body stores ejection liquid and air in an ejection liquid chamber. The storage body stores moisturizing liquid and air in a moisturizing liquid chamber. Therefore, a liquid surface of ejection liquid exists in the ejection liquid chamber. A liquid surface of moisturizing liquid exists in the moisturizing liquid chamber. In the liquid flow mechanism 21, the liquid amount stored in a storage body is controlled so that the storage body stores liquid together with air. By storing air together with liquid in the storage body, an upper end of a moisture permeable membrane can be positioned above a liquid surface.

Since the upper end of the moisture permeable membrane is positioned above a liquid surface, ejection liquid and moisturizing liquid cannot enter and exit in the ejection liquid chamber and the moisturizing liquid chamber by the moisture permeable membrane, but air can enter and exit through the moisture permeable membrane. Specifically, air can enter and exit the ejection liquid chamber and the gap of the moisture permeable membrane. Air can enter and exit the moisturizing liquid chamber and the gap of the moisture permeable membrane. Therefore, when the ejection liquid chamber is pressurized or the ejection liquid chamber is depressurized, air moves between the ejection liquid chamber and the gap, and thus a pressure difference is less likely to occur between the ejection liquid chamber and the gap. When the moisturizing liquid chamber is pressurized or the moisturizing liquid chamber is depressurized, air moves between the moisturizing liquid chamber and the gap, and thus a pressure difference is less likely to occur between the moisturizing liquid chamber and the gap. For example, in a case where the liquid flow mechanism 21 causes ejection liquid or moisturizing liquid to flow, there is a possibility that pressure in the storage body changes. In this case, since air moves between the ejection liquid chamber and the gap, a pressure difference is less likely to occur between the ejection liquid chamber and the gap. Since air moves between the moisturizing liquid chamber and the gap, a pressure difference is less likely to occur between the moisturizing liquid chamber and the gap. This reduces a possibility of liquid seeping into the moisture permeable membrane. In one example, since there is no pressure difference between the first ejection liquid chamber 31 and the first gap 30G, a possibility of ejection liquid seeping into the first gap 30G is reduced. Since there is no pressure difference between the first moisturizing liquid chamber 32 and the first gap 30G, a possibility of moisturizing liquid seeping into the first gap 30G is reduced. If a pressure difference occurs between the ejection liquid chamber or the moisturizing liquid chamber and the gap, a meniscus formed in a thin hole of a moisture permeable membrane may be broken. For example, in a case where an upper end of the moisture permeable membrane is positioned below an ejection liquid surface and a moisturizing liquid surface, it is difficult for air to enter and exit between the ejection liquid chamber and the moisturizing liquid chamber, and the gap. Therefore, when the ejection liquid chamber is pressurized or the ejection liquid chamber is depressurized, a pressure difference occurs between the ejection liquid chamber and the gap. When the moisturizing liquid chamber is pressurized or the moisturizing liquid chamber is depressurized, a pressure difference occurs between the moisturizing liquid chamber and the gap. When a meniscus is broken, there is a possibility that ejection liquid seeps out to the moisturizing liquid chamber through the moisture permeable membrane, or moisturizing liquid seeps out to the ejection liquid chamber through the moisture permeable membrane.

As shown in FIG. 1, the liquid flow mechanism 21 includes a liquid supply flow path. The liquid supply flow path is a flow path for supplying liquid from a liquid supply source to a liquid storage section. The liquid supply flow path includes an ejection liquid supply flow path 35 and a moisture supply flow path 36. The ejection liquid supply flow path 35 is a flow path for supplying ejection liquid from the ejection liquid supply source 22 to the liquid storage section. In one example, the ejection liquid supply flow path 35 is connected to the ejection liquid supply source 22 and the first storage body 26. The ejection liquid supply flow path 35 communicates with the first ejection liquid chamber 31. The moisture supply flow path 36 is a flow path for supplying water from the moisture supply source 23 to the liquid storage section. In one example, the moisture supply flow path 36 is connected to the moisture supply source 23 and the first storage body 26. The moisture supply flow path 36 communicates with the first moisturizing liquid chamber 32.

The liquid flow mechanism 21 includes a liquid supply valve. The liquid supply valve is positioned in the liquid supply flow path. The liquid supply valve includes an ejection liquid supply valve 37 and a moisture supply valve 38. The ejection liquid supply valve 37 is positioned in the ejection liquid supply flow path 35. When the ejection liquid supply valve 37 is opened, ejection liquid can be supplied from the ejection liquid supply source 22 to the first storage body 26. The moisture supply valve 38 is positioned in the moisture supply flow path 36. When the moisture supply valve 38 is opened, moisture can be supplied from the moisture supply source 23 to the first storage body 26. Normally, the liquid supply valve is closed. When it is necessary to supply liquid to the storage body, the liquid supply valve is opened.

The liquid flow mechanism 21 includes a liquid amount detection section. The liquid amount detection section is configured to detect the amount of liquid stored in the storage body. The liquid amount detection section includes an ejection liquid amount detection section 39 and a moisturizing liquid amount detection section 40. The ejection liquid amount detection section 39 detects the amount of ejection liquid stored in the storage body. The moisturizing liquid amount detection section 40 detects the amount of moisturizing liquid stored in the storage body.

The liquid amount detection section is attached to the storage body. The liquid amount detection section is attached to the first storage body 26, for example. The ejection liquid amount detection section 39 is attached to the first storage body 26. The ejection liquid amount detection section 39 detects the ejection liquid amount of ejection liquid stored in the first ejection liquid chamber 31. The moisturizing liquid amount detection section 40 is attached to the first storage body 26. The moisturizing liquid amount detection section 40 detects the liquid amount of moisturizing liquid stored in the first moisturizing liquid chamber 32. The liquid amount detection section is not limited to the first storage body 26 and may be attached to other storage bodies. For example, the liquid amount detection section may be attached to the second storage body 27.

The liquid amount detection section may detect the liquid amount based on energization between electrodes, or may detect the liquid amount based on reflected light by a prism. The liquid amount detection section may detect the liquid amount based on the vibration waveform of liquid by a piezoelectric sensor. The liquid amount detection section may detect the liquid amount based on pressure of liquid detected by a pressure sensor. Since the liquid amount detection section detects the liquid amount, the storage body can store air together with liquid. That is, the liquid amount of the storage body is controlled by the liquid amount detection section. The liquid amount is controlled based on the liquid amount detection section, and thus the storage body stores air together with liquid.

The moisturizing liquid amount of the storage body is controlled by the liquid amount detection section detecting the moisturizing liquid amount. By controlling the moisturizing liquid amount of the storage body, the moisturizing liquid is maintained at an appropriate concentration. When moisture is supplied to moisturizing liquid stored in the moisturizing liquid chamber, the concentration of moisturizing liquid is reduced. That is, the supply amount of moisture affects the moisturizing force of moisturizing liquid. Therefore, moisture is supplied so that the moisturizing liquid amount stored in the storage body is constant, whereby moisturizing liquid stored in the moisturizing liquid chamber is maintained at an appropriate concentration. In one example, moisturizing liquid stored in the first moisturizing liquid chamber 32 is maintained at an appropriate concentration by supplying moisture such that the moisturizing liquid amount stored in the first moisturizing liquid chamber 32 is constant based on a detection result of the moisturizing liquid amount detection section 40.

The liquid flow mechanism 21 includes an ejection liquid flow path 41. The ejection liquid flow path 41 is a flow path through which ejection liquid flows. The ejection liquid flow path 41 is a flow path for flowing ejection liquid stored in the storage body. The ejection liquid flow path 41 may include a flow path for circulating ejection liquid, or may include a flow path for supplying ejection liquid to the ejection section 12. In one example, the ejection liquid flow path 41 is a flow path for circulating ejection liquid, and is also a flow path for supplying ejection liquid to the ejection section 12. Therefore, the ejection section 12 can eject ejection liquid stored in the storage body.

The ejection liquid flow path 41 is connected to the storage body. In one example, the ejection liquid flow path 41 is connected to the first storage body 26 and the second storage body 27. The ejection liquid flow path 41 communicates with the storage chamber. Specifically, the ejection liquid flow path 41 communicates with the first ejection liquid chamber 31. The ejection liquid flow path 41 communicates with the second storage chamber 29. Ejection liquid may flow into the storage chamber through the ejection liquid flow path 41, or ejection liquid may flow out from the storage chamber.

The ejection liquid flow path 41 includes a first connection end 42 and a second connection end 43. The first connection end 42 and the second connection end 43 are end sections of the ejection liquid flow path 41. The first connection end 42 and the second connection end 43 are connected to the storage body. For example, the first connection end 42 and the second connection end 43 are connected to the first storage body 26. The first connection end 42 and the second connection end 43 communicate with the first ejection liquid chamber 31. Ejection liquid circulates by flowing through the ejection liquid flow path 41. Circulating ejection liquid is moisturized by moisturizing liquid. Therefore, the entire ejection liquid is moisturized by moisturizing liquid.

The ejection liquid flow path 41 includes a first connection flow path 44 and a second connection flow path 45. The first connection flow path 44 is connected to the first storage body 26 and the second storage body 27. The first connection flow path 44 includes a first connection end 42. The second connection flow path 45 is connected to the first storage body 26 and the second storage body 27. The second connection flow path 45 includes a second connection end 43. The first connection flow path 44 and the second connection flow path 45 circulate ejection liquid and supply ejection liquid to the ejection section 12.

The ejection liquid flow path 41 is connected to the ejection section 12. Specifically, the ejection section 12 is positioned in the ejection liquid flow path 41. Therefore, ejection liquid is supplied from the storage body to the ejection section 12 through the ejection liquid flow path 41. In one example, the ejection section 12 is positioned in the first connection flow path 44. Therefore, ejection liquid is circulated through the ejection section 12, the first storage body 26, and the second storage body 27 through the ejection liquid flow path 41. For example, when circulating, ejection liquid flows from the second storage body 27 to the first storage body 26 through the first connection flow path 44. When circulating, ejection liquid flows from the first storage body 26 to the second storage body 27 through the second connection flow path 45.

The ejection liquid flow path 41 may independently include a flow path for circulating ejection liquid and a flow path for supplying ejection liquid to the ejection section 12. The ejection liquid flow path 41 may include, for example, a bypass flow path 46. The bypass flow path 46 is a flow path for circulating ejection liquid without passing through the ejection section 12. The bypass flow path 46 is connected to the first storage body 26. In this case, both ends of the bypass flow path 46 correspond to the first connection end 42 and the second connection end 43. In addition to the bypass flow path 46, the ejection liquid flow path 41 may include a liquid feed flow path connected to the first storage body 26 and the ejection section 12.

The liquid flow mechanism 21 includes a pressure change mechanism 51. The pressure change mechanism 51 is connected to the liquid storage section. The pressure change mechanism 51 is a mechanism that changes pressure in the storage body. The pressure change mechanism 51 causes liquid to flow by changing pressure in the storage body. The pressure change mechanism 51 changes pressure in the first storage body 26. The pressure change mechanism 51 changes pressure in the second storage body 27.

The pressure change mechanism 51 is connected to the storage body. The pressure change mechanism 51 is connected to the first storage body 26. The pressure change mechanism 51 is connected to the second storage body 27. The pressure change mechanism 51 communicates with the first storage chamber 28. In one example, the pressure change mechanism 51 communicates with the first ejection liquid chamber 31 and the first moisturizing liquid chamber 32. The pressure change mechanism 51 communicates with the second storage chamber 29.

The pressure change mechanism 51 generates a pressure difference between the first storage body 26 and the second storage body 27. By this, liquid flows between the first storage body 26 and the second storage body 27. In one example, ejection liquid flows from the second storage body 27 to the first storage body 26 through the first connection flow path 44. By this, liquid is circulated between the first storage body 26 and the second storage body 27.

When changing pressure of the storage chamber, the pressure change mechanism 51 may change pressure of the ejection liquid chamber or may change pressure of the moisturizing liquid chamber. In any case, since air enter and exit between the ejection liquid chamber and the moisturizing liquid chamber through the moisture permeable membrane, pressure in the ejection liquid chamber and pressure in the moisturizing liquid chamber change in the same manner. Therefore, the pressure change mechanism 51 may pressurize or depressurize the first ejection liquid chamber 31, or may pressurize or depressurize the first moisturizing liquid chamber 32.

The pressure change mechanism 51 includes a change section. The change section is connected to the storage body. In one example, the pressure change mechanism 51 includes a first change section 52 and a second change section 53. The first change section 52 is connected to the first storage body 26. The second change section 53 is connected to the second storage body 27.

The change section changes pressure in the storage body. The change section pressurizes or depressurizes the inside of the storage body. The change section communicates with an upper section of the storage chamber. That is, the change section communicates with air stored in the storage body. The change section changes pressure in the storage body by sending air into the storage body or drawing air from the storage body. The change section causes liquid to flow by changing pressure in the storage body. The first change section 52 changes pressure in the first storage body 26. The first change section 52 communicates with an upper section of the first storage chamber 28. The second change section 53 changes pressure in the second storage body 27. The second change section 53 communicates with an upper section of the second storage chamber 29.

The first change section 52 and the second change section 53 change pressure in the first storage body 26 and pressure in the second storage body 27 so as to generate a pressure difference between the first storage body 26 and the second storage body 27. Specifically, the first change section 52 and the second change section 53 respectively change pressure in the first storage body 26 and pressure in the second storage body 27 so that pressure in the first storage body 26 becomes smaller than pressure in the second storage body 27. By this, ejection liquid flows from the second storage body 27 to the first storage body 26 through the first connection flow path 44. That is, ejection liquid flows in the ejection section 12 from the inlet path 15 toward the outlet path 19.

The first change section 52 normally changes pressure in the first storage body 26 such that the inside of the ejection section 12 is maintained at a predetermined negative pressure. The second change section 53 normally changes pressure in the second storage body 27 such that the inside of the ejection section 12 is maintained at a predetermined negative pressure. By this, the ejection section 12 can appropriately eject ejection liquid while causing ejection liquid to flow from the second storage body 27 to the first storage body 26.

The change section includes a change pump. The change pump is connected to the storage body. The change pump is a pump that changes pressure in the storage body. The change pump is, for example, a diaphragm pump. The first change section 52 includes a first change pump 54. The first change pump 54 is, for example, a depressurization pump. The first change pump 54 is connected to the first storage body 26. The first change pump 54 depressurizes the inside of the first storage body 26. Specifically, the first change pump 54 depressurizes the inside of the first storage body 26 by drawing air from the first storage body 26. The second change section 53 includes a second change pump 55. The second change pump 5 is, for example, a pressurization pump. The second change pump 55 is connected to the second storage body 27. The second change pump 55 pressurizes the inside of the second storage body 27. Specifically, the second change pump 55 pressurizes the inside of the second storage body 27 by sending air into the second storage body 27.

The first change pump 54 is driven to cause liquid to flow into the first storage body 26. When the first change pump 54 depressurizes the inside of the first storage body 26, liquid flows into the first storage body 26. For example, when the first change pump 54 depressurizes the inside of the first storage body 26, ejection liquid can flow from the ejection liquid supply source 22 into the first storage body 26. When the first change pump 54 depressurizes the inside of the first storage body 26, moisture flows from the moisture supply source 23 into the first storage body 26. When the first change pump 54 depressurizes the inside of the first storage body 26, ejection liquid flows from the ejection section 12 into the first storage body 26 through the first connection flow path 44.

The second change pump 55 is driven to cause liquid to flow out from the second storage body 27. When the second change pump 55 pressurizes the second storage body 27, liquid flows out from the second storage body 27. For example, when the second change pump 55 pressurizes the inside of the second storage body 27, ejection liquid flows out from the second storage body 27 toward the ejection section 12 through the first connection flow path 44.

The second change pump 55 is not limited to a pressurization pump, and may be a depressurization pump in the same manner as the first change pump 54, or may be a pump capable of pressurizing and depressurizing the inside of the second storage body 27. In this case, the second change pump 55 depressurizes the inside of the second storage body 27 so that pressure in the second storage body 27 becomes larger than pressure in the first storage body 26. Also in this case, since a pressure difference occurs between the first storage body 26 and the second storage body 27, ejection liquid flows from the second storage body 27 to the first storage body 26 through the first connection flow path 44. The second change pump 55 depressurizes the inside of the second storage body 27, thereby allowing ejection liquid to flow back from the ejection section 12 to the second storage body 27. In this case, air bubbles collected by the filter 18 flow to the second storage body 27, and thus the air bubbles can be removed from the filter 18.

The change section includes a pressure sensor. The pressure sensor is connected to the storage body. The pressure sensor detects pressure in the storage body. The first change section 52 includes a first pressure sensor 56. The first pressure sensor 56 is connected to the first storage body 26. The first pressure sensor 56 detects pressure in the first storage body 26. The second change section 53 includes a second pressure sensor 57. The second pressure sensor 57 is connected to the second storage body 27. The second pressure sensor 57 detects pressure in the second storage body 27. In the change section, the change pump is driven based on a detection result of the pressure sensor. By this, the inside of the ejection section 12 is maintained at a predetermined negative pressure.

The change section includes an atmosphere release valve. The atmosphere release valve is connected to the storage body. The atmosphere release valve is a valve that opens the inside of the storage body to the atmosphere. The first change section 52 includes a first atmosphere release valve 58. The first atmosphere release valve 58 is connected to the first storage body 26. The first atmosphere release valve 58 opens the inside of the first storage body 26 to the atmosphere. The second change section 53 includes a second atmosphere release valve 59. The second atmosphere release valve 59 is connected to the second storage body 27. The second atmosphere release valve 59 opens the inside of the second storage body 27 to the atmosphere. The atmosphere release valve includes a thin pipe that allows the inside of the storage body to communicate with the atmosphere in order to suppress evaporation of liquid in the storage body. Since the flow path resistance of the thin pipe is large, liquid becomes difficult to evaporate. That is, moisture contained in ejection liquid and moisture contained in moisturizing liquid are less likely to evaporate.

The pressure change mechanism 51 includes a liquid feed pump 60 that causes liquid to flow. The liquid feed pump 60 is positioned in the second connection flow path 45. The liquid feed pump 60 feeds ejection liquid from the first storage body 26 to the second storage body 27 through the second connection flow path 45. Therefore, in one example, ejection liquid is circulated by the first change pump 54, the second change pump 55, and the liquid feed pump 60.

The liquid feed pump 60 may be positioned in the bypass flow path 46. Specifically, when the ejection liquid flow path 41 includes the bypass flow path 46, the liquid feed pump 60 may be positioned in the bypass flow path 46. In this case, when the liquid feed pump 60 is driven, pressure in the first storage body 26 changes and ejection liquid circulates through the bypass flow path 46.

The liquid flow mechanism 21 includes a stirring section 61. The stirring section 61 is configured to stir moisturizing liquid. By the stirring section 61 stirring moisturizing liquid, the concentration of moisturizing liquid is made uniform. By this, a possibility that the concentration of moisturizing liquid increases is reduced.

The stirring section 61 is attached to the storage body. The stirring section 61 stirs moisturizing liquid stored in the storage body. In one example, the stirring section 61 is attached to the first storage body 26. The stirring section 61 stirs moisturizing liquid stored in the first storage body 26. That is, the stirring section 61 stirs moisturizing liquid stored in the first moisturizing liquid chamber 32.

The stirring section 61 includes a stirring flow path 62. The stirring flow path 62 includes a first end 63 and a second end 64. The first end 63 and the second end 64 are connected to the first storage body 26. The first end 63 and the second end 64 communicate with the first moisturizing liquid chamber 32. In one example, the stirring flow path 62 constitutes a part of the moisture supply flow path 36. For example, the first end 63 coincides with an end section of the moisture supply flow path 36. The stirring flow path 62 may be a flow path independent of the moisture supply flow path 36.

The stirring section 61 includes a stirring pump 65. The stirring pump 65 is positioned in the stirring flow path 62. The stirring pump 65 circulates moisturizing liquid of the first storage body 26 through the stirring flow path 62. By this, moisturizing liquid is stirred. In one example, when the stirring pump 65 is driven, moisturizing liquid flows through the stirring flow path 62 from the first end 63 toward the second end 64. That is, moisturizing liquid circulates in the stirring flow path 62.

The stirring section 61 is not limited to the configuration including the stirring flow path 62 and the stirring pump 65, and may be configured to including a fin for stirring and mixing moisturizing liquid of the first storage body 26. In this case, moisturizing liquid of the first moisturizing liquid chamber 32 is stirred by driving the fin.

The liquid ejection device 11 includes a control section 67. The control section 67 controls various components included in the liquid ejection device 11. The control section 67 controls the ejection section 12. The control section 67 controls the liquid flow mechanism 21. For example, the control section 67 controls the ejection liquid supply valve 37, the moisture supply valve 38, the pressure change mechanism 51, and the stirring section 61.

The control section 67 may be configured by one or more processors that execute various processes according to a computer program. The control section 67 may be configured by one or more dedicated hardware circuitry such as an ASIC that executes at least a part of various processes. The control section 67 may be constituted by circuitry including a combination of a processor and hardware circuitry. The processor includes a CPU and memories such as a RAM and a ROM. The memory stores program code or commands configured to cause the CPU to perform the processes. Memory, that is, computer readable medium, includes any readable medium that can be accessed by a general-purpose or dedicated computer.

The control section 67 drives the first change pump 54 so that the inside of the ejection section 12 is maintained at a predetermined negative pressure. The control section 67 drives the second change pump 55 so that the inside of the ejection section 12 is maintained at a predetermined negative pressure. Further, the control section 67 drives the liquid feed pump 60. By this, the control section 67 circulates ejection liquid. Circulating ejection liquid is moisturized by moisturizing liquid.

The control section 67 may supply moisture from the moisture supply source 23 to the first storage body 26 by driving the stirring section 61. The control section 67 may supply moisture from the moisture supply source 23 to the first storage body 26 by driving the stirring pump 65 in a state where the moisture supply valve 38 is opened. By this, the control section 67 supplies moisture to moisturizing liquid stored in the first moisturizing liquid chamber 32.

The control section 67 may circulate moisturizing liquid by driving the stirring section 61. The control section 67 circulates moisturizing liquid by driving the stirring pump 65 in a state in which the moisture supply valve 38 is closed.

The control section 67 may circulate liquid at all times or may circulate liquid at a predetermined timing. That is, control section 67 may circulate ejection liquid and moisturizing liquid at all times or at a predetermined timing. The control section 67 may circulate liquid during printing. The control section 67 may circulate liquid during maintenance of the liquid ejection device 11. The control section 67 may circulate liquid when it is determined that liquid needs to be circulated. The control section 67 may determine whether it is necessary to circulate liquid based on the temperature and humidity at the time of printing, the print duty, the elapsed time, and the like. For example, when the temperature and humidity are high, the control section 67 determines that liquid needs to be circulated. When the print duty is small, the control section 67 determines that it is necessary to circulate liquid. When the elapsed time is long, the control section 67 determines that liquid needs to be circulated. The elapsed time is a time elapsed from the previous printing, a time elapsed from the previous liquid supply, or the like.

The control section 67 controls the liquid supply valve based on a detection result of the liquid amount detection section. That is, the control section 67 controls the ejection liquid supply valve 37 based on a detection result of the ejection liquid amount detection section 39. The control section 67 controls the moisture supply valve 38 based on a detection result of the moisturizing liquid amount detection section 40.

The control section 67 opens the ejection liquid supply valve 37 when the ejection liquid amount detected by the ejection liquid amount detection section 39 is equal to or less than a threshold. By this, ejection liquid can be supplied from the ejection liquid supply source 22 to the first storage body 26. At this time, the control section 67 supplies ejection liquid from the ejection liquid supply source 22 to the first storage body 26 by causing the first change section 52 to depressurize the inside of the first storage body 26. The control section 67 closes the ejection liquid supply valve 37 when the ejection liquid amount detected by the ejection liquid amount detection section 39 is larger than a threshold. By this, the ejection liquid amount stored in the first storage body 26 is maintained in a state larger than the threshold.

The control section 67 opens the moisture supply valve 38 when the moisturizing liquid amount detected by the moisturizing liquid amount detection section 40 is equal to or less than a threshold. By this, moisture can be supplied from the moisture supply source 23 to the first storage body 26. At this time, the control section 67 supplies moisture from the moisture supply source 23 to the first storage body 26 by causing the first change section 52 to depressurize the inside of the first storage body 26. The control section 67 closes the moisture supply valve 38 when the moisturizing liquid amount detected by the moisturizing liquid amount detection section 40 is larger than a threshold. By this, the moisturizing liquid amount stored in the first storage body 26 is maintained in a state larger than the threshold. Therefore, moisturizing liquid is maintained at an appropriate concentration. A threshold of the ejection liquid amount and a threshold of the moisturizing liquid amount may be different values.

The control section 67 may supply liquid from the liquid supply source to the first storage body 26 by a water head difference between the liquid supply source and the first storage body 26 without using the first change section 52. In this case, a liquid surface stored in the liquid supply source is positioned above a liquid surface stored in the first storage body 26. The control section 67 opens the liquid supply valve based on a detection result of the liquid amount detection section, thereby supplying liquid to the first storage body 26.

### Operations and Effects

Next, the operations and effects of the first embodiment will be described.
(1) The first storage body 26 stores ejection liquid and moisturizing liquid such that a liquid surface of ejection liquid stored in the first ejection liquid chamber 31 and a liquid surface of moisturizing liquid stored in the first moisturizing liquid chamber 32 are positioned below the first upper end 33. According to the above-described configuration, the first ejection liquid chamber 31 stores ejection liquid and air, and the first moisturizing liquid chamber 32 stores moisturizing liquid and air. Air can move between the first ejection liquid chamber 31 and the first gap 30G. Air can move between the first moisturizing liquid chamber 32 and the first gap 30G. Therefore, even if pressure is applied to ejection liquid, a pressure difference is less likely to occur between the first ejection liquid chamber 31 and the first gap 30G. Even if pressure is applied to moisturizing liquid, a pressure difference is less likely to occur between the first moisturizing liquid chamber 32 and the first gap 30G. This reduces a possibility that liquid seeps into the first moisture permeable membrane 30.
(2) The first storage body 26 is connected to the pressure change mechanism 51 so that an upper section of the first ejection liquid chamber 31 or an upper section of the first moisturizing liquid chamber 32 communicates with the pressure change mechanism 51. According to the above-described configuration, even if the pressure change mechanism 51 changes pressure of the first ejection liquid chamber 31 or changes pressure of the first moisturizing liquid chamber 32, a pressure difference is less likely to occur between the first ejection liquid chamber 31 or the first moisturizing liquid chamber 32 and the first gap 30G. This reduces a possibility that liquid seeps into the first moisture permeable membrane 30.
(3) The liquid flow mechanism 21 includes the ejection liquid flow path 41 which is connected to the first storage body 26 and communicates with the first ejection liquid chamber 31. Liquid in the first ejection liquid chamber 31 flows through the ejection liquid flow path 41 by the pressure change mechanism 51 changing pressure in the first storage body 26. At this time, if a pressure difference occurs between the first ejection liquid chamber 31 and the first moisturizing liquid chamber 32, there is a possibility that liquid seeps into the first moisture permeable membrane 30. In this regard, according to the above-described configuration, the first ejection liquid chamber 31 stores ejection liquid and air, and the first moisturizing liquid chamber 32 stores moisturizing liquid and air. Air can move between the first ejection liquid chamber 31 and the first moisturizing liquid chamber 32. Therefore, even if the pressure change mechanism 51 changes pressure of the first ejection liquid chamber 31 or changes pressure of the first moisturizing liquid chamber 32, a pressure difference is less likely to occur between the first ejection liquid chamber 31 or the first moisturizing liquid chamber 32 and the first gap 30G. This reduces a possibility that liquid seeps into the first moisture permeable membrane 30.
(4) The first connection end 42 and the second connection end 43 communicate with the first ejection liquid chamber 31. According to the above-described configuration, ejection liquid flows through the ejection liquid flow path 41 by the pressure change mechanism 51 changing pressure in the first storage body 26. By this, ejection liquid stored in the first storage body 26 circulates through the ejection liquid flow path 41. As ejection liquid is circulated, moisture is supplied from moisturizing liquid to the entire ejection liquid. Therefore, moisturizing liquid can effectively moisturize ejection liquid.
(5) The ejection section 12 is positioned in the ejection liquid flow path 41. According to the above-described configuration, the ejection section 12 ejects ejection liquid that is effectively moisturized by moisturizing liquid. Therefore, the ejection section 12 can appropriately eject ejection liquid.
(6) The pressure change mechanism 51 includes the first change section 52 that changes pressure in the first storage body 26 and the second change section 53 that changes pressure in the second storage body 27. According to the above-described configuration, the pressure change mechanism 51 changes pressure in the first storage body 26 and pressure in the second storage body 27, thereby causing ejection liquid to circulate in the ejection liquid flow path 41. By this, circulating ejection liquid is moisturized by moisturizing liquid.
(7) The liquid flow mechanism 21 includes the stirring section 61 that stirs moisturizing liquid stored in the first moisturizing liquid chamber 32. According to the above-described configuration, since the stirring section 61 stirs moisturizing liquid, a possibility that the concentration of moisturizing liquid increases is reduced.
(8) The stirring section 61 includes the stirring flow path 62 through which moisturizing liquid stored in the first moisturizing liquid chamber 32 circulates, and a stirring pump 65 positioned in the stirring flow path 62. According to the above-described configuration, when the stirring pump 65 is driven, moisturizing liquid stored in the first moisturizing liquid chamber 32 circulates through the stirring flow path 62. By this, moisturizing liquid stored in the first moisturizing liquid chamber 32 is stirred. Therefore, a possibility that the concentration of moisturizing liquid increases is reduced.

### Second Embodiment

Next, a second embodiment of the liquid ejection device 11 will be described. In the second embodiment, the configuration of the pressure change mechanism 51 is different from that in the first embodiment. In the second embodiment, the differences from the first embodiment will be mainly described.

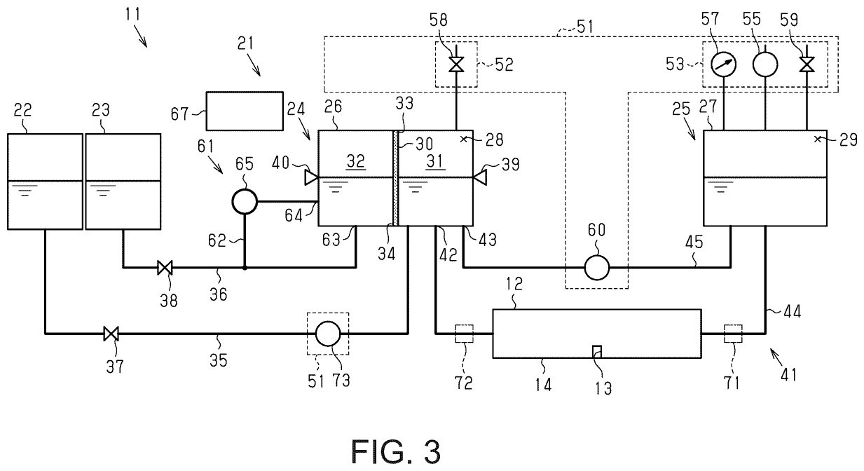

As shown in FIG. 3, the first change section 52 includes the first atmosphere release valve 58. The first change section 52 causes the inside of the first storage body 26 to change to atmospheric pressure by the first atmosphere release valve 58. The second change section 53 includes the second change pump 55, the second pressure sensor 57, and the second atmosphere release valve 59. The second change pump 55 pressurizes the inside of the second storage body 27. When the second change pump 55 pressurizes the inside of the second storage body 27, ejection liquid flows from the second storage body 27 to the ejection section 12. Accordingly, ejection liquid flows from the ejection section 12 to the first storage body 26. When the liquid feed pump 60 is driven, ejection liquid flows from the first storage body 26 to the second storage body 27. In this manner, ejection liquid may be circulated by the second change pump 55 and the liquid feed pump 60. However, in this case, a negative pressure in the ejection section 12 is not maintained when ejection liquid is circulated. Therefore, in this example, it is difficult to circulate ejection liquid while maintaining the inside of the ejection section 12 at a negative pressure. Therefore, when ejection liquid is circulated by the second change pump 55 and the liquid feed pump 60, it is desirable to circulate ejection liquid at a timing other than during printing.

The liquid flow mechanism 21 may include a differential pressure valve. For example, the liquid flow mechanism 21 may include a first differential pressure valve 71 and a second differential pressure valve 72. The first differential pressure valve 71 and the second differential pressure valve 72 are positioned in the first connection flow path 44. Specifically, the first differential pressure valve 71 is positioned between the second storage body 27 and the ejection section 12 in the first connection flow path 44. The second differential pressure valve 72 is positioned between the ejection section 12 and the first storage body 26 in the first connection flow path 44.

The differential pressure valve is configured to open and close by a differential pressure from atmospheric pressure. The first differential pressure valve 71 opens when pressure in the ejection section 12 falls below a predetermined value, for example, when the ejection liquid amount in the ejection section 12 becomes small. The second differential pressure valve 72 opens when pressure in the ejection section 12 exceeds a predetermined value, for example, when the ejection liquid amount in the ejection section 12 becomes large. By this, the inside of the ejection section 12 is maintained at a negative pressure.

Pressure in the ejection section 12 at which the first differential pressure valve 71 opens may be different from pressure in the ejection section 12 at which the second differential pressure valve 72 opens. For example, pressure in the ejection section 12 at which the first differential pressure valve 71 opens may be larger than pressure in the ejection section 12 at which the second differential pressure valve 72 opens. By this, ejection liquid flows from the inlet path 15 toward the outlet path 19. Therefore, even when ejection liquid is circulated by the second change pump 55 and the liquid feed pump 60, the ejection liquid can be circulated while maintaining the inside of the ejection section 12 at a negative pressure by the differential pressure valve.

The liquid flow mechanism 21 may maintain the inside of the ejection section 12 at a negative pressure by a water head difference. In this case, for example, the ejection section 12 is positioned such that the nozzle surface 14 is positioned above an ejection liquid surface of the first storage body 26. By this, when ejection liquid is circulated by the second change pump 55 and the liquid feed pump 60, the ejection liquid can be circulated while maintaining the inside of the ejection section 12 at a negative pressure.

The pressure change mechanism 51 may include a supply pump 73. The supply pump 73 is positioned in the ejection liquid supply flow path 35. When the supply pump 73 is driven, ejection liquid is supplied from the ejection liquid supply source 22 to the first storage body 26. When the pressure change mechanism 51 does not include a configuration of depressurizing the inside of the first storage body 26, the pressure change mechanism 51 may include a supply pump 73. In this example, when the stirring pump 65 is driven, moisture is supplied from the moisture supply source 23 to the first storage body 26. Additionally, even in a case where the pressure change mechanism 51 includes a configuration of depressurizing the inside of the first storage body 26, the pressure change mechanism 51 may include the supply pump 73.

### Third Embodiment

Next, a third embodiment of the liquid ejection device 11 will be described. In the third embodiment, the configuration of the pressure change mechanism 51 is different from that in the first embodiment. In the third embodiment, the differences from the first embodiment will be mainly described.

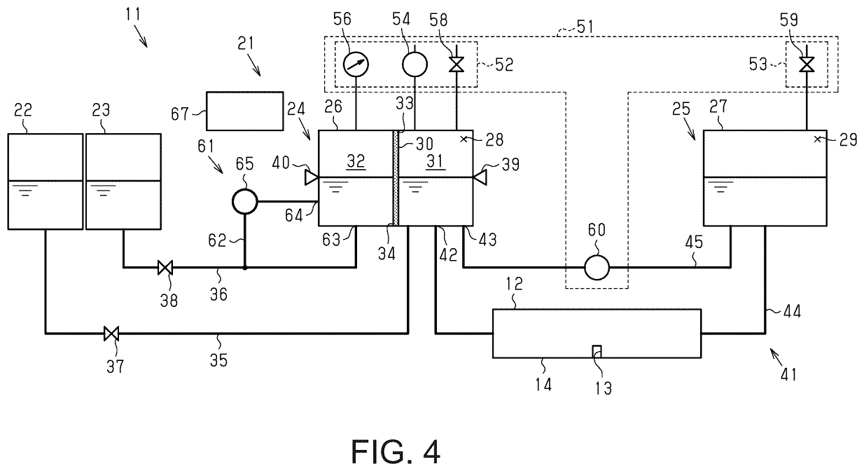

As shown in FIG. 4, the second change section 53 includes the second atmosphere release valve 59. The second change section 53 causes the inside of the second storage body 27 to change to atmospheric pressure by the second atmosphere release valve 59. The first change section 52 includes the first change pump 54, the first pressure sensor 56, and the first atmosphere release valve 58. The first change pump 54 depressurizes the inside of the first storage body 26. When the first change pump 54 depressurizes the inside of the first storage body 26, ejection liquid flows from the ejection section 12 to the first storage body 26. Accordingly, ejection liquid flows from the second storage body 27 to the ejection section 12. When the liquid feed pump 60 is driven, ejection liquid flows from the first storage body 26 to the second storage body 27. In this manner, ejection liquid may be circulated by the first change pump 54 and the liquid feed pump 60.

### Fourth Embodiment

Next, a fourth embodiment of the liquid ejection device 11 will be described. In the fourth embodiment, the configuration of the pressure change mechanism 51 is different from that in the first embodiment. In the fourth embodiment, the differences from the first embodiment will be mainly described.

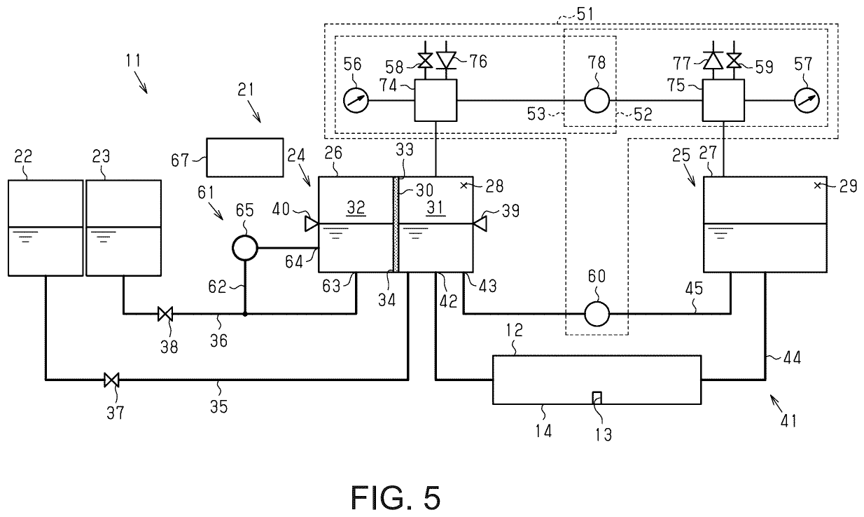

As shown in FIG. 5, the pressure change mechanism 51 includes a relay body. Specifically, the pressure change mechanism 51 includes a first relay body 74 and a second relay body 75. The relay body is connected to the storage body. The relay body stores air. The relay body communicates with an upper section of the storage body. Therefore, air can enter and exit between the relay body and the storage body. The first relay body 74 is connected to the first storage body 26. Air can enter and exit between the first relay body 74 and the first storage body 26. The second relay body 75 is connected to the second storage body 27. Air can enter and exit between the second relay body 75 and the second storage body 27.

The first pressure sensor 56 is connected to the first relay body 74. The first pressure sensor 56 detects pressure in the first relay body 74. The first pressure sensor 56 detects pressure in the first storage body 26 by detecting pressure in the first relay body 74. The second pressure sensor 57 is connected to the second relay body 75. The second pressure sensor 57 detects pressure in the second relay body 75. The second pressure sensor 57 detects pressure in the second storage body 27 by detecting pressure in the second relay body 75.

The first atmosphere release valve 58 is connected to the first relay body 74. The first atmosphere release valve 58 connects the inside of the first relay body 74 to the atmosphere. The first atmosphere release valve 58 connects the inside of the first relay body 74 to the atmosphere, thereby connecting the inside of the first storage body 26 to the atmosphere. The second atmosphere release valve 59 is connected to the second relay body 75. The second atmosphere release valve 59 connects the inside of the second relay body 75 to the atmosphere. The second atmosphere release valve 59 connects the inside of the second relay body 75 to the atmosphere, thereby connecting the inside of the second storage body 27 to the atmosphere.

The pressure change mechanism 51 includes a pressure adjustment valve. Specifically, the pressure change mechanism 51 includes a first pressure adjustment valve 76 and a second pressure adjustment valve 77. The first pressure adjustment valve 76 is connected to the first relay body 74. The first pressure adjustment valve 76 is connected to the first storage body 26 through the first relay body 74. The second pressure adjustment valve 77 is connected to the second relay body 75. The second pressure adjustment valve 77 is connected to the second storage body 27 through the second relay body 75.

The pressure adjustment valve is a valve that adjusts pressure in the storage body. Specifically, the pressure adjustment valve adjusts pressure in the storage body by adjusting pressure in the relay body. In one example, the pressure adjustment valve is, for example, a solenoid valve. The pressure adjustment valve, for example, opens and closes based on a detection result of the pressure sensor. Specifically, the opening degree of the pressure adjustment valve is determined by a detection result of the pressure sensor. The first pressure adjustment valve 76 opens and closes based on a detection result of the first pressure sensor 56. For example, the first pressure adjustment valve 76 opens and closes so that pressure in the first relay body 74 does not fall below a predetermined value. By this, a possibility that pressure in the first storage body 26 becomes too small is reduced. The second pressure adjustment valve 77 opens and closes based on a detection result of the second pressure sensor 57. The second pressure adjustment valve 77 opens and closes so that pressure in the second relay body 75 does not exceed a predetermined value. By this, the possibility that pressure in the second storage body 27 becomes too large is reduced. A predetermined value of the first pressure adjustment valve 76 may be different from a predetermined value of the second pressure adjustment valve 77.

The pressure change mechanism 51 includes a common pump 78. The common pump 78 is connected to the first relay body 74 and the second relay body 75. The common pump 78 depressurizes the inside of the first relay body 74. The common pump 78 depressurizes the inside of the first storage body 26 by depressurizing the first relay body 74. The common pump 78 pressurizes the inside of the second relay body 75. The common pump 78 pressurizes the inside of the second storage body 27 by pressurizing the inside of the second relay body 75.

When the common pump 78 is driven, the inside of the first storage body 26 is depressurized. When the common pump 78 is driven, the inside of the second storage body 27 is pressurized. By this, ejection liquid flows from the second storage body 27 to the first storage body 26 through the first connection flow path 44. In this way, ejection liquid may be circulated by the common pump 78 and the liquid feed pump 60. In this example, the first change section 52 includes the first pressure sensor 56, the first atmosphere release valve 58, the first relay body 74, the first pressure adjustment valve 76, and the common pump 78. The second change section 53 includes the second pressure sensor 57, the second atmosphere release valve 59, the second relay body 75, the second pressure adjustment valve 77, and the common pump 78.

### Fifth Embodiment

Next, a fifth embodiment of the liquid ejection device 11 will be described. In the fifth embodiment, the configuration of the pressure change mechanism 51 is different from that in the first embodiment. In the fifth embodiment, the differences from the first embodiment will be mainly described.

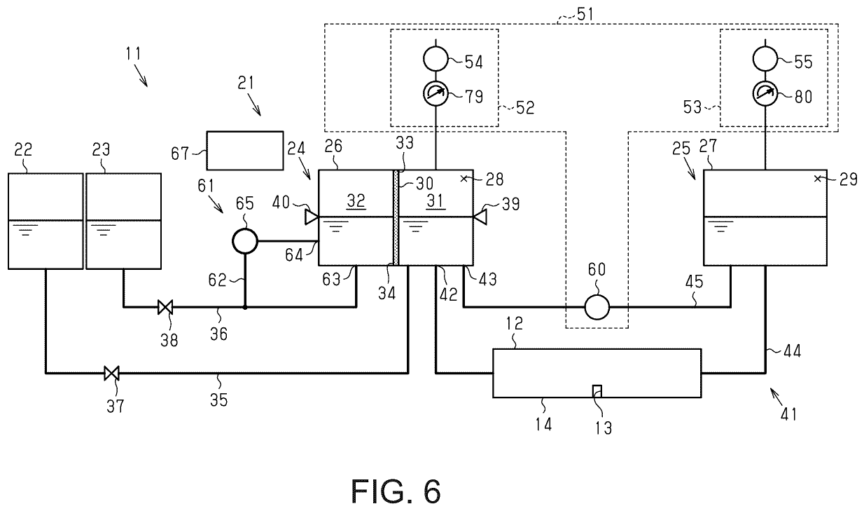

As shown in FIG. 6, the pressure change mechanism 51 includes a regulator. Specifically, the pressure change mechanism 51 includes a first regulator 79 and a second regulator 80. The first regulator 79 is connected to the first storage body 26. The first regulator 79 is connected to the first change pump 54. The first regulator 79 is positioned between the first storage body 26 and the first change pump 54. The second regulator 80 is connected to the second storage body 27. The second regulator 80 is connected to the second change pump 55. The second regulator 80 is positioned between the second storage body 27 and the second change pump 55.

The regulator regulates pressure in the storage body. The first regulator 79 regulates pressure in the first storage body 26. By this, the first change pump 54 can depressurize the inside of the first storage body 26 such that the inside of the ejection section 12 is maintained at a predetermined negative pressure. The second regulator 80 regulates pressure in the second storage body 27. By this, the second change pump 55 can pressurize the inside of the second storage body 27 such that the inside of the ejection section 12 is maintained at a predetermined negative pressure. In this example, the first change section 52 includes the first change pump 54 and the first regulator 79. The second change section 53 includes the second change pump 55 and the second regulator 80.

### Sixth Embodiment

Next, a sixth embodiment of the liquid ejection device 11 will be described. In the sixth embodiment, the configuration of the pressure change mechanism 51 is different from that in the first embodiment. In the sixth embodiment, the differences from the first embodiment will be mainly described.

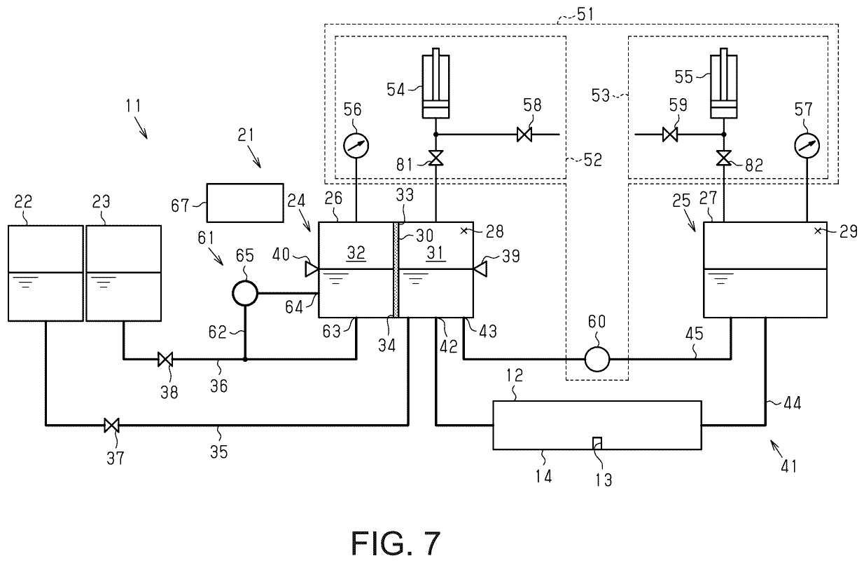

As shown in FIG. 7, the pressure change mechanism 51 includes a switching valve. Specifically, the pressure change mechanism 51 includes a first switching valve 81 and a second switching valve 82. The first switching valve 81 is connected to the first storage body 26. Specifically, the first switching valve 81 is positioned between the first storage body 26 and the first atmosphere release valve 58. The first switching valve 81 opens and closes. When the first switching valve 81 is opened, the first storage body 26 communicates with the first atmosphere release valve 58. The second switching valve 82 is connected to the second storage body 27. Specifically, the second switching valve 82 is positioned between the second storage body 27 and the second atmosphere release valve 59. The second switching valve 82 opens and closes. When the second switching valve 82 is opened, the second storage body 27 communicates with the second atmosphere release valve 59.

The pressure change mechanism 51 includes the change pump. Specifically, the pressure change mechanism 51 includes the first change pump 54 and the second change pump 55. In this example, the change pump is a cylinder pump. The first change pump 54 is connected to the first storage body 26. Specifically, the first change pump 54 is connected to the first storage body 26 through the first switching valve 81. Therefore, the first change pump 54 communicates with the first storage body 26 by opening the first switching valve 81. The first change pump 54 is connected to the first atmosphere release valve 58. Therefore, the first change pump 54 can take in and exhaust air through the first atmosphere release valve 58. The second change pump 55 is connected to the second storage body 27. Specifically, the second change pump 55 is connected to the second storage body 27 through the second switching valve 82. Therefore, the second change pump 55 communicates with the second storage body 27 by opening the second switching valve 82. The second change pump 55 is connected to the second atmosphere release valve 59. Therefore, the second change pump 55 can take in and exhaust air through the second atmosphere release valve 59.

The first change pump 54 takes in air in a state in which the first switching valve 81 is opened. At this time, the first change pump 54 depressurizes the inside of the first storage body 26 based on the first pressure sensor 56. Next, the first change pump 54 exhausts air in a state in which the first switching valve 81 is closed. At this time, the first change pump 54 exhausts air through the first atmosphere release valve 58. In this example, the first change section 52 includes the first change pump 54, the first pressure sensor 56, the first atmosphere release valve 58, and the first switching valve 81.

The second change pump 55 takes in air in a state in which the second switching valve 82 is closed. At this time, the second change pump 55 takes in air through the second atmosphere release valve 59. Next, the second change pump 55 exhausts air in a state in which the second switching valve 82 is opened. At this time, the second change pump 55 pressurizes the inside of the second storage body 27 based on the second pressure sensor 57. In this example, the second change section 53 includes the second change pump 55, the second pressure sensor 57, the second atmosphere release valve 59, and the second switching valve 82. In this way, ejection liquid may be circulated by the first change pump 54, the second change pump 55, and the liquid feed pump 60.

### Seventh Embodiment

Next, a seventh embodiment of the liquid ejection device 11 will be described. In the seventh embodiment, the configuration of the pressure change mechanism 51 is different from that in the first embodiment. In the seventh embodiment, the differences from the first embodiment will be mainly described.

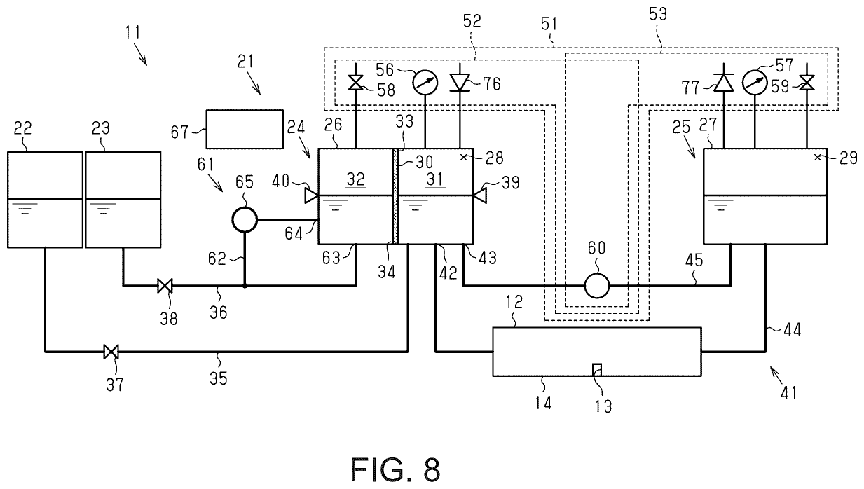

As shown in FIG. 8, the pressure change mechanism 51 includes the pressure adjustment valve. Specifically, the pressure change mechanism 51 includes the first pressure adjustment valve 76 and the second pressure adjustment valve 77. The pressure adjustment valve is configured to adjust pressure in the storage body as in the fourth embodiment. The first pressure adjustment valve 76 is connected to the first storage body 26. The first pressure adjustment valve 76 opens and closes so that pressure in the first storage body 26 does not fall below a predetermined value. The first pressure adjustment valve 76 opens and closes based on a detection result of the first pressure sensor 56. The second pressure adjustment valve 77 is connected to the second storage body 27. The second pressure adjustment valve 77 opens and closes so that pressure in the second storage body 27 does not exceed a predetermined value. The second pressure adjustment valve 77 opens and closes based on a detection result of the second pressure sensor 57.

The pressure change mechanism 51 does not include a change pump. Therefore, the pressure change mechanism 51 changes pressure in the storage body by the liquid feed pump 60. When the liquid feed pump 60 is driven, ejection liquid is sent from the first storage body 26 to the second storage body 27. At this time, the ejection liquid amount of the first storage body 26 becomes small, and the ejection liquid amount of the second storage body 27 becomes large. When the ejection liquid amount in the storage body changes, pressure in the storage body changes. That is, when the liquid feed pump 60 is driven, the inside of the first storage body 26 is depressurized and the inside of the second storage body 27 is pressurized. When the inside of the first storage body 26 is depressurized, ejection liquid flows from the ejection section 12 to the first storage body 26. When the inside of the second storage body 27 is pressurized, ejection liquid flows from the second storage body 27 to the ejection section 12. In this way, ejection liquid may be circulated by the liquid feed pump 60. In this example, the first change section 52 includes the first pressure sensor 56, the first atmosphere release valve 58, the liquid feed pump 60, and the first pressure adjustment valve 76. The second change section 53 includes the second pressure sensor 57, the second atmosphere release valve 59, the liquid feed pump 60, and the second pressure adjustment valve 77.

### Eighth Embodiment

Next, an eighth embodiment of the liquid ejection device 11 will be described. In the eighth embodiment, the configuration of the liquid flow mechanism 21 is different from that in the first embodiment. In the eighth embodiment, the differences from the first embodiment will be mainly described.

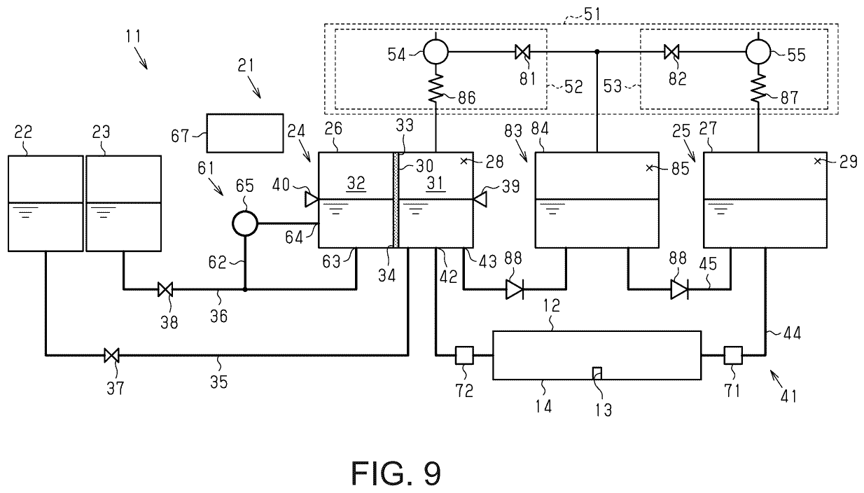

As shown in FIG. 9, the liquid flow mechanism 21 includes the differential pressure valve. Specifically, the liquid flow mechanism 21 includes the first differential pressure valve 71 and the second differential pressure valve 72. The differential pressure valve is the same as that of the second embodiment. A negative pressure in the ejection section 12 is maintained by the first differential pressure valve 71 and the second differential pressure valve 72.

The liquid flow mechanism 21 includes a third liquid storage section 83. The third liquid storage section 83 is configured to store ejection liquid or ejection liquid and moisturizing liquid. In this example, the third liquid storage section 83 stores ejection liquid.

The third liquid storage section 83 includes a third storage body 84. The third storage body 84 defines a third storage chamber 85. Similarly to the second liquid storage section 25, the third liquid storage section 83 does not include a moisture permeable membrane.

The third storage body 84 is connected to the first storage body 26 and the second storage body 27. Specifically, the third storage body 84 is positioned in the second connection flow path 45. The third storage chamber 85 communicates with the first storage chamber 28 and the second storage chamber 29. Specifically, the third storage chamber 85 communicates with the first ejection liquid chamber 31 and the second storage chamber 29.

The pressure change mechanism 51 includes the change pump. The pressure change mechanism 51 includes the first change pump 54 and the second change pump 55. The first change pump 54 is connected to the first storage body 26 and the third storage body 84. The first change pump 54 depressurizes the inside of the first storage body 26 and the inside of the third storage body 84. The second change pump 55 is connected to the second storage body 27 and the third storage body 84. The second change pump 55 pressurizes the inside of the second storage body 27 and the inside of the third storage body 84.

The pressure change mechanism 51 includes the switching valve. Similarly to the sixth embodiment, the pressure change mechanism 51 includes the first switching valve 81 and the second switching valve 82. The first switching valve 81 is connected to the first change pump 54 and the third storage body 84. The first switching valve 81 is positioned between the first change pump 54 and the third storage body 84. When the first switching valve 81 is opened, the first change pump 54 communicates with the third storage body 84. The second switching valve 82 is connected to the second change pump 55 and the third storage body 84. The second switching valve 82 is positioned between the second change pump 55 and the third storage body 84. When the second switching valve 82 is opened, the second change pump 55 communicates with the third storage body 84.

The pressure change mechanism 51 is configured such that pressure in the first storage body 26 becomes larger than pressure in the third storage body 84 in a case where the first change pump 54 depressurizes the inside of the first storage body 26 and the inside of the third storage body 84. By this, since a pressure difference is generated between the inside of the first storage body 26 and the inside of the third storage body 84, ejection liquid flows from the first storage body 26 to the third storage body 84 through the second connection flow path 45.

The pressure change mechanism 51 is configured such that pressure in the third storage body 84 becomes larger than pressure in the second storage body 27 in a case where the second change pump 55 pressurizes the inside of the second storage body 27 and the inside of the third storage body 84. By this, since a pressure difference is generated between the third storage body 84 and the second storage body 27, ejection liquid flows from the third storage body 84 to the second storage body 27 through the second connection flow path 45.

The pressure change mechanism 51 may include a resistance section. Specifically, the pressure change mechanism 51 includes a first resistance section 86 and a second resistance section 87. The resistance section is configured to be a resistance to a pressure change caused by the change pump. The resistance section is, for example, a thin pipe. The resistance section is not limited to a thin pipe, and may be, for example, a valve. The resistance section is positioned between the change pump and the storage body. The first resistance section 86 is positioned between the first change pump 54 and the first storage body 26. That is, the first change pump 54 depressurizes the inside of the first storage body 26 through the first resistance section 86. The second resistance section 87 is positioned between the second change pump 55 and the second storage body 27. That is, the second change pump 55 pressurizes the inside of the second storage body 27 through the second resistance section 87.

The first change pump 54 is unlikely to depressurize the inside of the first storage body 26 by the first resistance section 86. Therefore, when the first change pump 54 is driven, a pressure difference occurs between the first storage body 26 and the third storage body 84. By this, ejection liquid flows from the first storage body 26 to the third storage body 84. In this example, the first change section 52 includes the first change pump 54, the first switching valve 81, and the first resistance section 86. The second change pump 55 is unlikely to pressurize the inside of the second storage body 27 by the second resistance section 87. Therefore, when the second change pump 55 is driven, a pressure difference occurs between the second storage body 27 and the third storage body 84. By this, ejection liquid flows from the third storage body 84 to the second storage body 27. In this example, the second change section 53 includes the second change pump 55, the second switching valve 82, and the second resistance section 87. As described above, ejection liquid may flow from the first storage body 26 toward the second storage body 27 by the first change pump 54 and the second change pump 55 without being limited to the liquid feed pump 60.

The liquid flow mechanism 21 may include one or more one way valves 88. The one way valve 88 is a valve that allows liquid to flow in one direction and restricts liquid to flow in the opposite direction. The liquid flow mechanism 21 includes, for example, two one way valves 88. The one way valves 88 are positioned in the second connection flow path 45. Specifically, the two one way valves 88 are respectively positioned between the first storage body 26 and the third storage body 84, and between the second storage body 27 and the third storage body 84 in the second connection flow path 45. The one way valve 88 reduces a possibility that ejection liquid flows backward through the second connection flow path 45. That is, the one way valves 88 reduce a possibility that ejection liquid flows from the third storage body 84 to the first storage body 26 or ejection liquid flows from the second storage body 27 to the third storage body 84. When the one way valves 88 are positioned in the ejection liquid flow path 41, flow of ejection liquid circulating in the ejection liquid flow path 41 is regulated.

### Ninth Embodiment

Next, a ninth embodiment of the liquid ejection device 11 will be described. In the ninth embodiment, the configuration of the liquid flow mechanism 21 is different from that in the first embodiment. In the ninth embodiment, the differences from the first embodiment will be mainly described.

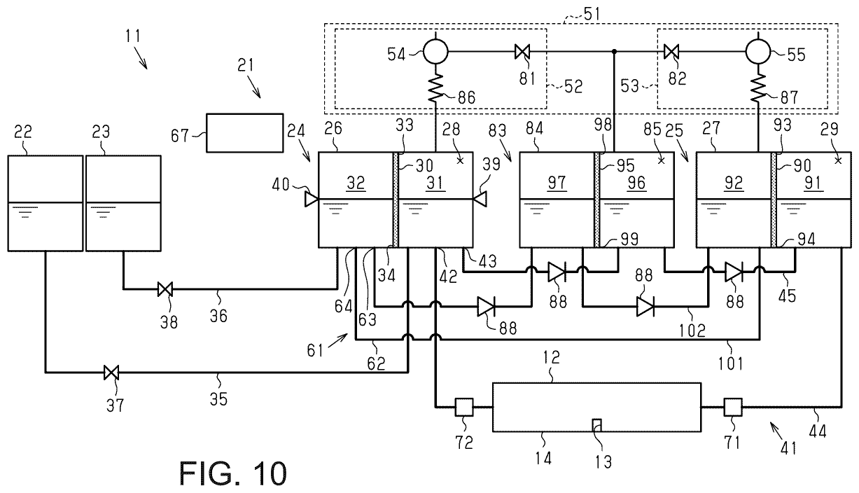

As shown in FIG. 10, the liquid flow mechanism 21 includes the differential pressure valve. Specifically, the liquid flow mechanism 21 includes the first differential pressure valve 71 and the second differential pressure valve 72. The differential pressure valve is the same as that of the second embodiment and the eighth embodiment. A negative pressure in the ejection section 12 is maintained by the first differential pressure valve 71 and the second differential pressure valve 72.

The second liquid storage section 25 is configured to store ejection liquid and moisturizing liquid. The second liquid storage section 25 includes a second moisture permeable membrane 90. The second moisture permeable membrane 90 is attached to the second storage body 27. The second moisture permeable membrane 90 partitions the inside of the second storage body 27 into a second ejection liquid chamber 91 and a second moisturizing liquid chamber 92. Ejection liquid is stored in the second ejection liquid chamber 91. Moisturizing liquid is stored in the second moisturizing liquid chamber 92. A plurality of thin holes is formed in the second moisture permeable membrane 90 in the same manner as in the first moisture permeable membrane 30. The second moisture permeable membrane 90 defines a gap in communication with the plurality of thin holes.

The second moisture permeable membrane 90 includes a second upper end 93 and a second lower end 94. The second lower end 94 is attached to the second storage body 27. The second upper end 93 is positioned above an ejection liquid surface of the second ejection liquid chamber 91 and a moisturizing liquid surface of the second moisturizing liquid chamber 92. The second storage body 27 stores ejection liquid and moisturizing liquid such that the second upper end 93 is positioned above the ejection liquid surface of the second ejection liquid chamber 91 and the moisturizing liquid surface of the second moisturizing liquid chamber 92. In one example, the second moisture permeable membrane 90 completely partitions the inside of the second storage body 27. That is, the second upper end 93 and the second lower end 94 are attached to the second storage body 27.

The liquid flow mechanism 21 includes the third liquid storage section 83. Similarly to the second liquid storage section 25, the third liquid storage section 83 is configured to store ejection liquid and moisturizing liquid. The third liquid storage section 83 includes the third storage body 84 and a third moisture permeable membrane 95. The third moisture permeable membrane 95 is attached to the third storage body 84. The third moisture permeable membrane 95 partitions the inside of the third storage body 84 into a third ejection liquid chamber 96 and a third moisturizing liquid chamber 97. Ejection liquid is stored in the third ejection liquid chamber 96. Moisturizing liquid is stored in the third moisturizing liquid chamber 97. A plurality of thin holes is formed in the third moisture permeable membrane 95 in the same manner as in the first moisture permeable membrane 30. The third moisture permeable membrane 95 defines a gap in communication with the plurality of thin holes.

The third moisture permeable membrane 95 includes a third upper end 98 and a third lower end 99. The third lower end 99 is attached to the third storage body 84. The third upper end 98 is positioned above an ejection liquid surface of the third ejection liquid chamber 96 and a moisturizing liquid surface of the third moisturizing liquid chamber 97. The third storage body 84 stores ejection liquid and moisturizing liquid such that the third upper end 98 is positioned above the ejection liquid surface of the third ejection liquid chamber 96 and the moisturizing liquid surface of the third moisturizing liquid chamber 97. In one example, the third moisture permeable membrane 95 completely partitions the inside of the third storage body 84. That is, the third upper end 98 and the third lower end 99 are attached to the third storage body 84.

The third storage body 84 is connected to the first storage body 26 and the second storage body 27. Specifically, the third storage body 84 is positioned in the second connection flow path 45. The third ejection liquid chamber 96 communicates with the first ejection liquid chamber 31 and the second ejection liquid chamber 91.

The stirring section 61 includes the stirring flow path 62. The stirring flow path 62 includes a first circulation flow path 101 and a second circulation flow path 102. The first circulation flow path 101 is connected to the first liquid storage section 24 and the second liquid storage section 25. Specifically, the first circulation flow path 101 is connected to the first storage body 26 and the second storage body 27. The first circulation flow path 101 communicates with the first moisturizing liquid chamber 32 and the second moisturizing liquid chamber 92. In one example, the first circulation flow path 101 includes the second end 64. The second circulation flow path 102 is connected to the first liquid storage section 24 and the second liquid storage section 25. Specifically, the second circulation flow path 102 is connected to the first storage body 26 and the second storage body 27. In one example, the second circulation flow path 102 includes the first end 63. The third storage body 84 is positioned in the second circulation flow path 102. Therefore, the second circulation flow path 102 communicates with the first moisturizing liquid chamber 32, the second moisturizing liquid chamber 92, and the third moisturizing liquid chamber 97.

The liquid flow mechanism 21 includes one or more one way valves 88. In one example, the liquid flow mechanism 21 includes four one way valves 88. Of the four one way valves 88, two of them are positioned in the ejection liquid flow path 41, similarly to the eighth embodiment. The remaining two one way valves 88 are positioned in the stirring flow path 62. Specifically, the two one way valves 88 are positioned in the second circulation flow path 102. The two one way valves 88 are positioned in the second circulation flow path 102, between the first storage body 26 and the third storage body 84, and between the second storage body 27 and the third storage body 84, respectively. By the one way valves 88, a possibility that moisturizing liquid flows from the third storage body 84 to the first storage body 26 or moisturizing liquid flows from the second storage body 27 to the third storage body 84 is reduced. When the one way valves 88 are positioned in the stirring flow path 62, flow of moisturizing liquid circulating in the stirring flow path 62 is regulated.

The pressure change mechanism 51, similar to the eighth embodiment, includes the first change pump 54, the second change pump 55, the first switching valve 81, the second switching valve 82, the first resistance section 86, and the second resistance section 87. The first change section 52 and the second change section 53 are the same as in the eighth embodiment.

The first change pump 54 depressurizes the inside of the first storage body 26 and the inside of the third storage body 84. At this time, due to the first resistance section 86, pressure in the first storage body 26 becomes larger than pressure in the third storage body 84. By this, ejection liquid and moisturizing liquid flow from the first storage body 26 to the third storage body 84. The second change pump 55 pressurizes the inside of the second storage body 27 and the inside of the third storage body 84. At this time, due to the second resistance section 87, pressure in the third storage body 84 becomes larger than pressure in the second storage body 27. By this, ejection liquid and moisturizing liquid flow from the third storage body 84 to the second storage body 27. When the first change pump 54 depressurizes the inside of the first storage body 26 and the second change pump 55 pressurizes the inside of the second storage body 27, ejection liquid and moisturizing liquid flow from the second storage body 27 to the first storage body 26. In this way, liquid is circulated by the first change pump 54 and the second change pump 55. Therefore, in the ninth embodiment, the pressure change mechanism 51 also serves as the stirring section 61.

### Tenth Embodiment

Next, a tenth embodiment of the liquid ejection device 11 will be described. In the tenth embodiment, the position of the pressure sensor is different from that in the first embodiment. In the tenth embodiment, the differences from the first embodiment will be mainly described.

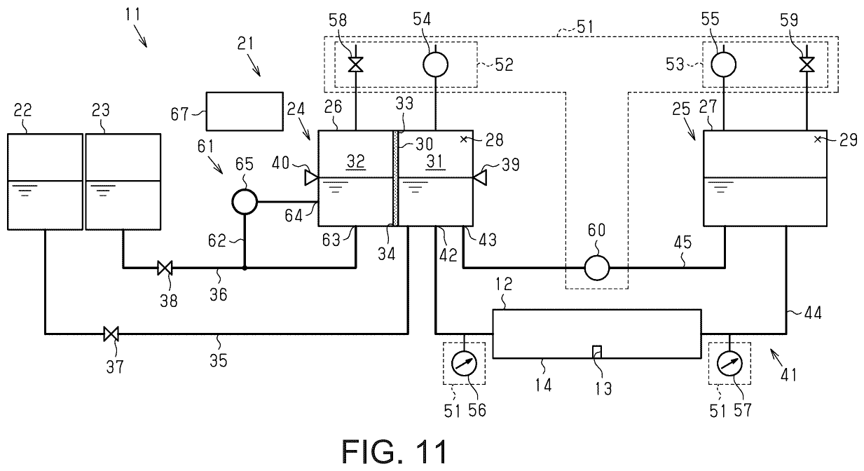

As shown in FIG. 11, the first pressure sensor 56 and the second pressure sensor 57 are positioned in the first connection flow path 44. Specifically, the first pressure sensor 56 is positioned between the ejection section 12 and the first storage body 26 in the first connection flow path 44. The second pressure sensor 57 is positioned between the second storage body 27 and the ejection section 12 in the first connection flow path 44. The first pressure sensor 56 detects pressure in the first storage body 26 through the first connection flow path 44. The second pressure sensor 57 detects pressure in the second storage body 27 through the first connection flow path 44. The first change pump 54 depressurizes the inside of the first storage body 26 based on a detection result of the first pressure sensor 56. The second change pump 55 pressurizes the inside of the second storage body 27 based on a detection result of the second pressure sensor 57. By this, ejection liquid circulates in a state in which the inside of the ejection section 12 is maintained at a negative pressure.

### Eleventh Embodiment

Next, an eleventh embodiment of the liquid ejection device 11 will be described. In the eleventh embodiment, the configuration of the liquid flow mechanism 21 is different from that in the first embodiment. In the eleventh embodiment, the differences from the first embodiment will be mainly described.

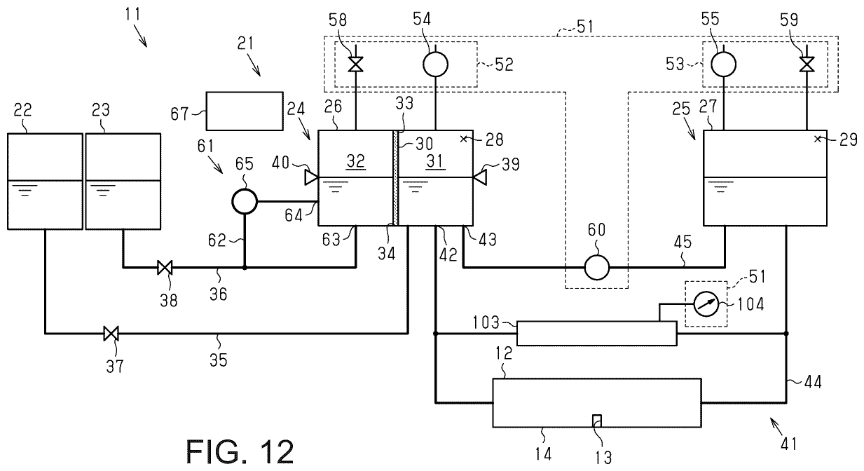

As shown in FIG. 12, the liquid flow mechanism 21 includes a relay tank 103. The relay tank 103 is connected to the ejection liquid flow path 41. Specifically, the relay tank 103 is connected to the first connection flow path 44 so as to be parallel to the ejection section 12. Therefore, ejection liquid flows into and out of the relay tank 103 similarly to the ejection section 12. Ejection liquid circulates in the ejection liquid flow path 41 by passing through the ejection section 12 or the relay tank 103.

The pressure change mechanism 51 includes one pressure sensor. Specifically, the pressure change mechanism 51 includes a relay pressure sensor 104. The relay pressure sensor 104 is connected to the relay tank 103. The relay pressure sensor 104 detects pressure in the relay tank 103. Pressure in the relay tank 103 corresponds to pressure in the ejection section 12. Therefore, the relay pressure sensor 104 detects pressure in the ejection section 12 by detecting pressure in the relay tank 103. Specifically, the relay pressure sensor 104 detects pressure in the ejection section 12 based on pressure in the relay tank 103 by referring to correspondence data. The correspondence data is data in which pressure in the relay tank 103 and pressure in the ejection section 12 are associated with each other. The correspondence data may be stored in the control section 67.

The first change pump 54 depressurizes the inside of the first storage body 26 based on a detection result of the relay pressure sensor 104. The second change pump 55 pressurizes the inside of the second storage body 27 based on a detection result of the relay pressure sensor 104. By this, ejection liquid circulates in a state in which the inside of the ejection section 12 is maintained at a negative pressure.

### Twelfth Embodiment

Next, a twelfth embodiment of the liquid ejection device 11 will be described. In the twelfth embodiment, the configuration of the pressure change mechanism 51 is different from that in the first embodiment. In the twelfth embodiment, the differences from the first embodiment will be mainly described.

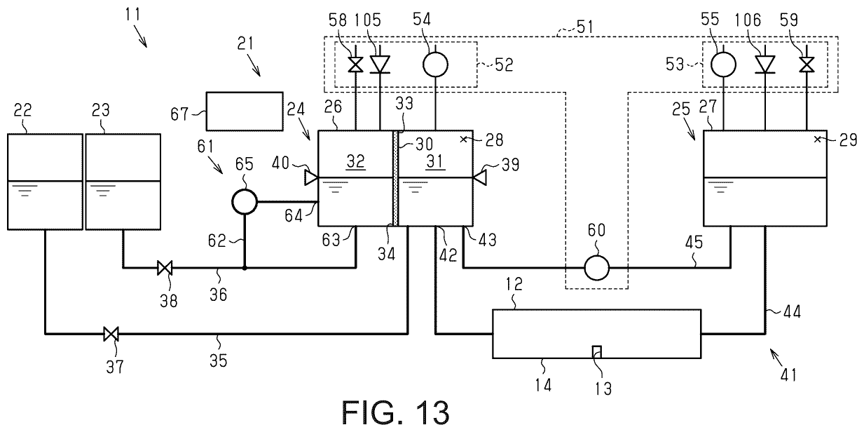

As shown in FIG. 13, instead of the pressure sensor, the pressure change mechanism 51 includes a differential pressure adjustment valve. Specifically, the pressure change mechanism 51 includes a first differential pressure adjustment valve 105 instead of the first pressure sensor 56. The pressure change mechanism 51 includes a second differential pressure adjustment valve 106 instead of the second pressure sensor 57. The differential pressure adjustment valve is a valve that opens and closes by a pressure difference between pressure in the storage body and atmospheric pressure. The first differential pressure adjustment valve 105 opens and closes by a pressure difference between pressure in the first storage body 26 and atmospheric pressure. The second differential pressure adjustment valve 106 opens and closes by a pressure difference between pressure in the second storage body 27 and atmospheric pressure.

The first differential pressure adjustment valve 105 is connected to the first storage body 26. The first differential pressure adjustment valve 105 opens when pressure in the first storage body 26 falls below a predetermined value. By this, pressure in the first storage body 26 is maintained so as not to be lower than a predetermined value. The first differential pressure adjustment valve 105 controls pressure in the first storage body 26.

The second differential pressure adjustment valve 106 is connected to the second storage body 27. The second differential pressure adjustment valve 106 opens when pressure in the second storage body 27 exceeds a predetermined value. By this, pressure in the second storage body 27 is maintained so as not to exceed a predetermined value. The second differential pressure adjustment valve 106 controls pressure in the second storage body 27.

The first differential pressure adjustment valve 105 and the second differential pressure adjustment valve 106 control pressure in the first storage body 26 and pressure in the second storage body 27, respectively, so that ejection liquid circulates in a state where the inside of the ejection section 12 is maintained at a negative pressure.

### Thirteenth Embodiment

Next, a thirteenth embodiment of the liquid ejection device 11 will be described. In the thirteenth embodiment, the configuration of the pressure change mechanism 51 is different from that in the first embodiment. In the thirteenth embodiment, the differences from the first embodiment will be mainly described.

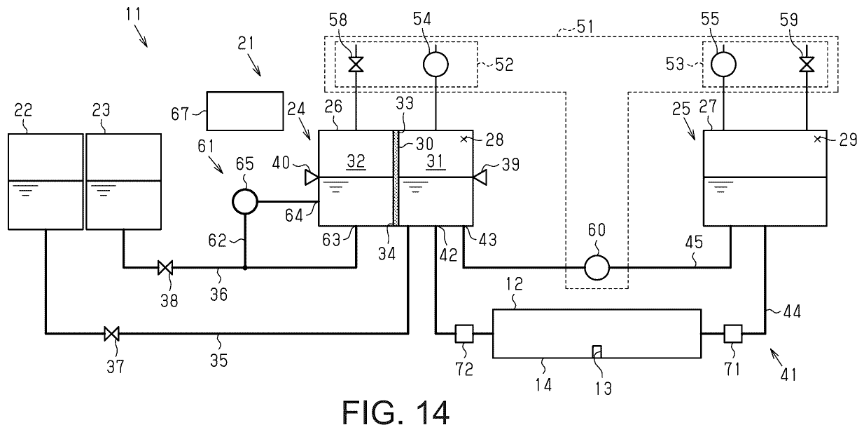

As shown in FIG. 14, the pressure change mechanism 51 includes the differential pressure valve instead of the pressure sensor. Specifically, the pressure change mechanism 51 includes the first differential pressure valve 71 and the second differential pressure valve 72 instead of the first pressure sensor 56 and the second pressure sensor 57. The differential pressure valve is the same as in the second embodiment, the eighth embodiment, and the ninth embodiment. A negative pressure in the ejection section 12 is maintained by the first differential pressure valve 71 and the second differential pressure valve 72 regardless of pressure in the first storage body 26 and pressure in the second storage body 27. By this, ejection liquid circulates in a state in which the inside of the ejection section 12 is maintained at a negative pressure.

### Fourteenth Embodiment

Next, a fourteenth embodiment of the liquid ejection device 11 will be described. In the fourteenth embodiment, the configuration of the liquid flow mechanism 21 is different from that in the first embodiment. In the fourteenth embodiment, the differences from the first embodiment will be mainly described.

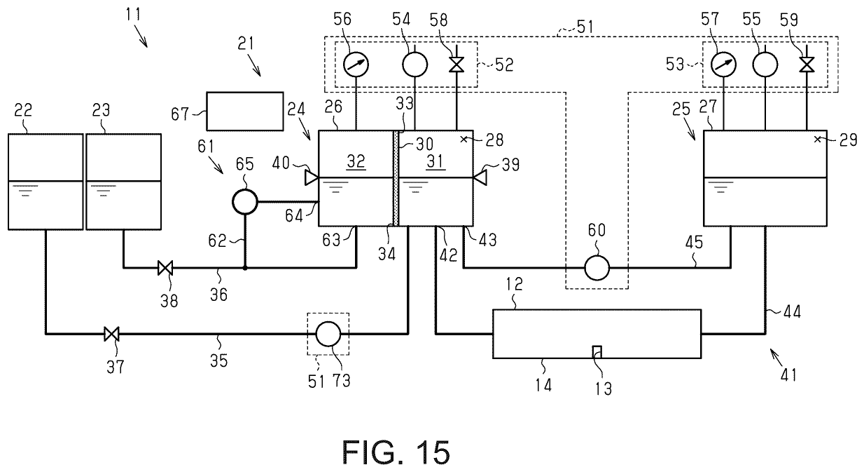

As shown in FIG. 15, the pressure change mechanism 51 includes the supply pump 73. The supply pump 73 is the same as that of the second embodiment. When the supply pump 73 is driven, ejection liquid is supplied from the ejection liquid supply source 22 to the first storage body 26. In this example, when the stirring pump 65 is driven, moisture is supplied from the moisture supply source 23 to the first storage body 26.

The liquid flow mechanism 21 is configured to feed ejection liquid from the first storage body 26 to the ejection section 12. That is, the first change section 52 feeds ejection liquid from the first storage body 26 to the ejection section 12 by pressurizing the inside of the first storage body 26. The liquid flow mechanism 21 is configured to feed ejection liquid from the ejection section 12 to the second storage body 27. That is, the second change section 53 feeds ejection liquid from the ejection section 12 to the second storage body 27 by depressurizing the inside of the second storage body 27. The liquid feed pump 60 feeds ejection liquid from the second storage body 27 to the first storage body 26.

The first change pump 54 is a pressurization pump. The first change pump 54 pressurizes the inside of the first storage body 26 based on the first pressure sensor 56. The second change pump 55 is a depressurization pump. The second change pump 55 depressurizes the inside of the second storage body 27 based on the second pressure sensor 57. By this, ejection liquid circulates in a state in which the inside of the ejection section 12 is maintained at a negative pressure. That is, in the fourteenth embodiment, compared with the first embodiment, flow of ejection liquid circulating in the ejection liquid flow path 41 is in the reverse direction.

### Fifteenth Embodiment

Next, a fifteenth embodiment of the liquid ejection device 11 will be described. In the fifteenth embodiment, the configuration of the liquid flow mechanism 21 is different from that in the first embodiment. In the fifteenth embodiment, the differences from the first embodiment will be mainly described.

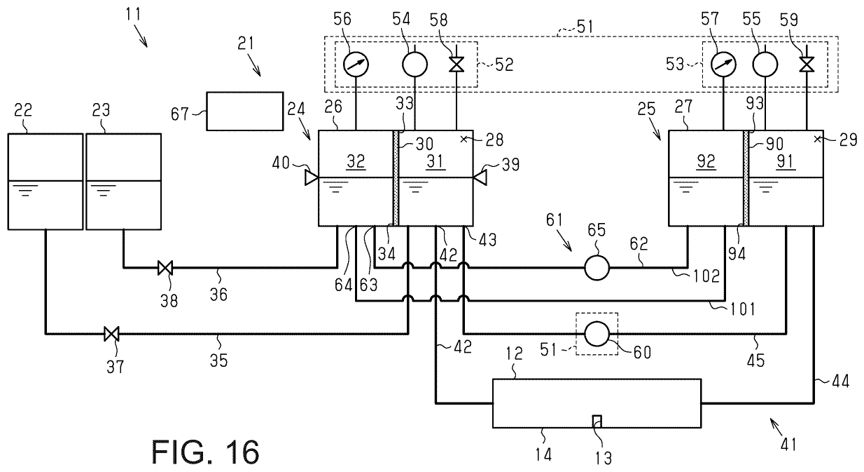

As shown in FIG. 16, the liquid flow mechanism 21 includes the second liquid storage section 25. The second liquid storage section 25 includes the second storage body 27 and the second moisture permeable membrane 90 in the same manner as in the ninth embodiment. The second moisture permeable membrane 90 partitions the second storage chamber 29 into the second ejection liquid chamber 91 and the second moisturizing liquid chamber 92.

The second ejection liquid chamber 91 communicates with the ejection liquid flow path 41. The second ejection liquid chamber 91 communicates with the first connection flow path 44 and the second connection flow path 45. Ejection liquid circulates between the first ejection liquid chamber 31 and the second ejection liquid chamber 91 by the ejection liquid flow path 41.

The stirring section 61 includes the stirring flow path 62. The stirring flow path 62 includes the first circulation flow path 101 and the second circulation flow path 102 in the same manner as in the ninth embodiment. The first circulation flow path 101 is connected to the first storage body 26 and the second storage body 27. The first circulation flow path 101 communicates with the first moisturizing liquid chamber 32 and the second moisturizing liquid chamber 92. In one example, the first circulation flow path 101 includes the second end 64. The second circulation flow path 102 is connected to the first storage body 26 and the second storage body 27. The second circulation flow path 102 communicates with the first moisturizing liquid chamber 32 and the second moisturizing liquid chamber 92. In one example, the second circulation flow path 102 includes the first end 63.

The stirring section 61 includes the stirring pump 65. The stirring pump 65 is positioned in the second circulation flow path 102. When the stirring pump 65 is driven, moisturizing liquid flows from the first moisturizing liquid chamber 32 to the second moisturizing liquid chamber 92 through the second circulation flow path 102. At this time, moisturizing liquid flows from the second moisturizing liquid chamber 92 to the first moisturizing liquid chamber 32 through the first circulation flow path 101. In this manner, moisturizing liquid circulates in the stirring flow path 62.

Moisturizing liquid may be circulated by the first change pump 54, the second change pump 55, and the stirring pump 65. When the first change pump 54 and the second change pump 55 change pressure in the first storage body 26 and pressure in the second storage body 27, respectively, ejection liquid flows from the second ejection liquid chamber 91 to the first ejection liquid chamber 31 through the first connection flow path 44. At this time, moisturizing from the second moisturizing liquid chamber 92 to the first moisturizing liquid chamber 32 through the first circulation flow path 101.

### Modifications

The above-described embodiments may be modified as follows. The above-described embodiments and the following modifications can be implemented in combination with each other to the extent that they are not technically contradictory.

The liquid flow mechanism 21 may include four or more liquid storage sections. Liquid may be circulated among four or more liquid storage sections.

The liquid flow mechanism 21 may include a configuration in which the second liquid storage section 25 includes a moisture permeable membrane and the third liquid storage section 83 does not include a moisture permeable membrane. The liquid flow mechanism 21 may include a configuration in which the third liquid storage section 83 includes a moisture permeable membrane and the second liquid storage section 25 does not include a moisture permeable membrane.

Liquid ejected by the ejection section 12 is not limited to ink, and may be, for example, liquid body in which particles of a functional material are dispersed or mixed in liquid. For example, the ejection section 12 may eject liquid body containing a material such as an electrode material or a pixel material used for manufacturing a liquid crystal display, an electroluminescent display, or a surface emitting display in a dispersed or dissolved form.

### Sixteenth Embodiment

First, a sixteenth embodiment of the liquid ejection device will be described.

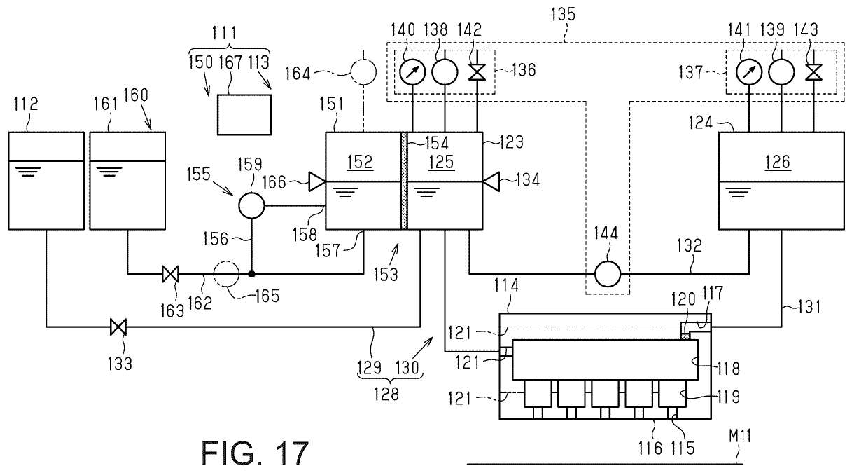

As shown in FIG. 17, a liquid ejection device 111 is connected to a supply source 112. The supply source 112 accommodates ejection liquid. The supply source 112 may be a cartridge, a pack, or the like that can be attached to the liquid ejection device 111, or may be a tank that can be refilled with ejection liquid. The inside of the supply source 112 may be opened to the atmosphere. Ejection liquid is supplied from the supply source 112 to the liquid ejection device 111.

The liquid ejection device 111 includes an ejection mechanism 113. The ejection mechanism 113 is a mechanism for ejecting ejection liquid. The ejection mechanism 113 is connected to the supply source 112. Ejection liquid supplied from the supply source 112 flows through the ejection mechanism 113. The ejection mechanism 113 ejects ejection liquid supplied from the supply source 112.

The ejection mechanism 113 includes an ejection section 114. The ejection section 114 is configured to eject ejection liquid onto the medium M11. The ejection section 114 is a so-called head. The ejection section 114 includes a nozzle surface 116 in which one or more nozzles 115 open. The ejection section 114 ejects ejection liquid from the nozzles 115.

In the ejection section 114, an inlet path 117, a common liquid chamber 118, and one or more individual liquid chambers 119 are formed. The inlet path 117, the common liquid chamber 118, and one or more individual liquid chambers 119 are spaces in the ejection section 114 through which ejection liquid flows.

The inlet path 117 is a space for introducing ejection liquid into the ejection section 114. The common liquid chamber 118 communicates with the inlet path 117. Ejection liquid is introduced into the common liquid chamber 118 through the inlet path 117. One or more individual liquid chambers 119 communicate with the common liquid chamber 118. Ejection liquid is introduced into one or more individual liquid chambers 119 through the common liquid chamber 118. When a plurality of individual liquid chambers 119 is formed in the ejection section 114, the plurality of individual liquid chambers 119 communicates with the common liquid chamber 118. One individual liquid chamber 119 communicates with one nozzle 115. Therefore, the ejection section 114 includes individual liquid chambers 119 formed in the same number as the nozzles 115. The ejection section 114 ejects ejection liquid from the nozzle 115 by applying pressure to ejection liquid positioned in the individual liquid chamber 119.

The ejection section 114 may include a filter 120. In one example, the filter 120 is positioned in inlet path 117. Specifically, the filter 120 is positioned at an end section of the inlet path 117 that is connected to the common liquid chamber 118. The filter 120 collects air bubbles, foreign matters, and the like contained in ejection liquid. By this, the common liquid chamber 118 and the individual liquid chambers 119 are supplied with ejection liquid from which air bubbles, foreign matters, and the like have been removed.

An outlet path 121 may be formed in the ejection section 114. The outlet path 121 is a space in the ejection section 114 through which ejection liquid flows. The outlet path 121 is a space for leading out ejection liquid from the ejection section 114. Therefore, ejection liquid can flow in the ejection section 114 from the inlet path 117 to the outlet path 121. When ejection liquid stays for a long time, the ejection liquid may thicken or settle. Since the ejection liquid flows in the ejection section 114, a possibility that ejection liquid is thickened or settled in the ejection section 114 is reduced.

The outlet path 121 extends from the inlet path 117, the common liquid chamber 118, or the individual liquid chambers 119. In one example, the outlet path 121 extends from the common liquid chamber 118. Therefore, ejection liquid flows through the inlet path 117, the common liquid chamber 118, and the outlet path 121 in this order to pass through the ejection section 114. The outlet path 121 may extend from the inlet path 117 or may extend from the individual liquid chambers 119. The outlet path 121 may extend from the inlet path 117 so that ejection liquid passes through the ejection section 114 without passing through the filter 120.

The inside of the ejection section 114 is usually maintained at a negative pressure. This is for forming a meniscus in the nozzle 115. By this, the ejection section 114 can appropriately eject ejection liquid. Therefore, even when ejection liquid flows from the inlet path 117 to the outlet path 121, it is preferable that the inside of the ejection section 114 is maintained at a negative pressure. When a negative pressure of the ejection section 114 is released, a meniscus may be broken. When a meniscus is broken, the meniscus needs to be formed again in the nozzle 115.

The ejection mechanism 113 includes one or more ejection liquid storage sections. In one example, the ejection mechanism 113 includes a first ejection liquid storage section 123 and a second ejection liquid storage section 124. The ejection mechanism 113 may include three or more ejection liquid storage sections.

The ejection liquid storage section stores ejection liquid. The ejection liquid storage section is connected to the supply source 112. Therefore, ejection liquid is supplied from the supply source 112 to the ejection liquid storage section. In one example, the first ejection liquid storage section 123 is connected to the supply source 112. The second ejection liquid storage section 124 is connected to the first ejection liquid storage section 123. That is, the second ejection liquid storage section 124 is connected to the supply source 112 through the first ejection liquid storage section 123. The second ejection liquid storage section 124 is supplied with ejection liquid from the first ejection liquid storage section 123. The first ejection liquid storage section 123 is not limited to being supplied with ejection liquid from the supply source 112, and may be configured to be supplied with ejection liquid from the second ejection liquid storage section 124. The second ejection liquid storage section 124 is not limited to being supplied with ejection liquid from the first ejection liquid storage section 123, and may be configured to be supplied with ejection liquid directly from the supply source 112.

The ejection liquid storage section defines an ejection liquid chamber. The ejection liquid chamber is a space in which ejection liquid is stored. The first ejection liquid storage section 123 defines a first ejection liquid chamber 125. The second ejection liquid storage section 124 defines a second ejection liquid chamber 126. In one example, the ejection liquid storage section stores air together with ejection liquid. Therefore, a liquid surface of ejection liquid exists in the ejection liquid storage section. The inside of the ejection liquid storage section may be filled with ejection liquid.

The ejection mechanism 113 includes an ejection liquid flow path 128. The ejection liquid flow path 128 is a flow path through which ejection liquid flows. The ejection liquid flow path 128 is connected to the supply source 112. The ejection liquid flow path 128 is connected to the ejection section 114. Ejection liquid is supplied from the supply source 112 to the ejection section 114 through the ejection liquid flow path 128.

The ejection liquid storage section is positioned in the ejection liquid flow path 128. That is, the ejection liquid flow path 128 is connected to the ejection liquid storage section. In one example, the first ejection liquid storage section 123 and the second ejection liquid storage section 124 are positioned in the middle of the ejection liquid flow path 128. The ejection liquid flow path 128 is connected to the first ejection liquid storage section 123 and the second ejection liquid storage section 124.

The ejection liquid flow path 128 includes an ejection liquid supply flow path 129. The ejection liquid supply flow path 129 is connected to the supply source 112. The ejection liquid supply flow path 129 is connected to the ejection liquid storage section. Ejection liquid is supplied from the supply source 112 to the ejection liquid storage section through the ejection liquid supply flow path 129. In one example, the ejection liquid supply flow path 129 is connected to the supply source 112 and the first ejection liquid storage section 123.

The ejection liquid flow path 128 includes an ejection liquid-flow flow path 130. The ejection liquid-flow flow path 130 is connected to the ejection liquid storage section. The ejection liquid-flow flow path 130 is connected to the ejection section 114. Ejection liquid is supplied from the ejection liquid storage section to the ejection section 114 through the ejection liquid-flow flow path 130. In one example, the ejection liquid-flow flow path 130 is connected to the ejection section 114, the first ejection liquid storage section 123, and the second ejection liquid storage section 124. The ejection liquid-flow flow path 130 is connected to the inlet path 117 with respect to the ejection section 114.

The ejection liquid-flow flow path 130 may be a flow path for circulating ejection liquid. In one example, the ejection liquid-flow flow path 130 includes a first connection flow path 131 and a second connection flow path 132. The first connection flow path 131 is connected to the first ejection liquid storage section 123 and the second ejection liquid storage section 124. The ejection section 114 is positioned in the first connection flow path 131. That is, the first connection flow path 131 is connected to the ejection section 114. The second connection flow path 132 is connected to the first ejection liquid storage section 123 and the second ejection liquid storage section 124. Ejection liquid can be circulated by the first connection flow path 131 and the second connection flow path 132. In one example, ejection liquid flows from the second ejection liquid storage section 124 to the first ejection liquid storage section 123 through the first connection flow path 131. Ejection liquid flows from the first ejection liquid storage section 123 to the second ejection liquid storage section 124 through the second connection flow path 132.

The ejection mechanism 113 includes an ejection liquid supply valve 133. The ejection liquid supply valve 133 is positioned in the ejection liquid flow path 128. Specifically, the ejection liquid supply valve 133 is positioned in the ejection liquid supply flow path 129. When the ejection liquid supply valve 133 is opened, ejection liquid can be supplied from the supply source 112 to the first ejection liquid storage section 123. Normally, the ejection liquid supply valve 133 is closed. When it is necessary to supply ejection liquid to the ejection liquid storage section, the ejection liquid supply valve 133 is opened.

The ejection mechanism 113 includes one or more ejection liquid amount detection sections. The ejection liquid amount detection section is configured to detect the ejection liquid amount of ejection liquid stored in the ejection liquid storage section. In one example, the ejection mechanism 113 includes a first ejection liquid amount detection section 134. The first ejection liquid amount detection section 134 is attached to the first ejection liquid storage section 123. The first ejection liquid amount detection section 134 detects the ejection liquid amount stored in the first ejection liquid storage section 123. The ejection mechanism 113 may include a second ejection liquid amount detection section. The second ejection liquid amount detection section detects the ejection liquid amount stored in the second ejection liquid storage section 124.

The ejection liquid amount detection section may detect the ejection liquid amount based on energization between electrodes, or may detect the ejection liquid amount based on reflected light by a prism. The ejection liquid amount detection section may detect the ejection liquid amount based on the vibration waveform of ejection liquid by a piezoelectric sensor. The ejection liquid amount detection section may detect the ejection liquid amount based on the pressure of ejection liquid detected by a pressure sensor. When the ejection liquid amount detection section detects the ejection liquid amount, the ejection liquid amount stored in the ejection liquid storage section is controlled.

The ejection mechanism 113 includes a pressure adjustment mechanism 135. The pressure adjustment mechanism 135 is a mechanism that adjusts the pressure in the ejection liquid storage section. The pressure adjustment mechanism 135 may adjust the pressure in a moisturizing liquid storage section (to be described later). The pressure adjustment mechanism 135 causes ejection liquid to flow by adjusting the pressure in the ejection liquid storage section. The pressure adjustment mechanism 135 adjusts the pressure in the first ejection liquid storage section 123. The pressure adjustment mechanism 135 adjusts the pressure in the second ejection liquid storage section 124.

The pressure adjustment mechanism 135 is connected to the ejection liquid storage section. The pressure adjustment mechanism 135 is connected to the first ejection liquid storage section 123. The pressure adjustment mechanism 135 is connected to the second ejection liquid storage section 124. The pressure adjustment mechanism 135 communicates with the first ejection liquid chamber 125. The pressure adjustment mechanism 135 communicates with the second ejection liquid chamber 126.

The pressure adjustment mechanism 135 generates a pressure difference between the first ejection liquid storage section 123 and the second ejection liquid storage section 124. By this, ejection liquid flows between the first ejection liquid storage section 123 and the second ejection liquid storage section 124. In one example, ejection liquid flows from the second ejection liquid storage section 124 to the first ejection liquid storage section 123 through the first connection flow path 131. By this, liquid is circulated between the first ejection liquid storage section 123 and the second ejection liquid storage section 124.

The pressure adjustment mechanism 135 includes an adjustment section. The adjustment section is connected to the ejection liquid storage section. In one example, the pressure adjustment mechanism 135 includes a first adjustment section 136 and a second adjustment section 137. The first adjustment section 136 is connected to the first ejection liquid storage section 123. The second adjustment section 137 is connected to the second ejection liquid storage section 124.

The adjustment section adjusts the pressure in the ejection liquid storage section. The adjustment section may adjust the pressure in the ejection liquid storage section by pressurizing or depressurizing the inside of the ejection liquid storage section. The adjustment section communicates, for example, with an upper section of the ejection liquid chamber. That is, the adjustment section communicates with air stored in the ejection liquid storage section. The adjustment section adjusts the pressure in the ejection liquid storage section by feeding air into the ejection liquid storage section or drawing air from the ejection liquid storage section. The adjustment section adjusts the pressure in the ejection liquid storage section to cause ejection liquid to flow. The first adjustment section 136 adjusts the pressure in the first ejection liquid storage section 123. The first adjustment section 136 communicates with an upper section of the first ejection liquid chamber 125. The second adjustment section 137 adjusts the pressure in the second ejection liquid storage section 124. The second adjustment section 137 communicates with an upper section of the second ejection liquid chamber 126.

The first adjustment section 136 and the second adjustment section 137 adjust the pressure in the first ejection liquid storage section 123 and the pressure in the second ejection liquid storage section 124 so as to generate a pressure difference between the inside of the first ejection liquid storage section 123 and the inside of the second ejection liquid storage section 124. Specifically, the first adjustment section 136 and the second adjustment section 137 adjust the pressure in the first ejection liquid storage section 123 and the pressure in the second ejection liquid storage section 124, respectively, so that the pressure in the first ejection liquid storage section 123 is lower than the pressure in the second ejection liquid storage section 124. By this, ejection liquid flows from the second ejection liquid storage section 124 to the first ejection liquid storage section 123 through the first connection flow path 131. That is, ejection liquid flows in the ejection section 114 from the inlet path 117 toward the outlet path 121.

The first adjustment section 136 normally changes the pressure in the first ejection liquid storage section 123 so that the inside of the ejection section 114 is maintained at a predetermined negative pressure. The second adjustment section 137 normally changes the pressure in the second ejection liquid storage section 124 so that the inside of the ejection section 114 is maintained at a predetermined negative pressure. By this, the ejection section 114 can appropriately eject ejection liquid while causing ejection liquid to flow from the second ejection liquid storage section 124 to the first ejection liquid storage section 123.

The adjustment section includes an adjustment pump. The adjustment pump is connected to the ejection liquid storage section. The adjustment pump is a pump that adjusts the pressure in the ejection liquid storage section. The adjustment pump is, for example, a diaphragm pump. The first adjustment section 136 includes a first adjustment pump 138. The first adjustment pump 138 is, for example, a depressurization pump. The first adjustment pump 138 is connected to the first ejection liquid storage section 123. The first adjustment pump 138 depressurizes the inside of the first ejection liquid storage section 123. Specifically, the first adjustment pump 138 depressurizes the inside of the first ejection liquid storage section 123 by drawing air from the first ejection liquid storage section 123. The second adjustment section 137 includes a second adjustment pump 139. The second adjustment pump 139 is, for example, a pressurization pump. The second adjustment pump 139 is connected to the second ejection liquid storage section 124. The second adjustment pump 139 pressurizes the inside of the second ejection liquid storage section 124. Specifically, the second adjustment pump 139 pressurizes the inside of the second ejection liquid storage section 124 by feeding air into the second ejection liquid storage section 124.

The first adjustment pump 138 causes ejection liquid to flow into the first ejection liquid storage section 123 by driving the first adjustment pump 138. When the first adjustment pump 138 depressurizes the inside of the first ejection liquid storage section 123, ejection liquid flows into the first ejection liquid storage section 123. For example, when the first adjustment pump 138 depressurizes the inside of the first ejection liquid storage section 123, ejection liquid can flow from the supply source 112 into the first ejection liquid storage section 123. When the first adjustment pump 138 depressurizes the inside of the first ejection liquid storage section 123, ejection liquid flows from the ejection section 114 into the first ejection liquid storage section 123 through the first connection flow path 131.

The second adjustment pump 139 causes ejection liquid to flow out from the second ejection liquid storage section 124 by driving the second adjustment pump 139. When the second adjustment pump 139 pressurizes the second ejection liquid storage section 124, ejection liquid flows out from the second ejection liquid storage section 124. For example, when the second adjustment pump 139 pressurizes the inside of the second ejection liquid storage section 124, ejection liquid flows out from the second ejection liquid storage section 124 toward the ejection section 114 through the first connection flow path 131.

The second adjustment pump 139 is not limited to a pressurization pump, and may be a depressurization pump in the same manner as the first adjustment pump 138, or may be a pump capable of pressurizing and depressurizing the inside of the second ejection liquid storage section 124. In this case, the second adjustment pump 139 depressurizes the inside of the second ejection liquid storage section 124 so that the pressure inside the second ejection liquid storage section 124 becomes larger than the pressure inside the first ejection liquid storage section 123. Also in this case, since a pressure difference occurs between the first ejection liquid storage section 123 and the second ejection liquid storage section 124, ejection liquid flows from the second ejection liquid storage section 124 to the first ejection liquid storage section 123 through the first connection flow path 131. The second adjustment pump 139 depressurizes the inside of the second ejection liquid storage section 124, so that ejection liquid can flow backward from the ejection section 114 to the second ejection liquid storage section 124. In this case, air bubbles collected by the filter 120 flow to the second ejection liquid storage section 124, whereby the air bubbles can be removed from the filter 120.

The adjustment section includes a pressure sensor. The pressure sensor is connected to the ejection liquid storage section. The pressure sensor detects the pressure in the ejection liquid storage section. The first adjustment section 136 includes a first pressure sensor 140. The first pressure sensor 140 is connected to the first ejection liquid storage section 123. The first pressure sensor 140 detects the pressure in the first ejection liquid storage section 123. The second adjustment section 137 includes a second pressure sensor 141. The second pressure sensor 141 is connected to the second ejection liquid storage section 124. The second pressure sensor 141 detects the pressure in the second ejection liquid storage section 124. In the adjustment section, the adjustment pump is driven based on a detection result of the pressure sensor. By this, the inside of the ejection section 114 is maintained at a predetermined negative pressure.

The adjustment section includes an atmosphere release valve. The atmosphere release valve is connected to the ejection liquid storage section. The atmosphere release valve is a valve that releases the inside of the ejection liquid storage section to the atmosphere. The first adjustment section 136 includes a first atmosphere release valve 142. The first atmosphere release valve 142 is connected to the first ejection liquid storage section 123. The first atmosphere release valve 142 opens the inside of the first ejection liquid storage section 123 to the atmosphere. The second adjustment section 137 includes a second atmosphere release valve 143. The second atmosphere release valve 143 is connected to the second ejection liquid storage section 124. The second atmosphere release valve 143 opens the inside of the second ejection liquid storage section 124 to the atmosphere. The atmosphere release valve includes a thin pipe that communicates the inside of the ejection liquid storage section with the atmosphere in order to suppress evaporation of ejection liquid in the ejection liquid storage section. Since the flow path resistance of a thin pipe is large, ejection liquid is difficult to evaporate.

The pressure adjustment mechanism 135 includes a liquid feed pump 144 that causes ejection liquid to flow. The liquid feed pump 144 is positioned in the ejection liquid-flow flow path 130. Specifically, the liquid feed pump 144 is positioned in the second connection flow path 132. The liquid feed pump 144 feeds ejection liquid from the first ejection liquid storage section 123 to the second ejection liquid storage section 124 through the second connection flow path 132. Therefore, in one example, ejection liquid is circulated by the first adjustment pump 138, the second adjustment pump 139, and the liquid feed pump 144.

The liquid ejection device 111 includes a moisturizing mechanism 150. The moisturizing mechanism 150 is a mechanism for moisturizing ejection liquid flowing through the ejection mechanism 113. The moisturizing mechanism 150 moisturizes ejection liquid with moisturizing liquid. Specifically, the moisturizing mechanism 150 moisturizes ejection liquid by supplying moisture contained in moisturizing liquid to ejection liquid. Moisturizing liquid is liquid for moisturizing ejection liquid. Moisturizing liquid is, for example, a glycerin aqueous solution.

The moisturizing mechanism 150 includes one or more moisturizing liquid storage sections. The moisturizing liquid storage section is configured to store moisturizing liquid. The moisturizing liquid storage section defines a moisturizing liquid chamber. The moisturizing liquid chamber is a space in which moisturizing liquid is stored. In one example, the moisturizing mechanism 150 includes a first moisturizing liquid storage section 151. The first moisturizing liquid storage section 151 defines a first moisturizing liquid chamber 152. In one example, the moisturizing liquid storage section stores air together with moisturizing liquid. Therefore, a liquid surface of moisturizing liquid exists in the moisturizing liquid storage section. The inside of the moisturizing liquid storage section may be filled with moisturizing liquid.

The moisturizing mechanism 150 includes one or more moisturizing sections. In one example, the moisturizing mechanism 150 includes a first moisturizing section 153. The moisturizing section is adjacent to the ejection mechanism 113. In one example, the first moisturizing section 153 is adjacent to the ejection liquid storage section. Specifically, the first moisturizing section 153 is adjacent to the first ejection liquid storage section 123. The moisturizing section is adjacent to the moisturizing liquid storage section. Specifically, the first moisturizing section 153 is adjacent to the first moisturizing liquid storage section 151. The first moisturizing section 153 moisturizes ejection liquid stored in the first ejection liquid storage section 123 by moisturizing liquid stored in the first moisturizing liquid storage section 151. The moisturizing section may be adjacent to the stirring section 155 (to be described later), not limited to the moisturizing liquid storage section.

The moisturizing section includes one or more moisture permeable membranes. The moisture permeable membrane is positioned so as to separate ejection liquid and moisturizing liquid. Specifically, the moisture permeable membrane is positioned so as to separate ejection liquid flowing in the ejection mechanism 113 and moisturizing liquid flowing in the moisturizing mechanism 150. In one example, the first moisturizing section 153 includes a first moisture permeable membrane 154. The first moisture permeable membrane 154 is positioned so as to separate ejection liquid stored in the first ejection liquid storage section 123 from moisturizing liquid stored in the first moisturizing liquid storage section 151. The first moisture permeable membrane 154 is positioned so as to constitute a wall of the first ejection liquid storage section 123. The first moisture permeable membrane 154 is positioned so as to constitute a wall of the first moisturizing liquid storage section 151. The first moisture permeable membrane 154 partitions the first ejection liquid chamber 125 and the first moisturizing liquid chamber 152.

The moisture permeable membrane is a membrane that allows gas to permeate through it but does not allow liquid to permeate through it. Therefore, the moisture permeable membrane separates ejection liquid and moisturizing liquid from each other so that ejection liquid and moisturizing liquid are not mixed. The moisture permeable membrane may be a porous membrane in which a plurality of thin holes is formed, or may be a homogeneous membrane composed of a polymer material. The porous membrane defines a gap in communication with the plurality of thin holes. The gap is a space in the moisture permeable membrane. In this thin hole, a meniscus is generated by surface tension of liquid. The meniscus is a gas-liquid interface between liquid stored in a liquid chamber and gas positioned in a gap. By this, the porous membrane allows gas to pass through while preventing the passage of liquid. The homogeneous membrane is composed of, for example, silicone. A homogeneous membrane is permeable to water vapor, but impermeable to liquid, by the dissolution and diffusion of moisture through polymers.

The first moisture permeable membrane 154 may partition the first ejection liquid chamber 125 and the first moisturizing liquid chamber 152 in a state in which air stored in the first ejection liquid chamber 125 and air stored in the first moisturizing liquid chamber 152 can enter and exit each other. In one example, an upper end of the first moisture permeable membrane 154 is positioned above an ejection liquid surface and an moisturizing liquid surface. That is, the first ejection liquid storage section 123 stores ejection liquid so that an ejection liquid surface is positioned below an upper end of the first moisture permeable membrane 154. The first moisturizing liquid storage section 151 stores moisturizing liquid so that a moisturizing liquid surface is positioned below an upper end of the first moisture permeable membrane 154. By this, air can enter and exit the gap of the first ejection liquid chamber 125 and the first moisture permeable membrane 154. Air can enter and exit the gap of the first moisturizing liquid chamber 152 and the first moisture permeable membrane 154. For example, when the pressure adjustment mechanism 135 changes the pressure in the first ejection liquid storage section 123 and the first moisturizing liquid storage section 151, air moves between the first ejection liquid chamber 125 and the gap, so that a pressure difference is unlikely to occur between the first ejection liquid chamber 125 and the gap. Similarly, air moves between the first moisturizing liquid chamber 152 and the gap, and thus a pressure difference is unlikely to occur between the first moisturizing liquid chamber 152 and the gap. By this, it is possible to reduce a possibility that a meniscus formed in a thin hole of the first moisture permeable membrane 154 is broken due to a pressure difference, ejection liquid seeps into the first moisturizing liquid chamber 152 through the first moisture permeable membrane 154, and moisturizing liquid seeps into the first ejection liquid chamber 125 through the first moisture permeable membrane 154.

The first moisture permeable membrane 154 completely partitions the first ejection liquid chamber 125 and the first moisturizing liquid chamber 152. In one example, an upper end of the first moisture permeable membrane 154 contacts the first ejection liquid storage section 123 and the first moisturizing liquid storage section 151. By this, even if ejection liquid or moisturizing liquid splashes, a possibility that ejection liquid and moisturizing liquid are mixed is reduced.

The first moisture permeable membrane 154 may not completely partition the first ejection liquid chamber 125 and the first moisturizing liquid chamber 152. For example, an upper end of the first moisture permeable membrane 154 may not be in contact with the first ejection liquid storage section 123 and the first moisturizing liquid storage section 151. Even in this case, it is possible to separate ejection liquid and moisturizing liquid by an upper end of the first moisture permeable membrane 154 being positioned above an ejection liquid surface and a moisturizing liquid surface.

In ejection liquid, moisture may evaporate with the passage of time. When moisture evaporates from ejection liquid, the concentration of ejection liquid increases. When the concentration of ejection liquid is increased, ejection liquid may become thickened. If thickening of ejection liquid occurs, the ejection section 114 may not be able to appropriately eject ejection liquid.

Moisturizing liquid moisturizes ejection liquid through the moisture permeable membrane. Specifically, moisturizing liquid moisturizes ejection liquid by supplying moisture to ejection liquid through the moisture permeable membrane. Moisture contained in moisturizing liquid permeates through the moisture permeable membrane as water vapor. By this, moisture is supplied to ejection liquid. In one example, moisture of moisturizing liquid stored in the first moisturizing liquid chamber 152 is supplied to ejection liquid stored in the first ejection liquid chamber 125 by permeating the first moisture permeable membrane 154. The movement speed of moisture supplied from moisturizing liquid to ejection liquid is determined by the contact area between ejection liquid and moisturizing liquid through the moisture permeable membrane The larger the contact area between ejection liquid and moisturizing liquid through the moisture permeable membrane, the larger the movement speed of moisture. The movement speed of moisture is desirably larger than the evaporation speed of ejection liquid. The movement speed of moisture supplied from moisturizing liquid to ejection liquid is determined by the thickness of the moisture permeable membrane. The thinner the moisture permeable membrane, the larger the movement speed of moisture.

For moisturizing liquid, an appropriate concentration for moisturizing ejection liquid is set. Specifically, the concentration of moisturizing liquid is set so that the moisturizing force of fresh ejection liquid and the moisturizing force of moisturizing liquid are balanced. Moisturizing force is the ease with which moisture is released. That is, the larger the moisturizing force, the easier it is to supply moisture. If the moisturizing force of moisturizing liquid stored in a moisturizing liquid chamber is smaller than the moisturizing force of fresh ejection liquid, moisture moves from ejection liquid to moisturizing liquid. In this case, there is a possibility that an increase in the concentration of ejection liquid is promoted. On the other hand, if the moisturizing force of moisturizing liquid stored in a moisturizing liquid chamber is larger than the moisturizing force of fresh ejection liquid, there is a possibility that the concentration of the ejection liquid is excessively lowered. Therefore, the moisturizing liquid storage section stores moisturizing liquid of an appropriate concentration when moisturizing ejection liquid so that the ejection liquid is maintained at an appropriate concentration. By this, when moisture of ejection liquid evaporates, causing the moisturizing force of the ejection liquid to decrease, moisture moves from moisturizing liquid to ejection liquid.

When moisture moves from moisturizing liquid to ejection liquid, the moisture amount of the moisturizing liquid decreases. In moisturizing liquid, similarly to ejection liquid, moisture may evaporate with the passage of time. Therefore, the concentration of moisturizing liquid may increase. When the concentration of moisturizing liquid becomes high, there is a possibility that ejection liquid cannot be moisturized.

The moisturizing mechanism 150 includes a stirring section 155. The stirring section 155 is configured to stir moisturizing liquid. By the stirring section 155 stirring moisturizing liquid, the concentration of moisturizing liquid is made uniform. By this, even when the moisture amount of moisturizing liquid locally decreases, a possibility that the concentration of moisturizing liquid increases is reduced.

The stirring section 155 is attached to the moisturizing liquid storage section. The stirring section 155 stirs moisturizing liquid stored in the moisturizing liquid storage section. In one example, the stirring section 155 is attached to the first moisturizing liquid storage section 151. The stirring section 155 stirs moisturizing liquid stored in the first moisturizing liquid storage section 151. That is, the stirring section 155 stirs moisturizing liquid stored in the first moisturizing liquid chamber 152.

The stirring section 155 includes a stirring flow path 156. The stirring flow path 156 includes a first end 157 and a second end 158. The first end 157 and the second end 158 are connected to the first moisturizing liquid storage section 151. That is, both ends of the stirring flow path 156 are connected to the first moisturizing liquid storage section 151.

The stirring section 155 includes a stirring pump 159. The stirring pump 159 is positioned in the stirring flow path 156. The stirring pump 159 circulates moisturizing liquid in the first moisturizing liquid storage section 151 through the stirring flow path 156. By this, moisturizing liquid stored in the first moisturizing liquid storage section 151 is stirred. In one example, when the stirring pump 159 is driven, moisturizing liquid flows through the stirring flow path 156 from the first end 157 toward the second end 158.

The stirring section 155 is not limited to a configuration including the stirring flow path 156 and the stirring pump 159, and may have a configuration including a fin for stirring moisturizing liquid of the first moisturizing liquid storage section 151. In this case, moisturizing liquid of the first moisturizing liquid chamber 152 is stirred by driving the fin.

The moisturizing mechanism 150 includes a supply section 160. The supply section 160 is configured to supply moisture to moisturizing liquid stored in the moisturizing liquid storage section. By the supply section 160 supplying moisture to moisturizing liquid, a possibility that the concentration of moisturizing liquid increases is reduced.

The supply section 160 includes a moisture storage section 161. The moisture storage section 161 is configured to store moisture. Specifically, the moisture storage section 161 stores water. Similarly to the ejection liquid storage section and the moisturizing liquid storage section, the moisture storage section 161 may store air together with moisture. The moisture storage section 161 may store moisture so that a liquid surface of moisture is positioned above a moisturizing liquid surface of the moisturizing liquid storage section. The inside of the moisture storage section 161 may be filled with moisture.

The supply section 160 includes a moisture supply flow path 162. The moisture supply flow path 162 is connected to the moisture storage section 161. The moisture supply flow path 162 is connected to the moisturizing liquid storage section. Moisture is supplied from the moisture storage section 161 to the moisturizing liquid storage section through the moisture supply flow path 162. In one example, the moisture supply flow path 162 is connected to the moisture storage section 161 and the first moisturizing liquid storage section 151. Through the moisture supply flow path 162, moisture is supplied from the moisture storage section 161 to the first moisturizing liquid storage section 151. The moisture supply flow path 162 may constitute a part of the stirring flow path 156. For example, the first end 157 may coincide with an end section of the moisture supply flow path 162. The moisture supply flow path 162 may be a flow path independent of the stirring flow path 156.

The supply section 160 includes a moisture supply valve 163. The moisture supply valve 163 is positioned in the moisture supply flow path 162. When the moisture supply valve 163 is opened, moisture can be supplied from the moisture storage section 161 to the first moisturizing liquid storage section 151. Normally, the moisture supply valve 163 is closed. When it is necessary to supply moisture to the moisturizing liquid storage section, the moisture supply valve 163 is opened.

The supply section 160 may include a depressurization section 164. The depressurization section 164 is configured to depressurize the inside of the moisturizing liquid storage section. The depressurization section 164 is connected to the moisturizing liquid storage section. The depressurization section 164 is, for example, a depressurization pump. In one example, the depressurization section 164 depressurizes the inside of the first moisturizing liquid storage section 151. By depressurizing the inside of the first moisturizing liquid storage section 151, moisture is supplied from the moisture storage section 161 to the first moisturizing liquid storage section 151.

The depressurization section 164 may be configured by the pressure adjustment mechanism 135. In one example, the depressurization section 164 is constituted by the first adjustment section 136. When the first adjustment section 136 depressurizes the inside of the first ejection liquid storage section 123, the inside of the first moisturizing liquid storage section 151 is also depressurized. By this, moisture is supplied from the moisture storage section 161 to the first moisturizing liquid storage section 151. The depressurization section 164 may be provided independently of the first adjustment section 136.

The supply section 160 may include a moisture pump 165. The moisture pump 165 is positioned in the moisture supply flow path 162. When the moisture pump 165 is driven while the moisture supply valve 163 is open, moisture is supplied from the moisture storage section 161 to the first moisturizing liquid storage section 151. The moisture pump 165 may be constituted by the stirring pump 159, or may be constituted by a pump different from the stirring pump 159. The supply section 160 may supply moisture from the moisture storage section 161 to the first moisturizing liquid storage section 151 by a water head difference between the moisture storage section 161 and the moisturizing liquid storage section.

The moisturizing mechanism 150 includes one or more moisturizing liquid amount detection sections. The moisturizing liquid amount detection section is configured to detect the amount of moisturizing liquid stored in the moisturizing liquid storage section. In one example, the moisturizing mechanism 150 includes a first moisturizing liquid amount detection section 166. The first moisturizing liquid amount detection section 166 is attached to the first moisturizing liquid storage section 151. The first moisturizing liquid amount detection section 166 detects the amount of moisturizing liquid stored in the first moisturizing liquid storage section 151. The moisturizing mechanism 150 may include a second moisturizing liquid amount detection section.

The moisturizing liquid amount detection section, similar to the ejection liquid amount detection section, may detect the liquid amount based on energization between electrodes, or may detect the liquid amount based on reflected light by a prism. The moisturizing liquid amount detection section may detect the liquid amount based on the vibration waveform of moisturizing liquid by a piezoelectric sensor. The moisturizing liquid amount detection section may detect the liquid amount based on the pressure of moisturizing liquid detected by a pressure sensor. By the moisturizing liquid amount detection section detecting the liquid amount, the liquid amount of the moisturizing liquid storage section is controlled. By controlling the liquid amount in the moisturizing liquid storage section, the moisturizing liquid storage section can store air together with moisturizing liquid.

By the moisturizing liquid amount detection section detecting the moisturizing liquid amount, the concentration of moisturizing liquid is appropriately maintained. That is, the concentration of moisturizing liquid is appropriately maintained by controlling the moisturizing liquid amount in the moisturizing liquid storage section. When moisture is supplied to moisturizing liquid stored in the moisturizing liquid storage section, the concentration of moisturizing liquid is reduced. That is, the supply amount of moisture affects the moisturizing force of moisturizing liquid. Therefore, by supplying moisture so that the moisturizing liquid amount stored in the moisturizing liquid storage section is constant, moisturizing liquid stored in the moisturizing liquid storage section is maintained at an appropriate concentration. In one example, moisture is supplied so that the moisturizing liquid amount stored in the first moisturizing liquid storage section 151 is constant based on a detection result of the first moisturizing liquid amount detection section 166, whereby moisturizing liquid stored in the first moisturizing liquid storage section 151 is kept at an appropriate concentration.

The liquid ejection device 111 includes a control section 167. The control section 167 controls various components included in the liquid ejection device 111. The control section 167 controls the ejection mechanism 113 and the moisturizing mechanism 150. For example, the control section 167 controls the ejection section 114, the ejection liquid supply valve 133, the pressure adjustment mechanism 135, the stirring section 155, the moisture supply valve 163, the depressurization section 164, the moisture pump 165, and the like.

The control section 167 may be configured by one or more processors that execute various processes according to a computer program. The control section 167 may be configured by one or more dedicated hardware circuitry such as an ASIC that executes at least a part of various processes. The control section 167 may be constituted by circuitry including a combination of a processor and hardware circuitry. The processor includes a CPU and memories such as a RAM and a ROM. The memory stores program code or commands configured to cause the CPU to perform the processes. Memory, that is, computer readable medium, includes any readable medium that can be accessed by a general-purpose or dedicated computer.

The control section 167 drives the first adjustment pump 138 so that the inside of the ejection section 114 is maintained at a predetermined negative pressure. The control section 167 drives the second adjustment pump 139 so that the inside of the ejection section 114 is maintained at a predetermined negative pressure. Further, the control section 167 drives the liquid feed pump 144. By this, the control section 167 circulates ejection liquid. The circulating ejection liquid is moisturized by moisturizing liquid.

The control section 167 may circulate moisturizing liquid by driving the stirring section 155. The control section 167 circulates moisturizing liquid by driving the stirring pump 159 in a state in which the moisture supply valve 163 is closed.

The control section 167 may circulate liquid at all times or may circulate liquid at a predetermined timing. That is, the control section 167 may circulate ejection liquid and moisturizing liquid at all times or at a predetermined timing. The control section 167 may circulate liquid during printing. The control section 167 may circulate liquid during maintenance of the liquid ejection device 111. The control section 167 may circulate liquid when it is determined that liquid needs to be circulated. The control section 167 may determine whether it is necessary to circulate liquid based on the temperature and humidity at the time of printing, the print duty, the elapsed time, and the like. For example, when the temperature and humidity are high, the control section 167 determines that liquid needs to be circulated. When the print duty is small, the control section 167 determines that it is necessary to circulate liquid. When the elapsed time is long, the control section 167 determines that liquid needs to be circulated. The elapsed time is a time elapsed from the previous printing, a time elapsed from the previous liquid supply, or the like.

The control section 167 controls the ejection liquid supply valve 133 based on a detection result of the first ejection liquid amount detection section 134. The control section 167 opens the ejection liquid supply valve 133 when the ejection liquid amount detected by the first ejection liquid amount detection section 134 is equal to or less than a threshold. By this, ejection liquid can be supplied from the supply source 112 to the first ejection liquid storage section 123. At this time, the control section 167 supplies ejection liquid from the supply source 112 to the first ejection liquid storage section 123 by causing the first adjustment section 136 to depressurize the inside of the first ejection liquid storage section 123. When the ejection liquid amount detected by the first ejection liquid amount detection section 134 is larger than a threshold, the control section 167 closes the ejection liquid supply valve 133. By this, the ejection liquid amount stored in the first ejection liquid storage section 123 is maintained in a state larger than the threshold.

The control section 167 controls the moisture supply valve 163 based on a detection result of the first moisturizing liquid amount detection section 166. When the moisturizing liquid amount detected by the first moisturizing liquid amount detection section 166 is equal to or less than a threshold, the control section 167 opens the moisture supply valve 163. By this, moisture can be supplied from the moisture storage section 161 to the first moisturizing liquid storage section 151. At this time, the control section 167 causes the depressurization section 164 to depressurize the inside of the first moisturizing liquid storage section 151, and thus moisture is supplied from the moisture storage section 161 to the first moisturizing liquid storage section 151. When the moisturizing liquid amount detected by the first moisturizing liquid amount detection section 166 is larger than a threshold, the control section 167 closes the moisture supply valve 163. By this, the moisturizing liquid amount stored in the first moisturizing liquid storage section 151 is maintained to be larger than the threshold. Therefore, moisturizing liquid is maintained at an appropriate concentration. A threshold of the ejection liquid amount and a threshold of the moisturizing liquid amount may be different values.

The control section 167 may supply ejection liquid from the supply source 112 to the first ejection liquid storage section 123 by a water head difference between the supply source 112 and the first ejection liquid storage section 123. In this case, an ejection liquid surface stored in the supply source 112 is positioned above an ejection liquid surface stored in the first ejection liquid storage section 123. The control section 167 supplies ejection liquid to the first ejection liquid storage section 123 by opening the ejection liquid supply valve 133 based on a detection result of the first ejection liquid amount detection section 134.

The control section 167 may supply moisture from the moisture storage section 161 to the first moisturizing liquid storage section 151 by a water head difference between the moisture storage section 161 and the first moisturizing liquid storage section 151. In this case, a liquid surface of water stored in the moisture storage section 161 is positioned above a moisturizing liquid surface stored in the first moisturizing liquid storage section 151. Strictly speaking, since the densities of water and moisturizing liquid are different from each other, it is desirable that there is a water head difference between the two so that water flows from the moisture storage section 161 to the first moisturizing liquid storage section 151. The control section 167 supplies moisture to the first moisturizing liquid storage section 151 by opening the moisture supply valve 163 based on a detection result of the first moisturizing liquid amount detection section 166.

The control section 167 may supply moisture from the moisture storage section 161 to the first moisturizing liquid storage section 151 by driving the moisture pump 165. The control section 167 supplies moisture from the moisture storage section 161 to the first moisturizing liquid storage section 151 by driving the moisture pump 165 in a state in which the moisture supply valve 163 is opened.

### Operations and Effects

Next, the operations and effects of the above-described embodiment will be described.
(1) The moisturizing mechanism 150 includes the first moisturizing liquid storage section 151 that stores moisturizing liquid, the first moisturizing section 153 adjacent to the ejection mechanism 113, and the stirring section 155 for stirring moisturizing liquid stored in the first moisturizing liquid storage section 151. The first moisturizing section 153 includes the first moisture permeable membrane 154 that separates ejection liquid and the moisturizing liquid. According to the above-described configuration, the concentration of moisturizing liquid is made uniform by the stirring section 155 stirring moisturizing liquid. Therefore, the concentration of moisturizing liquid is unlikely to be low. By this, ejection liquid is appropriately moisturized.
(2) The stirring section 155 includes the stirring flow path 156 for circulating moisturizing liquid, and the stirring pump 159 positioned in the stirring flow path 156. The stirring flow path 156 includes the first end 157 connected to the first moisturizing liquid storage section 151 and the second end 158 connected to the first moisturizing liquid storage section 151. According to the above-described configuration, when the stirring pump 159 is driven, moisturizing liquid stored in the first moisturizing liquid storage section 151 circulates through the stirring flow path 156. By this, the concentration of moisturizing liquid is made uniform.
(3) The supply section 160 includes the moisture storage section 161 that stores moisture, and the moisture supply flow path 162 connected to the moisture storage section 161 and the first moisturizing liquid storage section 151. According to the above-described configuration, moisture is supplied from the moisture storage section 161 to the first moisturizing liquid storage section 151 through the moisture supply flow path 162. By this, a possibility that the concentration of moisturizing liquid increases is reduced.
(4) The supply section 160 includes the moisture pump 165 positioned in the moisture supply flow path 162. According to the above-described configuration, moisture is supplied from the moisture storage section 161 to the first moisturizing liquid storage section 151 by driving the moisture pump 165. By this, a possibility that the concentration of moisturizing liquid increases is reduced.
(5) The moisture storage section 161 stores moisture so that a liquid surface of moisture is positioned above a liquid surface of moisturizing liquid stored in the first moisturizing liquid storage section 151. According to the above-described configuration, moisture is supplied from the moisture storage section 161 to the first moisturizing liquid storage section 151 by a water head difference between the moisture storage section 161 and the first moisturizing liquid storage section 151. By this, a possibility that the concentration of moisturizing liquid increases is reduced.
(6) The supply section 160 includes the depressurization section 164 that depressurizes the inside of the first moisturizing liquid storage section 151. According to the above-described configuration, the depressurization section 164 depressurizes the inside of the first moisturizing liquid storage section 151, and thus moisture is supplied from the moisture storage section 161 to the first moisturizing liquid storage section 151. By this, a possibility that the concentration of moisturizing liquid increases is reduced.
(7) The control section 167 opens the moisture supply valve 163 when the liquid amount of moisturizing liquid detected by the first moisturizing liquid amount detection section 166 is equal to or less than a threshold, and closes the moisture supply valve 163 when the liquid amount of moisturizing liquid detected by the first moisturizing liquid amount detection section 166 is larger than the threshold. When moisture is supplied from moisturizing liquid to ejection liquid, the moisture amount of moisturizing liquid decreases. Therefore, the liquid amount of moisturizing liquid stored in the first moisturizing liquid storage section 151 decreases. According to the above-described configuration, since moisture is supplied from the moisture storage section 161 to the first moisturizing liquid storage section 151 based on the liquid amount of moisturizing liquid stored in the first moisturizing liquid storage section 151, the concentration of moisturizing liquid is appropriately maintained.
(8) The first moisturizing section 153 is adjacent to the first ejection liquid storage section 123 and the first moisturizing liquid storage section 151. The first moisture permeable membrane 154 separates ejection liquid stored in the first ejection liquid storage section 123 and moisturizing liquid stored in the first moisturizing liquid storage section 151. According to the above-described configuration, ejection liquid stored in the first ejection liquid storage section 123 is moisturized. By this, the first ejection liquid storage section 123 can store moisturized ejection liquid.

### Seventeenth Embodiment

Next, a seventeenth embodiment of the liquid ejection device 111 will be described. The seventeenth embodiment is different from the sixteenth embodiment in the configuration of the adjustment pump. In the seventeenth embodiment, the differences from the sixteenth embodiment will be mainly described.

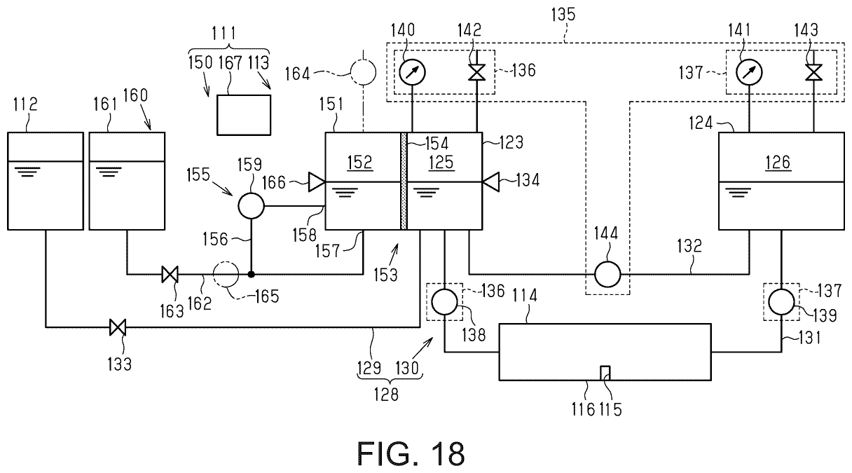

As shown in FIG. 18, the first adjustment pump 138 and the second adjustment pump 139 are positioned in the first connection flow path 131. Specifically, the first adjustment pump 138 is positioned between the ejection section 114 and the first ejection liquid storage section 123 in the first connection flow path 131. The second adjustment pump 139 is positioned between the ejection section 114 and the second ejection liquid storage section 124 in the first connection flow path 131.

When the first adjustment pump 138 is driven, ejection liquid flows from the ejection section 114 to the first ejection liquid storage section 123. When the second adjustment pump 139 is driven, ejection liquid flows from the second ejection liquid storage section 124 to the ejection section 114. When the liquid feed pump 144 is driven, ejection liquid flows from the first ejection liquid storage section 123 to the second ejection liquid storage section 124. As described above, ejection liquid is circulated by the first adjustment pump 138, the second adjustment pump 139, and the liquid feed pump 144. In this example, the inside of the first ejection liquid storage section 123 can be set to a negative pressure by driving the liquid feed pump 144. When the liquid feed pump 144 creates a negative pressure inside the first ejection liquid storage section 123, ejection liquid is supplied from the supply source 112 to the first ejection liquid storage section 123. When the liquid feed pump 144 creates a negative pressure inside the first moisturizing liquid storage section 151 through the first ejection liquid storage section 123, moisture is supplied from the moisture storage section 161 to the first moisturizing liquid storage section 151.

### Eighteenth Embodiment

Next, an eighteenth embodiment of the liquid ejection device 111 will be described. The eighteenth embodiment is different from the sixteenth embodiment in the configuration of the ejection mechanism 113. In the eighteenth embodiment, the differences from the sixteenth embodiment will be mainly described.

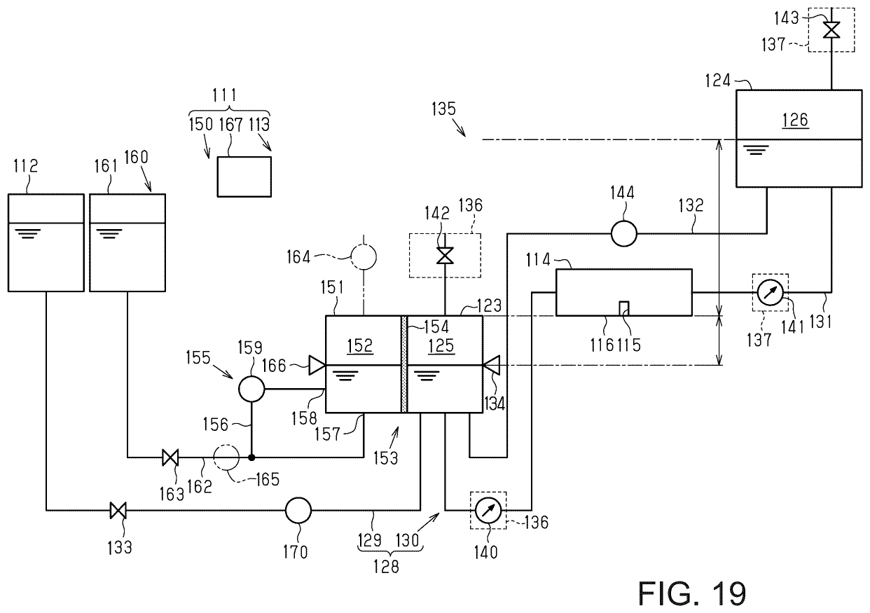

As shown in FIG. 19, the pressure adjustment mechanism 135 generates a pressure difference between the first ejection liquid storage section 123 and the second ejection liquid storage section 124 by a water head difference instead of the adjustment pump. The pressure adjustment mechanism 135 opens the inside of the first ejection liquid storage section 123 and the inside of the second ejection liquid storage section 124 to the atmosphere by the first atmosphere release valve 142 and the second atmosphere release valve 143, thereby generating a pressure difference between the first ejection liquid storage section 123 and the second ejection liquid storage section 124.

The first pressure sensor 140 and the second pressure sensor 141 are positioned in the first connection flow path 131. Specifically, the first pressure sensor 140 is positioned between the ejection section 114 and the first ejection liquid storage section 123 in the first connection flow path 131. The second pressure sensor 141 is positioned between the ejection section 114 and the second ejection liquid storage section 124 in the first connection flow path 131.

The first ejection liquid storage section 123 is positioned below the second ejection liquid storage section 124. Specifically, the first ejection liquid storage section 123 is positioned such that an ejection liquid surface stored in the first ejection liquid storage section 123 is positioned below an ejection liquid surface stored in the second ejection liquid storage section 124. By this, ejection liquid flows from the second ejection liquid storage section 124 to the first ejection liquid storage section 123.

The ejection section 114 is positioned above the first ejection liquid storage section 123 and below the second ejection liquid storage section 124. Specifically, the ejection section 114 is positioned such that an ejection liquid surface stored in the first ejection liquid storage section 123 is positioned above the nozzle surface 116. The ejection section 114 is positioned so that an ejection liquid surface stored in the second ejection liquid storage section 124 is positioned above the nozzle surface 116.

When the liquid feed pump 144 is driven, ejection liquid flows from the first ejection liquid storage section 123 to the second ejection liquid storage section 124. The liquid feed pump 144 adjusts the water head difference between the first ejection liquid storage section 123 and the second ejection liquid storage section 124 based on a detection result of the first pressure sensor 140 and a detection result of the second pressure sensor 141. By this, ejection liquid can be circulated while the inside of the ejection section 114 is maintained at a negative pressure.

The ejection mechanism 113 includes an ejection liquid pump 170. The ejection liquid pump 170 is positioned in the ejection liquid supply flow path 129. When the ejection liquid pump 170 is driven, ejection liquid is supplied from the supply source 112 to the first ejection liquid storage section 123. The ejection liquid pump 170 can supply ejection liquid from the supply source 112 to the first ejection liquid storage section 123 when the ejection mechanism 113 does not include a configuration that depressurizes the inside of the first ejection liquid storage section 123. The ejection mechanism 113 may include the ejection liquid pump 170 even when the ejection mechanism 113 includes a configuration in which the inside of the first ejection liquid storage section 123 is depressurized.

The ejection mechanism 113 is not limited to the ejection liquid pump 170, and ejection liquid may be supplied from the supply source 112 to the first ejection liquid storage section 123 by a water head difference. The ejection mechanism 113 may supply ejection liquid from the supply source 112 to the first ejection liquid storage section 123 by the depressurization section 164 depressurizing the inside of the first ejection liquid storage section 123 through the first moisturizing liquid storage section 151.

### Nineteenth Embodiment

Next, a nineteenth embodiment of the liquid ejection device 111 will be described. The nineteenth embodiment is different from the sixteenth embodiment in the configuration of the ejection mechanism 113. In the nineteenth embodiment, the differences from the sixteenth embodiment will be mainly described.

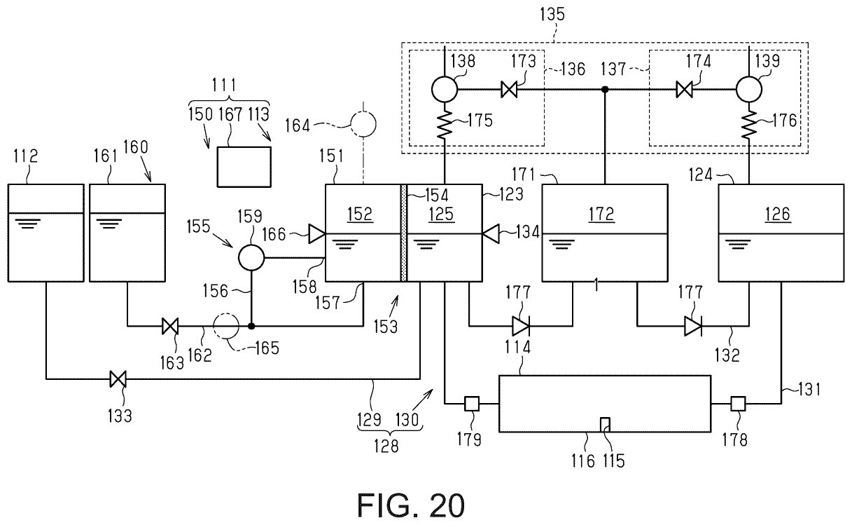

As shown in FIG. 20, the ejection mechanism 113 includes a third ejection liquid storage section 171. The third ejection liquid storage section 171 stores ejection liquid. The third ejection liquid storage section 171 defines a third ejection liquid chamber 172. The third ejection liquid storage section 171 is connected to the first ejection liquid storage section 123 and the second ejection liquid storage section 124. Specifically, the third ejection liquid storage section 171 is positioned in the second connection flow path 132. The third ejection liquid chamber 172 communicates with the first ejection liquid chamber 125 and the second ejection liquid chamber 126.

The first adjustment pump 138 is connected to the first ejection liquid storage section 123 and the third ejection liquid storage section 171. The first adjustment pump 138 depressurizes the inside of the first ejection liquid storage section 123 and the inside of the third ejection liquid storage section 171. The second adjustment pump 139 is connected to the second ejection liquid storage section 124 and the third ejection liquid storage section 171. The second adjustment pump 139 pressurizes the inside of the second ejection liquid storage section 124 and the inside of the third ejection liquid storage section 171.

The pressure adjustment mechanism 135 includes a switching valve. The switching valve opens and closes. The pressure adjustment mechanism 135 includes a first switching valve 173 and a second switching valve 174. The first switching valve 173 is connected to the first adjustment pump 138 and the third ejection liquid storage section 171. The first switching valve 173 is positioned between the first adjustment pump 138 and the third ejection liquid storage section 171. When the first switching valve 173 is opened, the first adjustment pump 138 communicates with the third ejection liquid storage section 171. The second switching valve 174 is connected to the second adjustment pump 139 and the third ejection liquid storage section 171. The second switching valve 174 is positioned between the second adjustment pump 139 and the third ejection liquid storage section 171. When the second switching valve 174 is opened, the second adjustment pump 139 communicates with the third ejection liquid storage section 171.

The pressure adjustment mechanism 135 is configured such that when the first adjustment pump 138 depressurizes the inside of the first ejection liquid storage section 123 and the inside of the third ejection liquid storage section 171, the pressure in the first ejection liquid storage section 123 becomes larger than the pressure in the third ejection liquid storage section 171. By this, a pressure difference is generated between the inside of the first ejection liquid storage section 123 and the inside of the third ejection liquid storage section 171, so that ejection liquid flows from the first ejection liquid storage section 123 to the third ejection liquid storage section 171 through the second connection flow path 132.

The pressure adjustment mechanism 135 is configured such that when the second adjustment pump 139 pressurizes the inside of the second ejection liquid storage section 124 and the inside of the third ejection liquid storage section 171, the pressure in the third ejection liquid storage section 171 becomes larger than the pressure in the second ejection liquid storage section 124. By this, a pressure difference is generated between the inside of the third ejection liquid storage section 171 and the inside of the second ejection liquid storage section 124, so that ejection liquid flows from the third ejection liquid storage section 171 to the second ejection liquid storage section 124 through the second connection flow path 132.

The pressure adjustment mechanism 135 may include a resistance section. Specifically, the pressure adjustment mechanism 135 includes a first resistance section 175 and a second resistance section 176. The resistance section is configured to be a resistance to a pressure change caused by the adjustment pump. The resistance section is, for example, a thin pipe. The resistance section is not limited to a thin pipe, and may be, for example, a valve. The resistance section is positioned between the adjustment pump and the ejection liquid storage section. The first resistance section 175 is positioned between the first adjustment pump 138 and the first ejection liquid storage section 123. That is, the first adjustment pump 138 depressurizes the inside of the first ejection liquid storage section 123 through the first resistance section 175. The second resistance section 176 is positioned between the second adjustment pump 139 and the second ejection liquid storage section 124. That is, the second adjustment pump 139 pressurizes the inside of the second ejection liquid storage section 124 through the second resistance section 176.

The first adjustment pump 138 is unlikely to depressurize the inside of the first ejection liquid storage section 123 by the first resistance section 175. Therefore, when the first adjustment pump 138 is driven, a pressure difference occurs between the first ejection liquid storage section 123 and the third ejection liquid storage section 171. By this, ejection liquid flows from the first ejection liquid storage section 123 to the third ejection liquid storage section 171. In this example, the first adjustment section 136 includes the first adjustment pump 138, the first switching valve 173, and the first resistance section 175. The second adjustment pump 139 is unlikely to depressurize the inside of the second ejection liquid storage section 124 by the second resistance section 176. Therefore, when the second adjustment pump 139 is driven, a pressure difference occurs between the second ejection liquid storage section 124 and the third ejection liquid storage section 171. By this, ejection liquid flows from the third ejection liquid storage section 171 to the second ejection liquid storage section 124. In this example, the second adjustment section 137 includes the second adjustment pump 139, the second switching valve 174, and the second resistance section 176. As described above, ejection liquid may flow from the first ejection liquid storage section 123 toward the second ejection liquid storage section 124 by the first adjustment pump 138 and the second adjustment pump 139 without being limited to the liquid feed pump 144.

The ejection mechanism 113 may include one or more one way valves 177. The one way valve 177 is a valve that allows liquid to flow in one direction and restricts liquid to flow in the opposite direction. The ejection mechanism 113 includes, for example, two one way valves 177. The one way valves 177 are positioned in the second connection flow path 132. Specifically, the two one way valves 177 are positioned in the second connection flow path 132 between the first ejection liquid storage section 123 and the third ejection liquid storage section 171, and between the second ejection liquid storage section 124 and the third ejection liquid storage section 171, respectively. The one way valve 177 reduces a possibility that ejection liquid flows backward through the second connection flow path 132. That is, the one way valves 177 reduces a possibility that ejection liquid flows from the third ejection liquid storage section 171 to the first ejection liquid storage section 123 or ejection liquid flows from the second ejection liquid storage section 124 to the third ejection liquid storage section 171. Since the one way valve 177 is positioned in the ejection liquid-flow flow path 130, the flow of ejection liquid circulating in the ejection liquid-flow flow path 130 is defined.

The ejection mechanism 113 may have a differential pressure valve. For example, the ejection mechanism 113 may include a first differential pressure valve 178 and a second differential pressure valve 179. The first differential pressure valve 178 and the second differential pressure valve 179 are positioned in the first connection flow path 131. Specifically, the first differential pressure valve 178 is positioned between the second ejection liquid storage section 124 and the ejection section 114 in the first connection flow path 131. The second differential pressure valve 179 is positioned between the ejection section 114 and the first ejection liquid storage section 123 in the first connection flow path 131.

The differential pressure valve is configured to open and close by a differential pressure from atmospheric pressure. The first differential pressure valve 178 opens when the pressure in the ejection section 114 falls below a predetermined value, for example, when the ejection liquid amount in the ejection section 114 becomes small. The second differential pressure valve 179 opens when the pressure in the ejection section 114 exceeds a predetermined value, for example, when the ejection liquid amount in the ejection section 114 becomes large. By this, the inside of the ejection section 114 is maintained at a negative pressure. Therefore, the differential pressure valve is useful when the pressure adjustment mechanism 135 does not include a pressure sensor.

The pressure in the ejection section 114 at which the first differential pressure valve 178 opens may be different from the pressure in the ejection section 114 at which the second differential pressure valve 179 opens. For example, the pressure in the ejection section 114 at which the first differential pressure valve 178 opens may be larger than the pressure in the ejection section 114 at which the second differential pressure valve 179 opens. By this, ejection liquid flows from the inlet path 117 toward the outlet path 121. That is, ejection liquid can be circulated in a state in which the inside of the ejection section 114 is maintained at a negative pressure by the differential pressure valve.

### Twentieth Embodiment

Next, a twentieth embodiment of the liquid ejection device 111 will be described. The twentieth embodiment is different from the sixteenth embodiment in the configuration of the ejection mechanism 113. In the twentieth embodiment, the differences from the sixteenth embodiment will be mainly described.

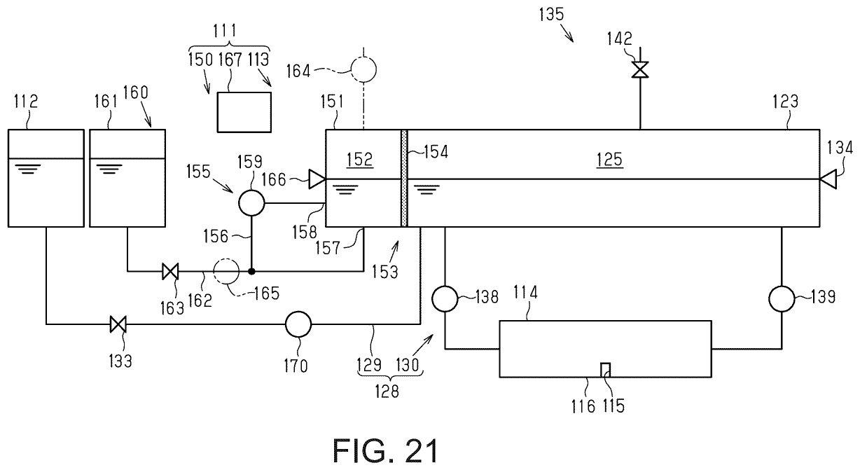

As shown in FIG. 21, the ejection mechanism 113 includes the first ejection liquid storage section 123 and does not include the second ejection liquid storage section 124. Both ends of the ejection liquid-flow flow path 130 are connected to the first ejection liquid storage section 123. Ejection liquid circulates through the ejection liquid-flow flow path 130.

The first adjustment pump 138 and the second adjustment pump 139 are positioned in the ejection liquid-flow flow path 130. Specifically, the first adjustment pump 138 and the second adjustment pump 139 are positioned so as to sandwich the ejection section 114 in the ejection liquid-flow flow path 130. That is, the ejection section 114 is positioned between the first adjustment pump 138 and the second adjustment pump 139 in the ejection liquid-flow flow path 130. In this example, the first adjustment pump 138 and the second adjustment pump 139 adjust the pressure of the first ejection liquid storage section 123.

When the first adjustment pump 138 is driven, ejection liquid flows from the ejection section 114 to the first ejection liquid storage section 123. When the second adjustment pump 139 is driven, ejection liquid flows from the second ejection liquid storage section 124 to the ejection section 114. Thus, ejection liquid is circulated by the first adjustment pump 138 and the second adjustment pump 139.

### Twenty First Embodiment

Next, a twenty first embodiment of the liquid ejection device 111 will be described. The twenty first embodiment is different from the sixteenth embodiment in the configuration of the ejection mechanism 113. In the twenty first embodiment, the differences from the sixteenth embodiment will be mainly described.

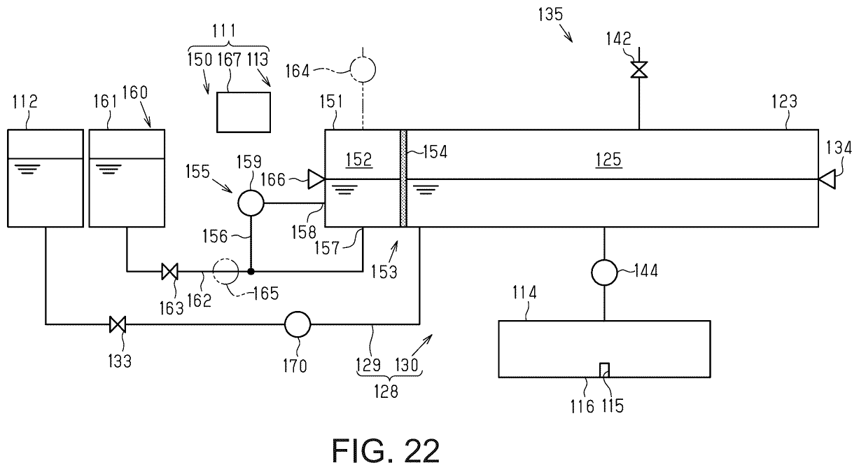

As shown in FIG. 22, the ejection mechanism 113 includes the first ejection liquid storage section 123 and does not include the second ejection liquid storage section 124. Both ends of the ejection liquid-flow flow path 130 are connected to the ejection section 114 and the first ejection liquid storage section 123, respectively. Therefore, in this example, ejection liquid does not circulate.

The liquid feed pump 144 is positioned in the ejection liquid-flow flow path 130. When the liquid feed pump 144 is driven, ejection liquid flows from the first ejection liquid storage section 123 to the ejection section 114. In this example, the liquid feed pump 144 can supply ejection liquid moisturized by moisturizing liquid to the ejection section 114.

### Twenty Second Embodiment

Next, a twenty second embodiment of the liquid ejection device 111 will be described. The twenty second embodiment is different from the sixteenth embodiment in the configuration of the ejection mechanism 113. In the twenty second embodiment, the differences from the sixteenth embodiment will be mainly described.

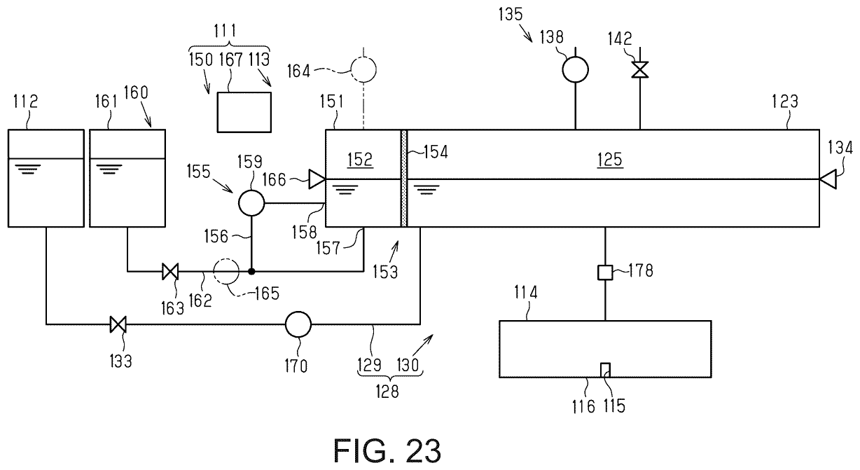

As shown in FIG. 23, the ejection mechanism 113 includes the first ejection liquid storage section 123 and does not include the second ejection liquid storage section 124. Both ends of the ejection liquid-flow flow path 130 are connected to the ejection section 114 and the first ejection liquid storage section 123, respectively. Therefore, in this example, ejection liquid does not circulate.

The pressure adjustment mechanism 135 includes the first adjustment pump 138 and does not include the second adjustment pump 139. The first adjustment pump 138 is connected to the first ejection liquid storage section 123. The first adjustment pump 138 pressurizes the inside of the first ejection liquid storage section 123. When the first adjustment pump 138 pressurizes the inside of the first ejection liquid storage section 123, ejection liquid is supplied from the first ejection liquid storage section 123 to the ejection section 114. The pressure adjustment mechanism 135 is not limited to supplying ejection liquid to the ejection section 114 by the first adjustment pump 138, and for example, ejection liquid may be supplied to the ejection section 114 by a water head difference between the ejection section 114 and the first ejection liquid storage section 123. In this case, the ejection section 114 is positioned so that the nozzle surface 116 is positioned above an ejection liquid surface of the first ejection liquid storage section 123.

The ejection mechanism 113 includes the first differential pressure valve 178. The first differential pressure valve 178 is positioned in the ejection liquid-flow flow path 130. The first differential pressure valve 178 opens when the pressure in the ejection section 114 falls below a predetermined value. When the first differential pressure valve 178 is opened, ejection liquid flows from the first ejection liquid storage section 123 to the ejection section 114. The inside of the ejection section 114 is maintained at a negative pressure by the first differential pressure valve 178. The ejection mechanism 113 is not limited to maintaining the inside of the ejection section 114 at a negative pressure by the first differential pressure valve 178, but may maintain the inside of the ejection section 114 at a negative pressure, for example, by a water head difference between the ejection section 114 and the first ejection liquid storage section 123. In this case, the ejection section 114 is positioned so that the nozzle surface 116 is positioned above an ejection liquid surface of the first ejection liquid storage section 123.

### Twenty Third Embodiment

Next, a twenty third embodiment of the liquid ejection device 111 will be described. The twenty third embodiment is different from the sixteenth embodiment in the configuration of the ejection mechanism 113. In the twenty third embodiment, the differences from the sixteenth embodiment will be mainly described.

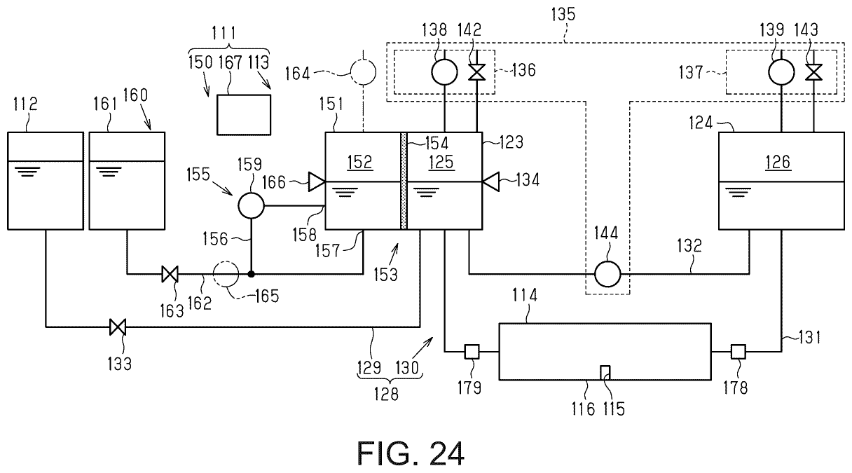

As shown in FIG. 24, the ejection mechanism 113 includes the first differential pressure valve 178 and the second differential pressure valve 179 in place of the first pressure sensor 140 and the second pressure sensor 141. The first differential pressure valve 178 and the second differential pressure valve 179 are the same as those of the nineteenth embodiment. The first differential pressure valve 178 is positioned between the second ejection liquid storage section 124 and the ejection section 114 in the first connection flow path 131. The second differential pressure valve 179 is positioned between the ejection section 114 and the first ejection liquid storage section 123 in the first connection flow path 131. By the first differential pressure valve 178 and the second differential pressure valve 179, the inside of the ejection section 114 is maintained at a negative pressure. Therefore, ejection liquid can be circulated in a state where the inside of the ejection section 114 is maintained at a negative pressure.

### Twenty Fourth Embodiment

Next, a twenty fourth embodiment of the liquid ejection device 111 will be described. The twenty fourth embodiment is different from the sixteenth embodiment in the configuration of the ejection mechanism 113. In the twenty fourth embodiment, the differences from the sixteenth embodiment will be mainly described.

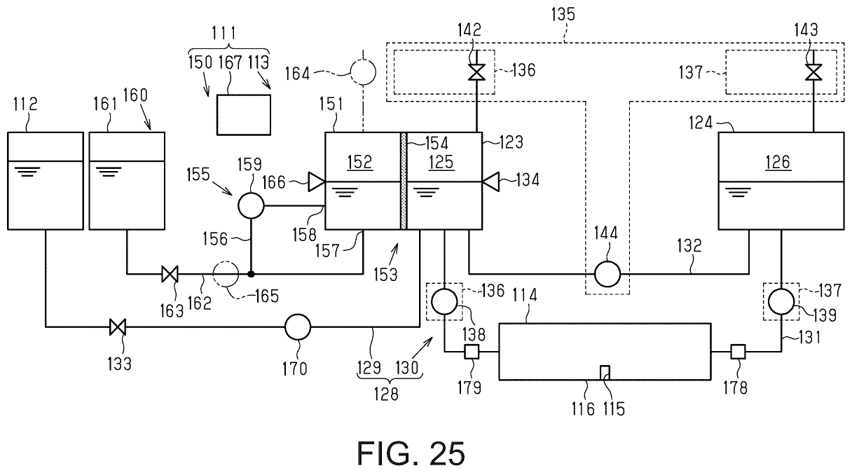

As shown in FIG. 25, the ejection mechanism 113 includes the first differential pressure valve 178 and the second differential pressure valve 179 in place of the first pressure sensor 140 and the second pressure sensor 141. The first differential pressure valve 178 and the second differential pressure valve 179 are the same as those of the nineteenth embodiment and the twenty third embodiment. The first differential pressure valve 178 is positioned between the second ejection liquid storage section 124 and the ejection section 114 in the first connection flow path 131. The second differential pressure valve 179 is positioned between the ejection section 114 and the first ejection liquid storage section 123 in the first connection flow path 131. By the first differential pressure valve 178 and the second differential pressure valve 179, the inside of the ejection section 114 is maintained at a negative pressure.

The first adjustment pump 138 and the second adjustment pump 139 are positioned in the first connection flow path 131, similarly to the seventeenth embodiment. The first adjustment pump 138 is positioned between the ejection section 114 and the first ejection liquid storage section 123 in the first connection flow path 131. Specifically, the first adjustment pump 138 is positioned between the second differential pressure valve 179 and the first ejection liquid storage section 123 in the first connection flow path 131. The second adjustment pump 139 is positioned between the ejection section 114 and the second ejection liquid storage section 124 in the first connection flow path 131. Specifically, the second adjustment pump 139 is positioned between the first differential pressure valve 178 and the second ejection liquid storage section 124 in the first connection flow path 131.

When the first adjustment pump 138 is driven, ejection liquid flows from the ejection section 114 to the first ejection liquid storage section 123. When the second adjustment pump 139 is driven, ejection liquid flows from the second ejection liquid storage section 124 to the ejection section 114. When the liquid feed pump 144 is driven, ejection liquid flows from the first ejection liquid storage section 123 to the second ejection liquid storage section 124. As described above, ejection liquid is circulated by the first adjustment pump 138, the second adjustment pump 139, and the liquid feed pump 144.

### Twenty Fifth Embodiment

Next, a twenty fifth embodiment of the liquid ejection device 111 will be described. The twenty fifth embodiment is different from the sixteenth embodiment in the configuration of the ejection mechanism 113. In the twenty fifth embodiment, the differences from the sixteenth embodiment will be mainly described.

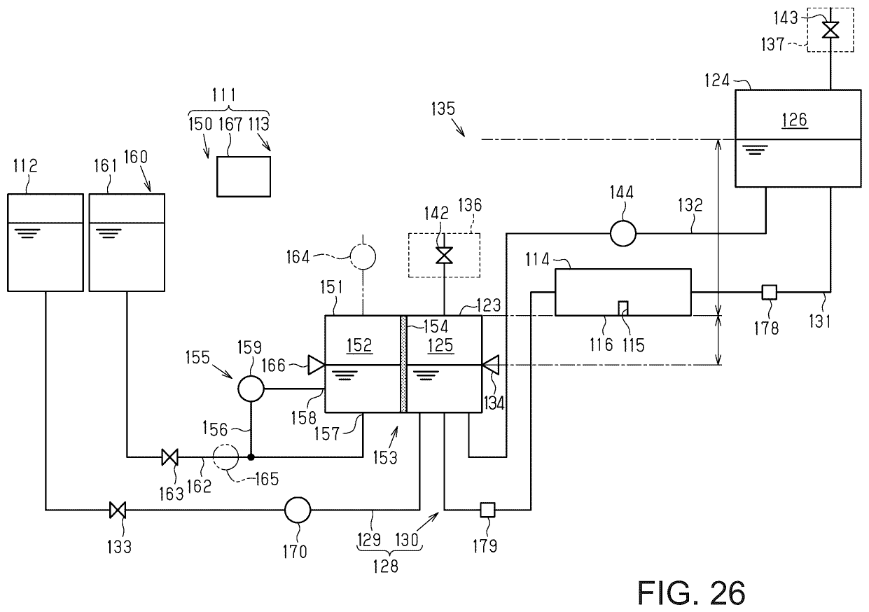

As shown in FIG. 26, the pressure adjustment mechanism 135 generates a pressure difference between the first ejection liquid storage section 123 and the second ejection liquid storage section 124 by a water head difference, instead of the adjustment pump, similar to the eighteenth embodiment. The pressure adjustment mechanism 135 opens the inside of the first ejection liquid storage section 123 and the inside of the second ejection liquid storage section 124 to the atmosphere by the first atmosphere release valve 142 and the second atmosphere release valve 143, thereby generating a pressure difference between the first ejection liquid storage section 123 and the second ejection liquid storage section 124.

The ejection mechanism 113 includes the first differential pressure valve 178 and the second differential pressure valve 179. The first differential pressure valve 178 and the second differential pressure valve 179 are the same as those of the nineteenth embodiment, the twenty third embodiment, and the twenty fourth embodiment. The first differential pressure valve 178 is positioned between the second ejection liquid storage section 124 and the ejection section 114 in the first connection flow path 131. The second differential pressure valve 179 is positioned between the ejection section 114 and the first ejection liquid storage section 123 in the first connection flow path 131. By the first differential pressure valve 178 and the second differential pressure valve 179, the inside of the ejection section 114 is maintained at a negative pressure.

The first ejection liquid storage section 123 is positioned below the second ejection liquid storage section 124. Specifically, the first ejection liquid storage section 123 is positioned such that an ejection liquid surface stored in the first ejection liquid storage section 123 is positioned below an ejection liquid surface stored in the second ejection liquid storage section 124. By this, ejection liquid flows from the second ejection liquid storage section 124 to the first ejection liquid storage section 123.

The ejection section 114 is positioned above the first ejection liquid storage section 123 and below the second ejection liquid storage section 124. Specifically, the ejection section 114 is positioned such that an ejection liquid surface stored in the first ejection liquid storage section 123 is positioned above the nozzle surface 116. The ejection section 114 is positioned so that an ejection liquid surface stored in the second ejection liquid storage section 124 is positioned above the nozzle surface 116.

### Twenty Sixth Embodiment

Next, a twenty sixth embodiment of the liquid ejection device 111 will be described. The twenty sixth embodiment is different from the sixteenth embodiment in the configuration of the moisturizing mechanism 150. In the twenty sixth embodiment, the differences from the sixteenth embodiment will be mainly described.

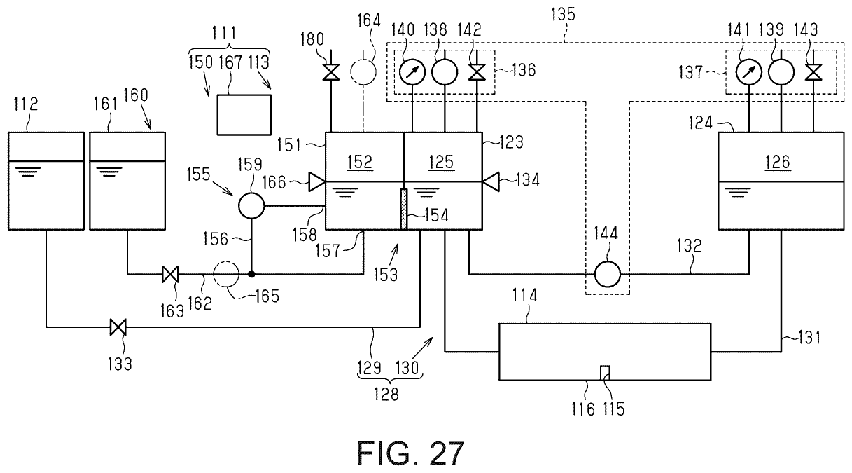

As shown in FIG. 27, the first moisture permeable membrane 154 may be positioned below an ejection liquid surface of the first ejection liquid storage section 123. That is, an upper end of the first moisture permeable membrane 154 is positioned below an ejection liquid surface of the first ejection liquid storage section 123. The first moisture permeable membrane 154 may be positioned below a moisturizing liquid surface of the first moisturizing liquid storage section 151. That is, an upper end of the first moisture permeable membrane 154 is positioned below a moisturizing liquid surface of the first moisturizing liquid storage section 151. In this example, in the first ejection liquid storage section 123 and the first moisturizing liquid storage section 151, air cannot enter or exit each other through the first moisture permeable membrane 154. Specifically, air cannot enter or exit the first ejection liquid chamber 125 and the gap of the first moisture permeable membrane 154. Similarly, air cannot enter or exit the first moisturizing liquid chamber 152 and the gap of the first moisture permeable membrane 154. Therefore, a pressure difference may occur between the first ejection liquid chamber 125 and the gap. A pressure difference may occur between the first moisturizing liquid chamber 152 and the gap. For example, when the first adjustment pump 138 depressurizes the inside of the first ejection liquid storage section 123 or the depressurization section 164 depressurizes the inside of the first moisturizing liquid storage section 151, a pressure difference may occur between the first ejection liquid chamber 125 and the gap or between the first moisturizing liquid chamber 152 and the gap.

The first moisture permeable membrane 154 may be composed of a homogeneous membrane. In a case where the first moisture permeable membrane 154 is formed of a homogeneous membrane, even if the first ejection liquid chamber 125 or the first moisturizing liquid chamber 152 is pressurized or depressurized, liquid is unlikely to seep out. When the first moisture permeable membrane 154 is composed of a porous membrane, if a pressure difference occurs between the first ejection liquid chamber 125 and the gap or between the first moisturizing liquid chamber 152 and the gap, there is a possibility that a meniscus formed in thin holes of the porous membrane may be broken. In this case, liquid may seep out from the first moisture permeable membrane 154.

The moisturizing mechanism 150 includes a moisturizing liquid atmosphere release valve 180. The moisturizing liquid atmosphere release valve 180 is connected to the first moisturizing liquid storage section 151. The moisturizing liquid atmosphere release valve 180 opens the first moisturizing liquid chamber 152 to the atmosphere. In this example, since air cannot enter and exit each other in the first ejection liquid storage section 123 and the first moisturizing liquid storage section 151, the inside of the first moisturizing liquid storage section 151 cannot be opened to the atmosphere through the first atmosphere release valve 142. Therefore, the moisturizing mechanism 150 includes an atmosphere release valve.

### Twenty Seventh Embodiment

Next, a twenty seventh embodiment of the liquid ejection device 111 will be described. The twenty seventh embodiment is different from the sixteenth embodiment in the configurations of the ejection mechanism 113 and the moisturizing mechanism 150. In the twenty seventh embodiment, the differences from the sixteenth embodiment will be mainly described.

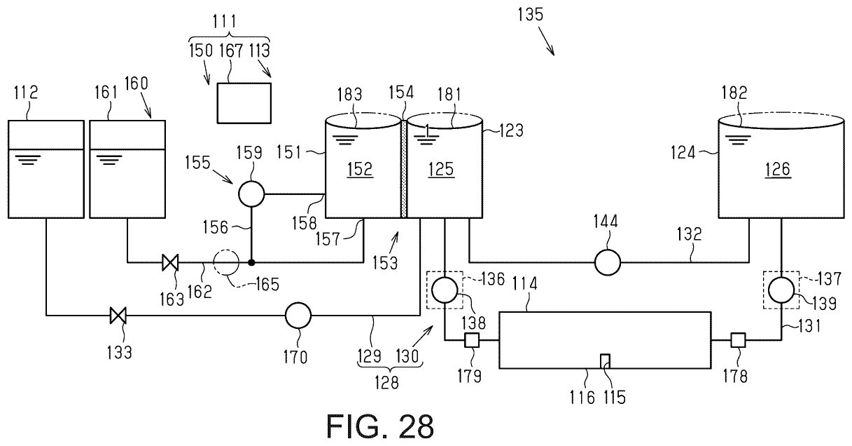

As shown in FIG. 28, similarly to the twenty fourth embodiment, the ejection mechanism 113 includes the first differential pressure valve 178 and the second differential pressure valve 179. The first adjustment pump 138 and the second adjustment pump 139 are positioned in the first connection flow path 131 similarly to the twenty fourth embodiment. Similarly to the twenty fourth embodiment, ejection liquid is circulated by the first adjustment pump 138, the second adjustment pump 139, and the liquid feed pump 144.

The ejection liquid storage section includes a flexible membrane. Specifically, the first ejection liquid storage section 123 includes a first flexible membrane 181. The second ejection liquid storage section 124 includes a second flexible membrane 182. The flexible membrane constitutes a wall of the ejection liquid storage section. The flexible membrane is displaced according to the pressure in the ejection liquid storage section. The displacement of the flexible membrane changes the volume of the ejection liquid storage section. For example, the first flexible membrane 181 is displaced by the first adjustment pump 138, the liquid feed pump 144, the ejection liquid pump 170, and the like. The second flexible membrane 182 is displaced by the second adjustment pump 139, the liquid feed pump 144, and the like. In this example, the inside of the ejection liquid storage section is filled with ejection liquid.

The moisturizing liquid storage section includes a flexible membrane, similar to the ejection liquid storage section. Specifically, the first moisturizing liquid storage section 151 includes a third flexible membrane 183. The third flexible membrane 183 constitutes a wall of the first moisturizing liquid storage section 151. The third flexible membrane 183 is displaced according to the pressure in the first moisturizing liquid storage section 151. The volume of the first moisturizing liquid storage section 151 is changed by the displacement of the third flexible membrane 183. For example, the third flexible membrane 183 is displaced by the stirring pump 159 and the moisture pump 165. In this example, the inside of the first moisturizing liquid storage section 151 is filled with moisturizing liquid.

### Twenty Eighth Embodiment

Next, a twenty eighth embodiment of the liquid ejection device 111 will be described. The twenty eighth embodiment is different from the sixteenth embodiment in the configuration of the moisturizing mechanism 150. In the twenty eighth embodiment, the differences from the sixteenth embodiment will be mainly described.

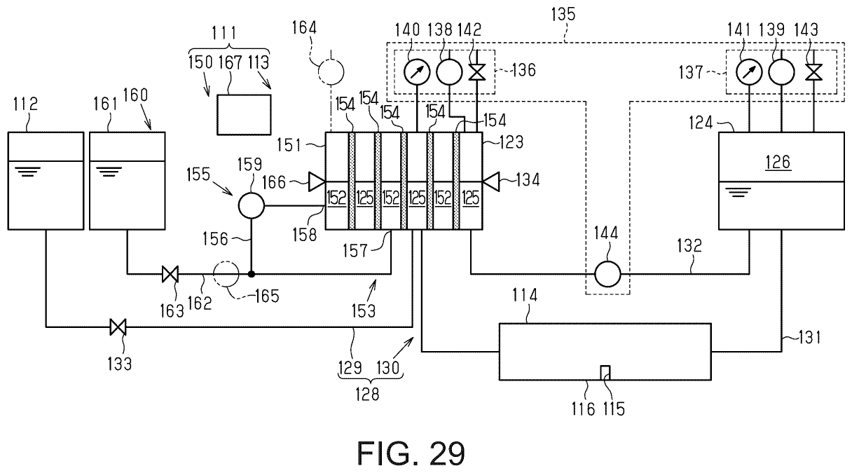

As shown in FIG. 29, the first moisturizing section 153 includes a plurality of first moisture permeable membranes 154. The plurality of first moisture permeable membranes 154 is respectively positioned so as to separate ejection liquid stored in the first ejection liquid storage section 123 and moisturizing liquid stored in the first moisturizing liquid storage section 151. The plurality of first moisture permeable membranes 154 partitions the first ejection liquid chamber 125 and the first moisturizing liquid chamber 152 into a comb-like shape, for example. Since the first moisturizing section 153 includes a plurality of first moisture permeable membranes 154, the contact area between ejection liquid and moisturizing liquid through the first moisture permeable membranes 154 is increased. Thereby, the movement speed of moisture from moisturizing liquid to ejection liquid is increased. Therefore, ejection liquid is easily moisturized by moisturizing liquid.

### Twenty Ninth Embodiment

Next, a twenty ninth embodiment of the liquid ejection device 111 will be described. The twenty ninth embodiment is different from the sixteenth embodiment in the configuration of the moisturizing mechanism 150. In the twenty ninth embodiment, the differences from the sixteenth embodiment will be mainly described.

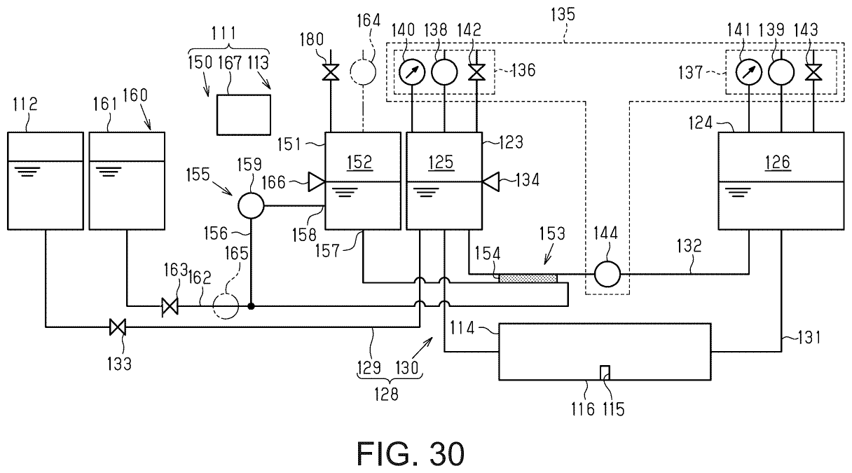

As shown in FIG. 30, the first moisturizing section 153 is adjacent to the ejection liquid flow path 128. Specifically, the first moisturizing section 153 is adjacent to the ejection liquid-flow flow path 130. For example, the first moisturizing section 153 is adjacent to the second connection flow path 132. The first moisturizing section 153 is adjacent to the stirring flow path 156. The first moisturizing section 153 moisturizes ejection liquid flowing through the second connection flow path 132 with moisturizing liquid flowing through the stirring flow path 156.

The first moisture permeable membrane 154 is positioned so as to separate ejection liquid flowing through the second connection flow path 132 and moisturizing liquid flowing through the stirring flow path 156. The first moisture permeable membrane 154 is positioned so as to constitute a wall of the second connection flow path 132. The first moisture permeable membrane 154 is positioned so as to constitute a wall of the stirring flow path 156. According to this example, moisturizing liquid circulates in the stirring flow path 156, and thus ejection liquid flowing in the ejection liquid-flow flow path 130 is effectively moisturized.

### Thirtieth Embodiment

Next, a thirtieth embodiment of the liquid ejection device 111 will be described. The thirtieth embodiment is different from the sixteenth embodiment in the configuration of the moisturizing mechanism 150. In the thirtieth embodiment, the differences from the sixteenth embodiment will be mainly described.

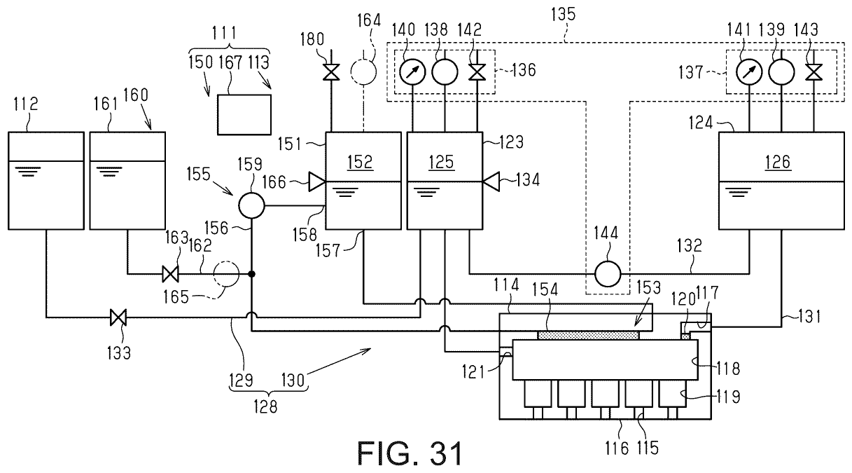

As shown in FIG. 31, the first moisturizing section 153 is adjacent to the ejection section 114. The first moisturizing section 153 may be positioned outside the ejection section 114 or may be positioned inside the ejection section 114. In one example, the first moisturizing section 153 is incorporated into the ejection section 114. The first moisturizing section 153 is adjacent to, for example, the common liquid chamber 118. The first moisturizing section 153 may be adjacent to the inlet path 117, may be adjacent to the individual liquid chamber 119, or may be adjacent to the outlet path 121. The first moisturizing section 153 is adjacent to the stirring flow path 156. In this example, the stirring flow path 156 extends within the ejection section 114. The first moisturizing section 153 moisturizes ejection liquid flowing through the ejection section 114 with moisturizing liquid flowing through the stirring flow path 156.

The first moisture permeable membrane 154 is positioned so as to separate ejection liquid flowing in the ejection section 114 and moisturizing liquid flowing in the stirring flow path 156. The first moisture permeable membrane 154 is positioned so as to constitute a wall defining the common liquid chamber 118. The first moisture permeable membrane 154 is positioned so as to constitute a wall of the stirring flow path 156. According to this example, moisturizing liquid circulates in the stirring flow path 156, and thus ejection liquid flowing in the ejection section 114 is effectively moisturized.

### Thirty First Embodiment

Next, a thirty first embodiment of the liquid ejection device 111 will be described. The thirty first embodiment is different from the sixteenth embodiment in the configuration of the moisturizing mechanism 150. In the thirty first embodiment, the differences from the sixteenth embodiment will be mainly described.

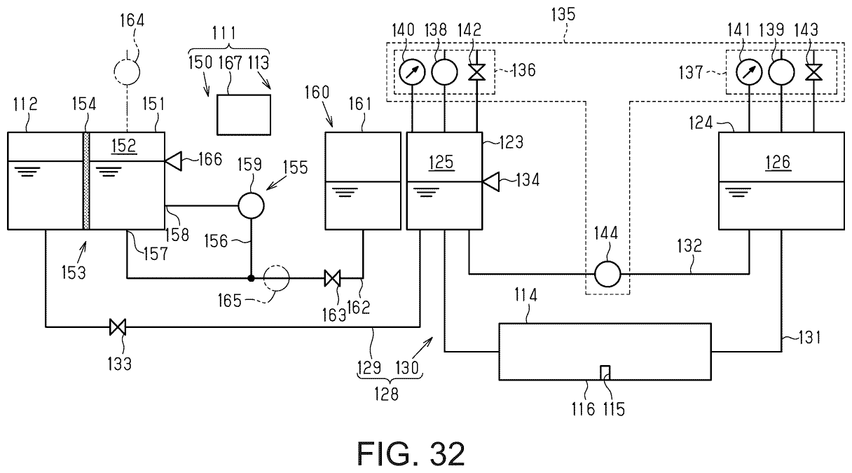

As shown in FIG. 32, the first moisturizing section 153 is adjacent to the supply source 112. The first moisturizing section 153 is adjacent to the first moisturizing liquid storage section 151. The first moisturizing section 153 moisturizes ejection liquid stored in the supply source 112 by moisturizing liquid stored in the first moisturizing liquid storage section 151.

The first moisture permeable membrane 154 is positioned so as to separate ejection liquid stored in the supply source 112 and moisturizing liquid stored in the first moisturizing liquid storage section 151. The first moisture permeable membrane 154 is positioned to constitute a wall of the supply source 112. The first moisture permeable membrane 154 is positioned so as to constitute a wall of the first moisturizing liquid storage section 151. According to this example, ejection liquid stored in the supply source 112 is effectively moisturized.

### Thirty Second Embodiment

Next, a thirty second embodiment of the liquid ejection device 111 will be described. The thirty second embodiment is different from the sixteenth embodiment in the configurations of the ejection mechanism 113 and the moisturizing mechanism 150. In the thirty second embodiment, the differences from the sixteenth embodiment will be mainly described.

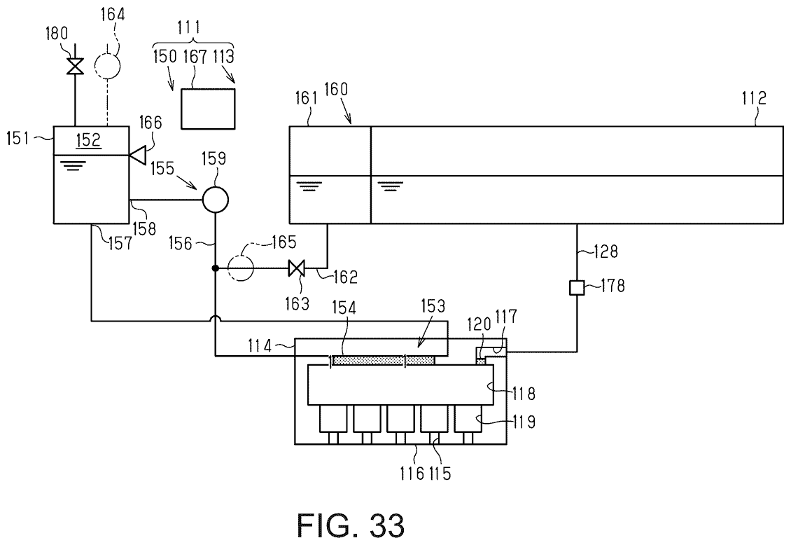

As shown in FIG. 33, the ejection liquid flow path 128 directly connects the supply source 112 and the ejection section 114. That is, in this example, the ejection mechanism 113 does not include the ejection liquid storage section. Ejection liquid is directly supplied from the supply source 112 to the ejection section 114 through the ejection liquid flow path 128.

The supply source 112 is integrally formed with the moisture storage section 161. For example, the supply source 112 is constituted by a cartridge for storing ejection liquid and moisture. In this example, the moisture storage section 161 is attachable to and detachable from the liquid ejection device 111.

The ejection mechanism 113 may include the first differential pressure valve 178. The first differential pressure valve 178 is the same as in the other embodiments. The first differential pressure valve 178 is positioned in the ejection liquid flow path 128. The inside of the ejection section 114 is maintained at a negative pressure by the first differential pressure valve 178. Not limited to the first differential pressure valve 178, the ejection mechanism 113, by a water head difference between the supply source 112 and the ejection section 114, may be maintained in the ejection section 114 to a negative pressure.

The first moisturizing section 153 is adjacent to the ejection section 114, similar to the thirtieth embodiment. In one example, the first moisturizing section 153 is adjacent to the common liquid chamber 118. The first moisturizing section 153 is adjacent to the stirring flow path 156. In this example, the stirring flow path 156 extends within the ejection section 114. In the first moisturizing section 153, ejection liquid flowing through the ejection section 114 is moisturized by moisturizing liquid flowing through the stirring flow path 156.

The first moisture permeable membrane 154 is positioned so as to separate ejection liquid flowing in the ejection section 114 and moisturizing liquid flowing in the stirring flow path 156. The first moisture permeable membrane 154 is positioned so as to constitute a wall defining the common liquid chamber 118. The first moisture permeable membrane 154 is positioned so as to constitute a wall of the stirring flow path 156. According to this example, moisturizing liquid circulates in the stirring flow path 156, and thus ejection liquid flowing in the ejection section 114 is effectively moisturized.

### Thirty Third Embodiment

Next, a thirty third embodiment of the liquid ejection device 111 will be described. The thirty third embodiment is different from the sixteenth embodiment in the configuration of the liquid ejection device 111. In the thirty third embodiment, the differences from the sixteenth embodiment will be mainly described.

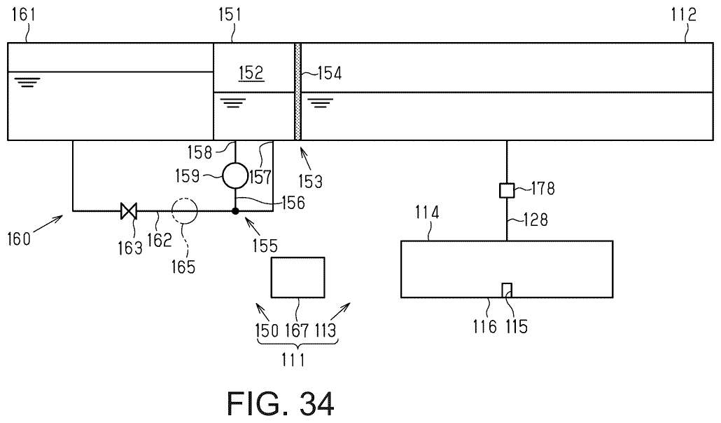

As shown in FIG. 34, the ejection liquid flow path 128 directly connects the supply source 112 and the ejection section 114, similarly to the thirty second embodiment. That is, in this example, the ejection mechanism 113 does not include the ejection liquid storage section. Ejection liquid is directly supplied from the supply source 112 to the ejection section 114 through the ejection liquid flow path 128.

The supply source 112 is integrally formed with the first moisturizing liquid storage section 151 and the moisture storage section 161. For example, the supply source 112 is composed of a cartridge storing ejection liquid, moisturizing liquid, and moisture. In this example, the first moisturizing liquid storage section 151 and the moisture storage section 161 are attachable to and detachable from the liquid ejection device 111.

The ejection mechanism 113 may include the first differential pressure valve 178. The first differential pressure valve 178 is the same as in the other embodiments. The first differential pressure valve 178 is positioned in the ejection liquid flow path 128. The inside of the ejection section 114 is maintained at a negative pressure by the first differential pressure valve 178. Not limited to the first differential pressure valve 178, the ejection mechanism 113, by a water head difference between the supply source 112 and the ejection section 114, may be maintained in the ejection section 114 to a negative pressure.

The supply source 112 includes the first moisturizing section 153. The first moisturizing section 153 is adjacent to the first moisturizing liquid storage section 151. The first moisturizing section 153 moisturizes ejection liquid stored in the supply source 112 by moisturizing liquid stored in the first moisturizing liquid storage section 151. The first moisture permeable membrane 154 is positioned so as to separate ejection liquid stored in the supply source 112 and moisturizing liquid stored in the first moisturizing liquid storage section 151.

### Thirty Fourth Embodiment

Next, a thirty fourth embodiment of the liquid ejection device 111 will be described. The thirty fourth embodiment is different from the sixteenth embodiment in the configurations of the ejection mechanism 113 and the moisturizing mechanism 150. In the thirty fourth embodiment, the differences from the sixteenth embodiment will be mainly described.

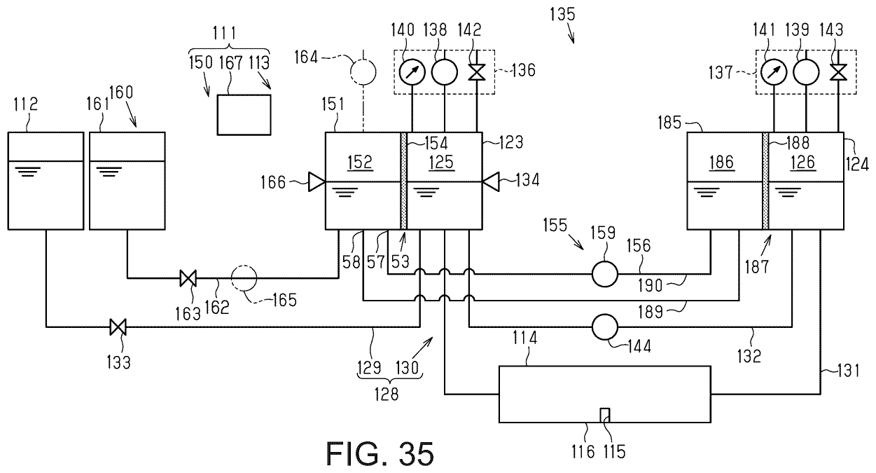

As shown in FIG. 35, the moisturizing mechanism 150 includes a second moisturizing liquid storage section 185. The second moisturizing liquid storage section 185 defines a second moisturizing liquid chamber 186. The second moisturizing liquid storage section 185 stores air together with moisturizing liquid, for example. The inside of the second moisturizing liquid storage section 185 may be filled with moisturizing liquid.

The moisturizing mechanism 150 includes a second moisturizing section 187. The second moisturizing section 187 is adjacent to the second ejection liquid storage section 124. The second moisturizing section 187 is adjacent to the second moisturizing liquid storage section 185. The second moisturizing section 187 moisturizes ejection liquid stored in the second ejection liquid storage section 124 by moisturizing liquid stored in the second moisturizing liquid storage section 185.

The second moisturizing section 187 includes a second moisture permeable membrane 188. The second moisture permeable membrane 188 is positioned so as to separate ejection liquid and moisturizing liquid. Specifically, the second moisture permeable membrane 188 is positioned so as to separate ejection liquid stored in the second ejection liquid storage section 124 and moisturizing liquid stored in the second moisturizing liquid storage section 185. The second moisture permeable membrane 188 is positioned so as to constitute a wall of the second ejection liquid storage section 124. The second moisture permeable membrane 188 is positioned so as to constitute a wall of the second moisturizing liquid storage section 185. The second moisture permeable membrane 188 partitions the second ejection liquid chamber 126 and the second moisturizing liquid chamber 186.

Similarly to the first moisture permeable membrane 154, the second moisture permeable membrane 188 may partition the second ejection liquid chamber 126 and the second moisturizing liquid chamber 186 in a state in which air stored in the second ejection liquid chamber 126 and air stored in the second moisturizing liquid chamber 186 can enter and exit each other. In one example, an upper end of the second moisture permeable membrane 188 is positioned above an ejection liquid surface and a moisturizing liquid surface. That is, the second ejection liquid storage section 124 stores ejection liquid so that an ejection liquid surface is positioned below an upper end of the second moisture permeable membrane 188. The second moisturizing liquid storage section 185 stores moisturizing liquid so that a moisturizing liquid surface is positioned below an upper end of the second moisture permeable membrane 188. By this, air can enter and exit the second ejection liquid chamber 126 and the second moisturizing liquid chamber 186 through the second moisture permeable membrane 188. In this case, a pressure difference is unlikely to occur between the second ejection liquid chamber 126 and the second moisturizing liquid chamber 186.

The second moisture permeable membrane 188 completely partitions the second ejection liquid chamber 126 and the second moisturizing liquid chamber 186. In one example, an upper end of the second moisture permeable membrane 188 contacts the second ejection liquid storage section 124 and the second moisturizing liquid storage section 185. By this, even if ejection liquid or moisturizing liquid splashes, a possibility that ejection liquid and moisturizing liquid are mixed is reduced.

The second moisture permeable membrane 188 may not completely partition the second ejection liquid chamber 126 and the second moisturizing liquid chamber 186. For example, an upper end of the second moisture permeable membrane 188 may not contact the second ejection liquid storage section 124 and the second moisturizing liquid storage section 185.

The stirring flow path 156 includes a first circulation flow path 189 and a second circulation flow path 190. The first circulation flow path 189 is connected to the first moisturizing liquid storage section 151 and the second moisturizing liquid storage section 185. The first circulation flow path 189 communicates with the first moisturizing liquid chamber 152 and the second moisturizing liquid chamber 186. In one example, the first circulation flow path 189 includes the second end 158. The second circulation flow path 190 is connected to the first moisturizing liquid storage section 151 and the second moisturizing liquid storage section 185. The second circulation flow path 190 communicates with the first moisturizing liquid chamber 152 and the second moisturizing liquid chamber 186. In one example, the second circulation flow path 190 includes the first end 157.

The stirring pump 159 is positioned in the second circulation flow path 190. When the stirring pump 159 is driven, moisturizing liquid flows from the first moisturizing liquid chamber 152 to the second moisturizing liquid chamber 186 through the second circulation flow path 190. At this time, moisturizing liquid flows from the second moisturizing liquid chamber 186 to the first moisturizing liquid chamber 152 through the first circulation flow path 189. As described above, moisturizing liquid circulates between the first moisturizing liquid storage section 151 and the second moisturizing liquid storage section 185. In this example, ejection liquid stored in the first ejection liquid storage section 123 and ejection liquid stored in the second ejection liquid storage section 124 are effectively moisturized.

Moisturizing liquid may be circulated by the first adjustment pump 138, the second adjustment pump 139, and the stirring pump 159. When the first adjustment pump 138 depressurizes the inside of the first ejection liquid storage section 123, the inside of the first moisturizing liquid storage section 151 is also depressurized. When the second adjustment pump 139 pressurizes the inside of the second ejection liquid storage section 124, the inside of the second moisturizing liquid storage section 185 is also pressurized. By this, moisturizing liquid flows from the second moisturizing liquid storage section 185 to the first moisturizing liquid storage section 151.

### Thirty Fifth Embodiment

Next, a thirty fifth embodiment of the liquid ejection device 111 will be described. The thirty fifth embodiment is different from the sixteenth embodiment in the configuration of the ejection mechanism 113. In the thirty fifth embodiment, the differences from the sixteenth embodiment will be mainly described.

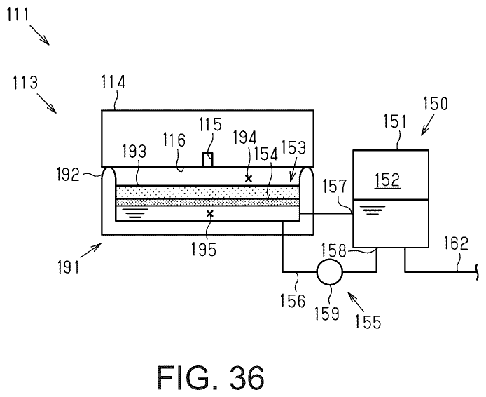

As shown in FIG. 36, the ejection mechanism 113 may include a maintenance section 191. The maintenance section 191 is configured to maintain the ejection section 114. Specifically, the maintenance section 191 performs maintenance by moisturizing the ejection section 114.

The maintenance section 191 includes a cap 192. The cap 192 contacts the nozzle surface 116, thereby forming a space in communication with the nozzle 115. By this, a possibility that moisture in ejection liquid evaporates from the nozzle 115 is reduced. When the cap 192 contacts the nozzle surface 116, the maintenance section 191 performs maintenance on the ejection section 114. This is also called capping.

The cap 192 may receive ejection liquid ejected from the ejection section 114 by flushing and cleaning. Flushing is maintenance in which ejection liquid is appropriately ejected from the nozzle 115 in order to suppress clogging of the nozzle 115. Cleaning is maintenance for discharging ejection liquid from the nozzle 115 by applying pressure to the inside of the ejection section 114.

The maintenance section 191 includes a absorbent material 193. The absorbent material 193 is positioned within the cap 192. The absorbent material 193 absorbs ejection liquid ejected from the ejection section 114. When the cap 192 caps the nozzle 115 in a state in which the absorbent material 193 contains ejection liquid, ejection liquid in the nozzle 115 is effectively moisturized. That is, moisture moves from ejection liquid contained in the absorbent material 193 to ejection liquid positioned in the nozzle 115.

The first moisturizing section 153 is adjacent to the maintenance section 191. Specifically, the first moisturizing section 153 is adjacent to the absorbent material 193. The first moisturizing section 153 is adjacent to the stirring flow path 156. In this example, the stirring flow path 156 extends through the cap 192. It can also be said that the cap 192 is positioned in the stirring flow path 156. Therefore, when the stirring pump 159 is driven, moisturizing liquid circulates between the first moisturizing liquid storage section 151 and the cap 192 by flowing through the stirring flow path 156. The first moisturizing section 153 moisturizes ejection liquid contained in the absorbent material 193 by moisturizing liquid flowing through the stirring flow path 156.

The first moisture permeable membrane 154 is positioned so as to separate ejection liquid contained in the absorbent material 193 and moisturizing liquid flowing through the stirring flow path 156. The first moisture permeable membrane 154 is attached to the cap 192. The first moisture permeable membrane 154 is positioned within the cap 192. The first moisture permeable membrane 154 partitions the inside of the cap 192 into an ejection liquid space 194 and a moisturizing liquid space 195. The ejection liquid space 194 is a space for holding ejection liquid in the cap 192. The absorbent material 193 is positioned in the ejection liquid space 194. The moisturizing liquid space 195 is a space in which moisturizing liquid is stored. The moisturizing liquid space 195 constitutes a part of the stirring flow path 156.

Moisture is supplied from moisturizing liquid to ejection liquid contained in the absorbent material 193 through the first moisture permeable membrane 154. By this, ejection liquid contained in the absorbent material 193 is maintained at an ideal moisture amount. Therefore, the moisturizing effect by capping is improved.

### Modifications

The above-described embodiments may be modified as follows. The above-described embodiments and the following modifications can be implemented in combination with each other to the extent that they are not technically contradictory.

The ejection mechanism 113 may include a third ejection liquid amount detection section for detecting the ejection liquid amount in the third ejection liquid storage section 171.

The moisturizing mechanism 150 may include a second moisturizing liquid amount detection section or detecting the moisturizing liquid amount in the second moisturizing liquid storage section 185.

The moisturizing mechanism 150 may include a third moisturizing liquid storage section. The moisturizing mechanism 150 may include a third moisturizing section.

Liquid ejected by the ejection section 114 is not limited to ink, and may be, for example, liquid body in which particles of a functional material are dispersed or mixed in liquid. For example, the ejection section 114 may eject liquid body containing a material such as an electrode material or a color material used for manufacturing a liquid crystal display, an electroluminescent display, a surface emitting display, or the like in a dispersed or dissolved form.

### Technical Ideas

Hereinafter, technical ideas grasped from the above-described embodiments and operations and effects thereof, will be described.
(A) A liquid storage section includes a storage body that stores ejection liquid and moisturizing liquid and a moisture permeable membrane attached to the storage body, wherein the moisture permeable membrane partitions an inside of the storage body into an ejection liquid chamber and a moisturizing liquid chamber, the ejection liquid chamber is a space in which ejection liquid is stored, the moisturizing liquid chamber is a space in which moisturizing liquid is stored, and the storage body stores ejection liquid and moisturizing liquid such that a liquid surface of ejection liquid stored in the ejection liquid chamber and a liquid surface of moisturizing liquid stored in the moisturizing liquid chamber are positioned below an upper end of the moisture permeable membrane.

According to the above-described configuration, ejection liquid and air are stored in the ejection liquid chamber, and moisturizing liquid and air are stored in the moisturizing liquid chamber. Air can move between the ejection liquid chamber and the moisture permeable membrane. Air can move between the moisturizing liquid chamber and the moisture permeable membrane. Therefore, even when pressure is applied to ejection liquid, a pressure difference is less likely to occur between the ejection liquid chamber and the moisture permeable membrane. Even when pressure is applied to moisturizing liquid, a pressure difference is less likely to occur between the moisturizing liquid chamber and the moisture permeable membrane. This reduces a possibility of liquid seeping into the moisture permeable membrane.
(B) The above-described liquid storage section may be configured such that the liquid storage section is connected to a pressure change mechanism that changes pressure in the storage body and the storage body is connected to the pressure change mechanism such that an upper section of the ejection liquid chamber or an upper section of the moisturizing liquid chamber communicates with the pressure change mechanism.

According to the above-described configuration, even if the pressure change mechanism changes pressure of the ejection liquid chamber or pressure of the moisturizing liquid chamber, a pressure difference is less likely to occur between the ejection liquid chamber or the moisturizing liquid chamber and the moisture permeable membrane. This reduces a possibility of liquid seeping into the moisture permeable membrane.
(C) A liquid flow mechanism includes the above-described liquid storage section; a pressure change mechanism connected to the storage body and configured to change pressure in the storage body; and an ejection liquid flow path connected to the storage body and communicating with the ejection liquid chamber.

When the pressure change mechanism changes pressure in the storage body, liquid in the ejection liquid chamber flows through the ejection liquid flow path. At this time, if a pressure difference occurs between the ejection liquid chamber and the moisturizing liquid chamber, there is a possibility that liquid seeps into the moisture permeable membrane. In this regard, according to the above-described configuration, ejection liquid and air are stored in the ejection liquid chamber, and moisturizing liquid and air are stored in the moisturizing liquid chamber. Air can move between the ejection liquid chamber and the moisturizing liquid chamber. Therefore, even if the pressure change mechanism changes pressure of the ejection liquid chamber or pressure of the moisturizing liquid chamber, a pressure difference is less likely to occur between the ejection liquid chamber or the moisturizing liquid chamber and the moisture permeable membrane. This reduces a possibility of liquid seeping into the moisture permeable membrane.
(D) The above-described liquid flow mechanism may be configured such that the ejection liquid flow path includes a first connection end connected to the storage body and a second connection end connected to the storage body and the first connection end and the second connection end communicate with the ejection liquid chamber.

According to the above-described configuration, ejection liquid flows through the circulation flow path by the pressure change mechanism changing pressure in the storage body. By this, ejection liquid stored in the storage body circulates through the ejection liquid flow path. As ejection liquid is circulated, moisture is supplied from moisturizing liquid to the entire ejection liquid. Therefore, moisturizing liquid can effectively moisturize ejection liquid.
(E) A liquid ejection device includes the above-described liquid flow mechanism and an ejection section connected to the storage body and configured to eject ejection liquid stored in the ejection liquid chamber.

When the pressure change mechanism changes pressure in the storage body, liquid in the ejection liquid chamber flows through the ejection liquid flow path. At this time, if a pressure difference occurs between the ejection liquid chamber and the moisturizing liquid chamber, there is a possibility that liquid seeps into the moisture permeable membrane. In this regard, according to the above-described configuration, ejection liquid and air are stored in the ejection liquid chamber, and moisturizing liquid and air are stored in the moisturizing liquid chamber. Air can move between the ejection liquid chamber and the moisturizing liquid chamber. Therefore, even if the pressure change mechanism changes pressure of the ejection liquid chamber or pressure of the moisturizing liquid chamber, a pressure difference is less likely to occur between the ejection liquid chamber or the moisturizing liquid chamber and the moisture permeable membrane. This reduces a possibility of liquid seeping into the moisture permeable membrane.
(F) The above-described liquid ejection device may be configured such that the ejection liquid flow path includes a first connection end connected to the storage body and a second connection end connected to the storage body, the first connection end and the second connection end communicate with the ejection liquid chamber, and the ejection section is positioned in the ejection liquid flow path.

According to the above-described configuration, ejection liquid flows through the ejection liquid flow path when the pressure change mechanism changes pressure in the storage body. By this, ejection liquid stored in the storage body circulates through the ejection liquid flow path. As ejection liquid is circulated, moisture is supplied from moisturizing liquid to the entire ejection liquid. Therefore, moisturizing liquid can effectively moisturize ejection liquid. The ejection section ejects ejection liquid effectively moisturized by moisturizing liquid. Therefore, the ejection section can properly eject ejection liquid.
(G) The above-described liquid ejection device may be configured such that the liquid storage section is a first liquid storage section, the storage body is a first storage body, the liquid flow mechanism includes a second liquid storage section that stores ejection liquid, or ejection liquid and moisturizing liquid, the second liquid storage section includes a second storage body that stores ejection liquid, or ejection liquid and moisturizing liquid, the ejection liquid flow path includes a first connection flow path connected to the first storage body and the second storage body, and a second connection flow path connected to the first storage body and the second storage body, the ejection section is positioned in the first connection flow path, and the pressure change mechanism includes a first change section configured to change pressure in the first storage body and a second change section configured to change pressure in the second storage body.

According to the above-described configuration, the pressure change mechanism changes pressure in the first storage body and pressure in the second storage body, whereby ejection liquid circulates through the ejection liquid flow path. By this, moisturizing liquid can effectively moisturize ejection liquid.
(H) The above-described liquid ejection device may be configured such that the liquid flow mechanism includes a stirring section that stirs moisturizing liquid stored in the moisturizing liquid chamber.

According to the above-described configuration, since the stirring section stirs moisturizing liquid, a possibility that the concentration of moisturizing liquid increases is reduced.
(I) The above-described liquid ejection device may be configured such that the stirring section includes a stirring flow path through which moisturizing liquid stored in the moisturizing liquid chamber circulates, and a stirring pump positioned in the stirring flow path, the stirring flow path includes a first end connected to the storage body and a second end connected to the storage body, and the first end and the second end communicate with the moisturizing liquid chamber.

According to the above-described configuration, by driving the stirring pump, moisturizing liquid stored in the moisturizing liquid chamber is circulated in the stirring flow path. By this, moisturizing liquid stored in the moisturizing liquid chamber is stirred. Therefore, a possibility that the concentration of moisturizing liquid increases is reduced.
(J) The above-described liquid ejection device may be configured such that the moisture permeable membrane is a first moisture permeable membrane, the ejection liquid chamber is a first ejection liquid chamber, the moisturizing liquid chamber is a first moisturizing liquid chamber, the second liquid storage section includes a second moisture permeable membrane attached to the second storage body, the second moisture permeable membrane partitions an inside of the second storage body into a second ejection liquid chamber and a second moisturizing liquid chamber, the second ejection liquid chamber is a space in which ejection liquid is stored, the second moisturizing liquid chamber is a space in which moisturizing liquid is stored, the second storage body stores ejection liquid and moisturizing liquid such that a liquid surface of ejection liquid stored in the second ejection liquid chamber and a liquid surface of moisturizing liquid stored in the second moisturizing liquid chamber are positioned below an upper end of the second moisture permeable membrane, the liquid flow mechanism includes a stirring section that stirs moisturizing liquid stored in the first moisturizing liquid chamber and moisturizing liquid stored in the second moisturizing liquid chamber, the stirring section includes a stirring flow path in which moisturizing liquid circulates in the first moisturizing liquid chamber and the second moisturizing liquid chamber, the stirring flow path includes a first circulation flow path connected to the first liquid storage section and the second liquid storage section, and a second circulation flow path connected to the first liquid storage section and the second liquid storage section, the first circulation flow path communicates with the first moisturizing liquid chamber and the second moisturizing liquid chamber, the second circulation flow path communicates with the first moisturizing liquid chamber and the second moisturizing liquid chamber.

According to the above-described configuration, moisturizing liquid can moisturize ejection liquid in the first liquid storage section and the second liquid storage section. By this, circulating ejection liquid is moisturized by moisturizing liquid.

What is claimed is:

1. A liquid storage section comprising:
a storage body that stores ejection liquid and moisturizing liquid and a moisture permeable membrane attached to the storage body, wherein
the moisture permeable membrane partitions an inside of the storage body into an ejection liquid chamber and a moisturizing liquid chamber,
the ejection liquid chamber is a space in which ejection liquid is stored,
the moisturizing liquid chamber is a space in which moisturizing liquid is stored, and
the storage body stores ejection liquid and moisturizing liquid such that a liquid surface of ejection liquid stored in the ejection liquid chamber and a liquid surface of moisturizing liquid stored in the moisturizing liquid chamber are positioned below an upper end of the moisture permeable membrane.

2. The liquid storage section according to claim 1, wherein
the liquid storage section is connected to a pressure change mechanism that changes pressure in the storage body and
the storage body is connected to the pressure change mechanism such that an upper section of the ejection liquid chamber or an upper section of the moisturizing liquid chamber communicates with the pressure change mechanism.

3. A liquid flow mechanism comprising:
the liquid storage section according to claim 1;
a pressure change mechanism connected to the storage body and configured to change pressure in the storage body; and
an ejection liquid flow path connected to the storage body and communicating with the ejection liquid chamber.

4. The liquid flow mechanism according to claim 3, wherein
the ejection liquid flow path includes a first connection end connected to the storage body and a second connection end connected to the storage body and
the first connection end and the second connection end communicate with the ejection liquid chamber.

5. A liquid ejection device comprising:
the liquid flow mechanism according to claim 3 and
an ejection section connected to the storage body and configured to eject ejection liquid stored in the ejection liquid chamber.

6. The liquid ejection device according to claim 5, wherein
the ejection liquid flow path includes a first connection end connected to the storage body and a second connection end connected to the storage body,
the first connection end and the second connection end communicate with the ejection liquid chamber, and
the ejection section is positioned in the ejection liquid flow path.

7. The liquid ejection device according to claim 6, wherein
the liquid storage section is a first liquid storage section,
the storage body is a first storage body,
the liquid flow mechanism includes a second liquid storage section that stores ejection liquid, or ejection liquid and moisturizing liquid,
the second liquid storage section includes a second storage body that stores ejection liquid, or ejection liquid and moisturizing liquid,
the ejection liquid flow path includes a first connection flow path connected to the first storage body and the second storage body, and a second connection flow path connected to the first storage body and the second storage body,
the ejection section is positioned in the first connection flow path, and
the pressure change mechanism includes a first change section configured to change pressure in the first storage body and a second change section configured to change pressure in the second storage body.

8. The liquid ejection device according to claim 5, wherein
the liquid flow mechanism includes a stirring section that stirs moisturizing liquid stored in the moisturizing liquid chamber.

9. The liquid ejection device according to claim 8, wherein
the stirring section includes a stirring flow path through which moisturizing liquid stored in the moisturizing liquid chamber circulates, and a stirring pump positioned in the stirring flow path,
the stirring flow path includes a first end connected to the storage body and a second end connected to the storage body, and
the first end and the second end communicate with the moisturizing liquid chamber.

10. The liquid ejection device according to claim 7, wherein
the moisture permeable membrane is a first moisture permeable membrane,
the ejection liquid chamber is a first ejection liquid chamber,
the moisturizing liquid chamber is a first moisturizing liquid chamber,
the second liquid storage section includes a second moisture permeable membrane attached to the second storage body,
the second moisture permeable membrane partitions an inside of the second storage body into a second ejection liquid chamber and a second moisturizing liquid chamber,
the second ejection liquid chamber is a space in which ejection liquid is stored,
the second moisturizing liquid chamber is a space in which moisturizing liquid is stored,
the second storage body stores ejection liquid and moisturizing liquid such that a liquid surface of ejection liquid stored in the second ejection liquid chamber and a liquid surface of moisturizing liquid stored in the second moisturizing liquid chamber are positioned below an upper end of the second moisture permeable membrane,
the liquid flow mechanism includes a stirring section that stirs moisturizing liquid stored in the first moisturizing liquid chamber and moisturizing liquid stored in the second moisturizing liquid chamber,
the stirring section includes a stirring flow path in which moisturizing liquid circulates in the first moisturizing liquid chamber and the second moisturizing liquid chamber,
the stirring flow path includes a first circulation flow path connected to the first liquid storage section and the second liquid storage section, and a second circulation flow path connected to the first liquid storage section and the second liquid storage section,
the first circulation flow path communicates with the first moisturizing liquid chamber and the second moisturizing liquid chamber, and
the second circulation flow path communicates with the first moisturizing liquid chamber and the second moisturizing liquid chamber.
